(19) United States
(12) Patent Application Publication
(10) Pub. No.: US 2023/0408826 A1
(43) Pub. Date: Dec. 21, 2023

(54) NEAR-EYE DISPLAY ARCHITECTURES

(71) Applicant: Meta Platforms Technologies, LLC, Menlo Park, CA (US)

(72) Inventors: Chulwoo OH, Sammamish, WA (US); Agnes LEE, Da'an (TW); Linghui RAO, Redmond, WA (US)

(21) Appl. No.: 18/362,900

(22) Filed: Jul. 31, 2023

Related U.S. Application Data
(60) Provisional application No. 63/501,244, filed on May 10, 2023.
(60) Provisional application No. 63/393,813, filed on Jul. 29, 2022.

(51) Int. Cl. G02B 27/01; G02F 1/1368; G02F 1/1335

(52) U.S. Cl. CPC G02B 27/0172; G02F 1/1368; G02F 1/133504; G02B 2027/0178; G02F 1/133528; G02F 2203/01; G02F 1/133514

(57) ABSTRACT

Disclosed herein are various near-eye display architectures, including kaleidoscopic waveguide display architectures, geometrical waveguide displays with improved pupil replication density, liquid crystal displays with improved brightness uniformity, tiled display panels for field of view expansion, and display modules including over-molded frame with integrated heat sink fins.

### CROSS-REFERENCE TO RELATED APPLICATIONS

This application claims the benefit of and priority to U.S. Provisional Application No. 63/393,813, filed Jul. 29, 2022, entitled “LIQUID-CRYSTAL DISPLAY (LCD) WITH IMPROVED BRIGHTNESS UNIFORMITY,” and U.S. Provisional Application No. 63/501,244, filed May 10, 2023, entitled “HOMOGENEOUS INTEGRATION OF TILED DISPLAY SYSTEM FOR FIELD-OF-VIEW EXPANSION,” which are herein incorporated by reference in their entireties for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 10 to 20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through) or viewing displayed images of the surrounding environment captured by a camera (often referred to as video see-through).

A near-eye display may include an optical system configured to form an image of a computer-generated image on an image plane. The optical system of the near-eye display may relay the image generated by an image source (e.g., a display panel) to create a virtual image that appears to be away from the image source and further than just a few centimeters away from the user's eyes. For example, the optical system may collimate the light from the image source or otherwise convert spatial information of the displayed virtual objects into angular information to create a virtual image that may appear to be far away. The optical system may also magnify the image source to make the image appear larger than the actual size of the image source. It is generally desirable that the near-eye display has a small size, a low weight, a large field of view, a large eye box, a high efficiency, and a low cost.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5 illustrates an example of an optical see-through augmented reality system including a waveguide display for exit pupil expansion according to certain embodiments.

FIG. 6 illustrates an example of a waveguide display including two waveguides for two-dimensional (2D) pupil expansion.

FIG. 7 illustrates an example of a waveguide display including two waveguide assemblies for pupil expansion and a scanning mirror for 2D field of view (FOV) expansion.

FIG. 8 illustrates an example of a waveguide display including one or more curved waveguides for pupil expansion and a scanning mirror for 2D FOV expansion.

FIGS. 9A and 9B illustrate an example of a kaleidoscopic waveguide for pupil expansion and 2D FOV expansion in a waveguide display according to certain embodiments.

FIG. 10A illustrates light reflections by four surfaces of an example of a kaleidoscopic waveguide according to certain embodiments.

FIG. 10B illustrates wave vectors of display light being reflected by the four surfaces of the kaleidoscopic waveguide of FIG. 10A through total internal reflection according to certain embodiments.

FIG. 11 illustrates an example of a geometrical waveguide display including a kaleidoscopic geometrical waveguide for pupil expansion and 2-D FOV expansion according to certain embodiments.

FIG. 12A illustrates k-vectors of light beams propagating within an example of a geometrical waveguide and reflected by surfaces and transflective mirrors having a first orientation (e.g., about 60° with respect to a surface of the geometrical waveguide) in the geometrical waveguide.

FIG. 12B illustrates k-vectors of light beams propagating within an example of a geometrical waveguide and reflected by surfaces and transflective mirrors having a second orientation (e.g., about 36° with respect to a surface of the geometrical waveguide) in the geometrical waveguide.

FIG. 12C illustrates k-vectors of light beams propagating within an example of a geometrical waveguide and reflected by surfaces and transflective mirrors having a third orientation (e.g., about 180/7=25.7° with respect to a surface of the geometrical waveguide) in the geometrical waveguide.

FIG. 13A illustrates an example of a pupil expander in the form of a geometrical waveguide that includes a set of transflective mirrors in a waveguide.

FIG. 13B illustrates another example of a pupil expander in the form of a geometrical waveguide that includes a set of transflective mirrors in a waveguide.

FIG. 13C illustrates yet another example of a pupil expander in the form of a geometrical waveguide that includes a set of transflective mirrors in a waveguide.

FIGS. 14A-14C illustrate an example of a geometrical waveguide display including a kaleidoscopic geometrical waveguide and an output geometrical waveguide according to certain embodiments.

FIG. 15A illustrates wave vectors of display light coupled into the kaleidoscopic geometrical waveguide of the geometrical waveguide display of FIGS. 14A-14C according to certain embodiments.

FIG. 15B illustrates wave vectors of display light reflected by surfaces (sidewalls) of the kaleidoscopic geometrical waveguide of the geometrical waveguide display of FIGS. 14A-14C according to certain embodiments.

FIG. 15C illustrates k-vectors of display light reflected by geometrical mirrors of the kaleidoscopic geometrical waveguide of the geometrical waveguide display of FIGS. 14A-14C according to certain embodiments, where the k-vectors are projected onto a plane (e.g., a y-z plane) of the k-sphere.

FIG. 15D illustrates k-vectors of display light reflected by the geometrical mirrors of the kaleidoscopic geometrical waveguide of the geometrical waveguide display of FIGS. 14A-14C according to certain embodiments, where the k-vectors may be projected onto a plane (e.g., an x-z plane) of the k-sphere.

FIG. 15E illustrates wave vectors of display light reflected by transflective mirrors and surfaces (sidewalls) of the kaleidoscopic geometrical waveguide of the geometrical waveguide display of FIGS. 14A-14C according to certain embodiments.

FIG. 15F illustrates wave vectors of display light reflected by surfaces and geometric mirrors of the kaleidoscopic geometrical waveguide of the geometrical waveguide display of FIGS. 14A-14C according to certain embodiments, where the wave vectors are projected onto a y-z plane of a k-sphere.

FIG. 15G illustrates wave vectors of display light reflected by surfaces and geometric mirrors of the kaleidoscopic geometrical waveguide of the geometrical waveguide display of FIGS. 14A-14C according to certain embodiments, where the wave vectors are projected onto an x-y plane of a k-sphere.

FIG. 16A illustrates an example of a geometrical waveguide display including a kaleidoscopic geometrical waveguide according to certain embodiments.

FIG. 16B illustrates an example of the kaleidoscopic geometrical waveguide of the geometrical waveguide display of FIG. 16A according to certain embodiments.

FIG. 16C illustrates an example of an output geometrical waveguide of the geometrical waveguide display of FIG. 16A according to certain embodiments.

FIG. 17A illustrates wave vectors of display light coupled out of the kaleidoscopic geometrical waveguide and propagating within the output geometrical waveguide of the geometrical waveguide display of FIG. 16A according to certain embodiments.

FIG. 17B illustrates wave vectors of display light reflected by surfaces and geometric mirrors of the output geometrical waveguide of the geometrical waveguide display of FIG. 16A according to certain embodiments.

FIG. 18 illustrates an example of a geometrical waveguide display including a kaleidoscopic geometrical waveguide according to certain embodiments.

FIG. 19 illustrates an example of a geometrical waveguide display including a kaleidoscopic geometrical waveguide according to certain embodiments.

FIG. 20 illustrates an example of a waveguide display including three groups of reflective and/or transflective mirrors for two-dimensional pupil expansion according to certain embodiments.

FIG. 21A illustrates an example a waveguide with a higher thickness.

FIG. 21B illustrates an example a waveguide with a lower thickness.

FIGS. 21C and 21D illustrate examples of input couplers for waveguide display.

FIG. 22A illustrates an example of a waveguide display including a waveguide and a beam splitter embedded in the waveguide according to certain embodiments.

FIG. 22B illustrates an example of a waveguide display according to certain embodiments.

FIG. 22C illustrates an example of a waveguide display including a waveguide and a partial reflective film on a surface of the waveguide according to certain embodiments.

FIG. 23A illustrates an example of a geometrical waveguide display including beam splitters in a kaleidoscopic waveguide according to certain embodiments.

FIG. 23B illustrates an example of a geometrical waveguide display including a kaleidoscopic waveguide and partially reflective films on one or more sidewalls of the kaleidoscopic waveguide according to certain embodiments.

FIGS. 24A-24D illustrate examples of pupil replication by waveguide displays with and without beam splitters.

FIG. 25A illustrates an example of a waveguide display that includes a waveguide, an input coupler, a first pupil replicator, and a second pupil replicator. FIG. 25B illustrates another example of a waveguide display according to certain embodiments.

FIGS. 26A-26B show an example of a waveguide display according to certain embodiments.

FIGS. 27A-27D illustrate examples of pupil replication by geometrical waveguide displays including kaleidoscopic waveguides.

FIGS. 28A-28C show that the pupil replication density may depend on the thickness of the waveguide.

FIGS. 28D-28E show that the location of the embedded beam splitter in the waveguide may also affect the pupil replication density.

FIGS. 29A-29C illustrate an example of a process of fabricating a geometrical waveguide including an embedded beam splitter to improve the pupil replication density according to certain embodiments.

FIG. 30 is a cross-sectional view of an example of a near-eye display according to certain embodiments.

FIG. 31 illustrates an example of an optical system with a non-pupil forming configuration for a near-eye display device according to certain embodiments.

FIG. 32 illustrates an example of an image source assembly in a near-eye system according to certain embodiments.

FIG. 33 illustrates an example of a liquid crystal display (LCD).

FIG. 34 illustrates a mismatch between the display peak emission angle of an LCD of a near-eye display and the chief-ray angles of the near-eye display for some regions of the LCD.

FIG. 35 illustrates a relationship between a display luminance and the chief-ray angle of a near-eye LCD.

FIG. 36 illustrates an example of an LCD for near-eye display according to certain embodiments.

FIG. 37A illustrates an example of an LCD according to certain embodiments.

FIG. 37B illustrates another example of an LCD according to certain embodiments.

FIG. 38A illustrates an example of a Pancharatnam-Berry phase (PBP) lens of the diffractive optical element shown in FIGS. 36-37B.

FIG. 38B illustrates a relationship between the angular shift of an incident light and the position of the incident point from the center of the PBP lens shown in FIG. 38A.

FIG. 39A is a view of an x-z plane of an example of a PBP grating.

FIG. 39B is a view of an x-y plane of the example of the PBP grating shown in FIG. 39A.

FIG. 40A illustrates LC molecule orientations in an example of a PBP lens according to certain embodiments.

FIG. 40B illustrates the LC molecule orientations of a portion of the PBP lens of FIG. 40A according to certain embodiments.

FIGS. 41A and 41B illustrate an example of a PBP lens that is sensitive to circularly polarized light according to certain embodiments.

FIG. 42A illustrates an example of a near-eye display viewed by a user's eye having a gazing angle about 0°.

FIG. 42B illustrates an example of a beam profile of the light beam emitted at each region of a display panel.

FIG. 42C illustrates the example of near-eye display viewed by a user's eye having a gazing angle about 30°.

FIG. 42D illustrates a beam profile of the light beam emitted at each region of a display panel and a region of the beam profile showing light emitted from a right region of display panel and collected by display optics in a near-eye display when the user's gazing angle is about 30°.

FIG. 43A illustrates an example of a backlight unit (BLU) in an LCD panel.

FIG. 43B illustrates an example of a top brightness enhancement film (BEF) in a backlight unit.

FIG. 44 illustrates an example of a BLU including a beam steering film.

FIG. 45 illustrates an example of a BLU including an emission profile control film according to certain embodiments.

FIG. 46 illustrates an example of a relationship between the pixel location and the corresponding optical weight factor (e.g., FWHM of emission cone) in order to reduce the BRO effect according to certain embodiments.

FIG. 47A illustrates an example of a BLU for reducing BRO effect according to certain embodiments.

FIG. 47B illustrates another example of a BLU for reducing BRO effect according to certain embodiments.

FIGS. 48A-48B illustrate examples of concave pyramid structures on a pyramid BEF according to certain embodiments.

FIGS. 48C-48D illustrate examples of prism structures on a pyramid BEF.

FIG. 49 illustrates examples of monocular and binocular fields of view of human eyes.

FIG. 50A is a perspective view of an example of a tiled display system according to certain embodiments.

FIG. 50B is a cross-sectional view of an example of a tiled display system according to certain embodiments.

FIG. 50C is a cross-sectional view of another example of a tiled display system according to certain embodiments.

FIG. 51A illustrates an example of a near-eye display system including a tiled display system and display optics according to certain embodiments.

FIG. 51B illustrates another example of a near-eye display system including a tiled display system and display optics according to certain embodiments.

FIGS. 52A-52C illustrate an example of a process of fabricating a tiled display panel according to certain embodiments.

FIGS. 53A and 53B illustrate an example of a tiled display panel according to certain embodiments.

FIGS. 53C and 53D illustrate another example of a tiled display panel according to certain embodiments.

FIGS. 54A and 54B illustrate an example of a tiled display panel according to certain embodiments.

FIG. 54C illustrates another example of a tiled display panel according to certain embodiments.

FIGS. 55A-55C illustrate an example of a tiled display panel according to certain embodiments.

FIG. 56A illustrates an example of a tiled display panel according to certain embodiments.

FIG. 56B illustrates an example of a tiled display panel according to certain embodiments.

FIG. 57 illustrates an example of a near-eye display system including a tiled display panel and display optics according to certain embodiments.

FIG. 58 includes a flowchart illustrating an example of a process of fabricating a tiled display panel according to certain embodiments.

FIGS. 59A-59C include different views of an example of a display module including an over-molded frame with integrated heat sink according to certain embodiments.

FIG. 60 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. Various inventive embodiments are described herein, including devices, components, systems, modules, assemblies, subsystems, and the like.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

### I. Near-Eye Display

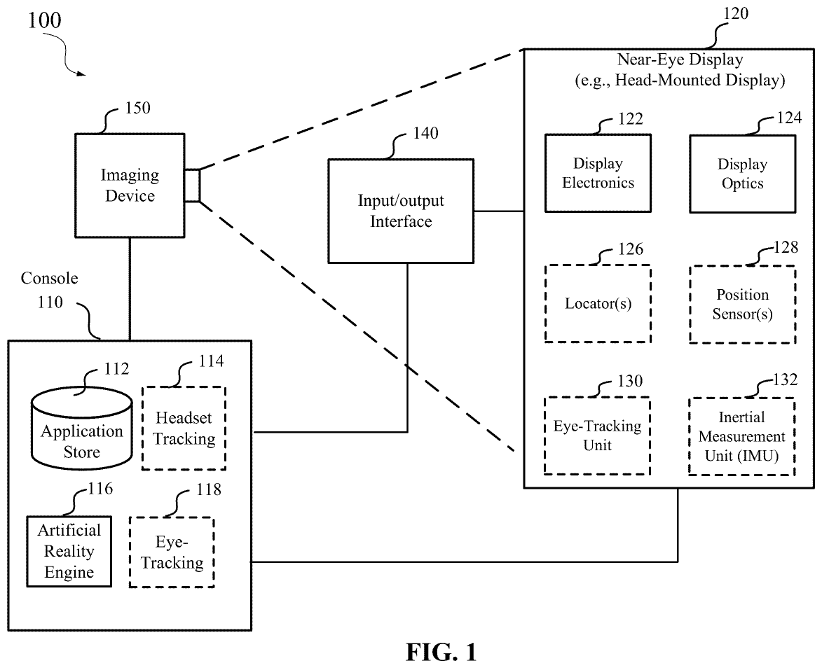

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

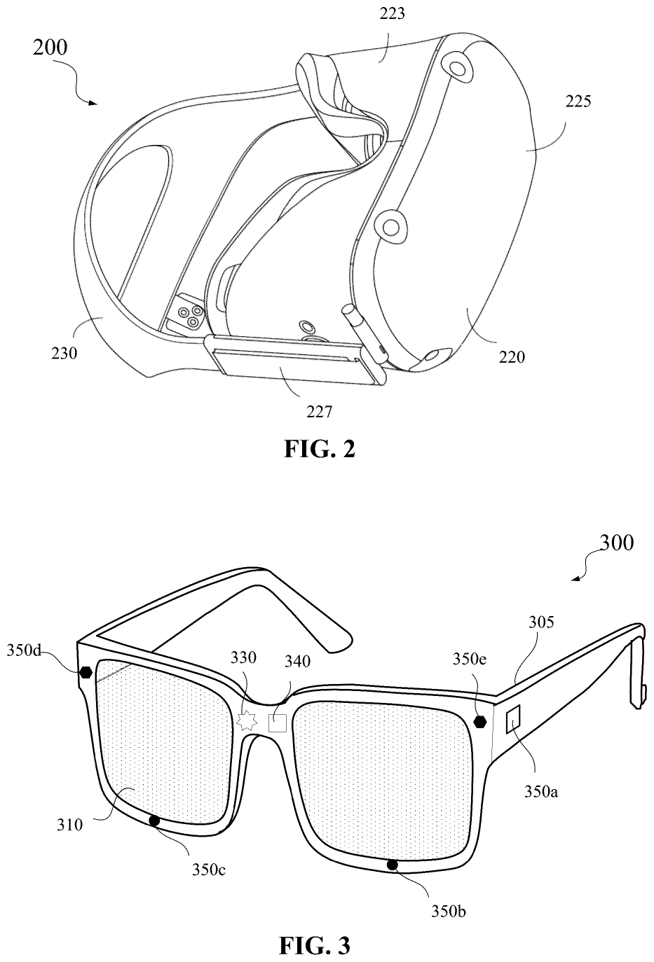

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

### II. Waveguide Display

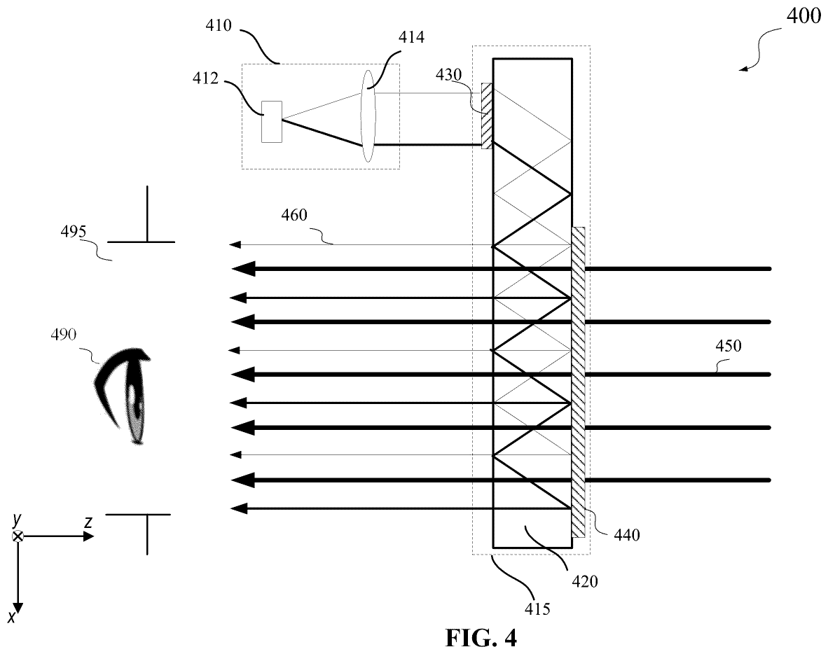

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator.

Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 12 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

In some embodiments, projector 410, input coupler 430, and output coupler 440 may be on any side of substrate 420. Input coupler 430 and output coupler 440 may be reflective gratings (also referred to as reflective gratings) or transmissive gratings (also referred to as transmissive gratings) to couple display light into or out of substrate 420.

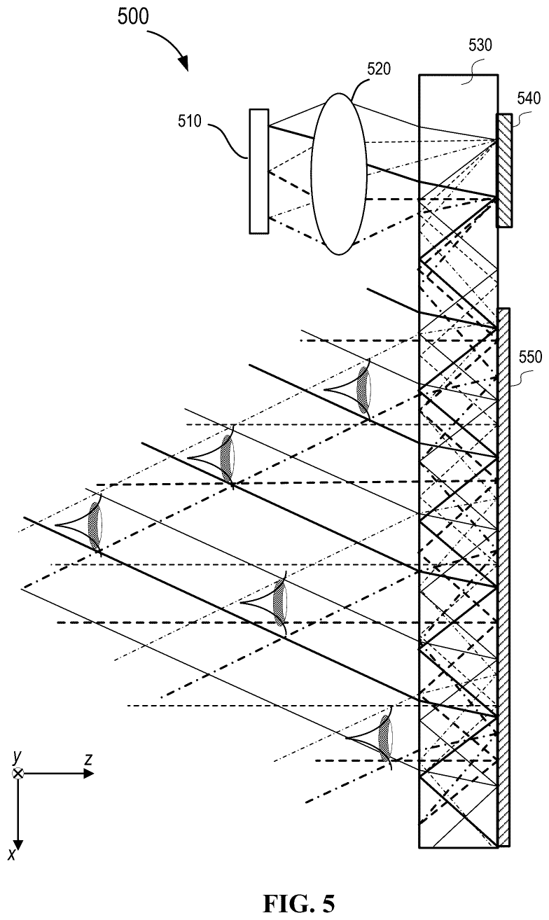

FIG. 5 illustrates an example of an optical see-through augmented reality system 500 including a waveguide display for exit pupil expansion according to certain embodiments. Augmented reality system 500 may be similar to augmented reality system 500, and may include the waveguide display and a projector that may include a light source or image source 510 and projector optics 520. The waveguide display may include a substrate 530, an input coupler 540, and a plurality of output couplers 550 as described above with respect to augmented reality system 500. While FIG. 5 only shows the propagation of light from a single field of view, FIG. 5 shows the propagation of light from multiple fields of view.

FIG. 5 shows that the exit pupil is replicated by output couplers 550 to form an aggregated exit pupil or eyebox, where different regions in a field of view (e.g., different pixels on image source 510) may be associated with different respective propagation directions towards the eyebox, and light from a same field of view (e.g., a same pixel on image source 510) may have a same propagation direction for the different individual exit pupils. Thus, a single image of image source 510 may be formed by the user's eye located anywhere in the eyebox, where light from different individual exit pupils and propagating in the same direction may be from a same pixel on image source 510 and may be focused onto a same location on the retina of the user's eye. In other words, the user's eye may convert angular information in the eyebox or exit pupil (e.g., corresponding to a Fourier plane) to spatial information in images form on the retina. FIG. 5 shows that the image of the image source is visible by the user's eye even if the user's eye moves to different locations in the eyebox.

As described above, in a waveguide-based near-eye display system, light of projected images may be coupled into a waveguide (e.g., a transparent substrate), propagate within the waveguide through total internal reflection, and be coupled out of the waveguide at multiple locations to replicate the exit pupil and expand the eyebox. Multiple waveguides and/or multiple couplers (e.g., gratings or transflective mirrors) may be used to replicate the exit pupil in two dimensions to fill a large eyebox (e.g., 40×40 mm² or larger) with a 2D array of pupils (e.g., 2×2 mm²), thereby expanding the eyebox such that the user's eyes can view the displayed image even if the user's eyes move within a large area. For example, two or more gratings may be used to expand the display light in two dimensions or along two axes. The two gratings may have different grating parameters, such that one grating may be used to replicate the exit pupil in one direction and the other grating may be used to replicate the exit pupil in another direction. In such waveguide display systems, to achieve a large FOV, the two or more gratings may need to be large, and thus the waveguide display may have a large form factor (e.g., a large area). In some implementations, to reduce the size the waveguide displays, a long bar-shaped waveguide may be used to split the input display light into a one-dimensional (1D) array of light beams along one direction (e.g., the length direction of the bar-shaped waveguide), thereby replicating the pupil in one dimension. A larger waveguide may receive the 1D array of light beams and split each light beam into an array of light beams along another direction, thereby replicating the pupil in another dimension. Therefore, two-dimensional (2D) pupil replication may be achieved by the combination of the bar-shaped waveguide and the larger waveguide to expand the eyebox. The long bar-shaped waveguide and the larger waveguide may be stacked to form a three-dimensional structure and reduce the form factor (e.g., the total area) of the waveguide display.

As also described above, in optical see-through near-eye display system for augmented reality or mixed reality applications generally includes an image source (e.g., a micro-display), an optical combiner, and an eyepiece. The optical combiner may include, for example, a flat beam splitter, a curved or freeform surface with a beam-splitting coating, a diffractive (e.g., holographic) waveguide, or a geometrical waveguide. Optical combiners made of flat beam splitters or freeform surfaces may have high image quality but may have large sizes. Waveguide displays using, for example, diffractive couplers (e.g., volume Bragg gratings or surface-relief gratings) or transflective mirrors, can be made thin and compact. In waveguide displays, multiple waveguides and/or couplers may be used to replicate the exit pupil, thereby increasing the size of the eyebox, such that the user's eyes may be able to view the displayed image even if the user's eyes move within a large area. To achieve a large field of view (FOV), a waveguide display using diffractive couplers or transflective mirrors may generally need to have a large form factor.

In some implementations, to reduce the size of a waveguide display, a long bar-shaped waveguide may be used to split the input display light into a one-dimensional (1D) array of light beams along one direction (e.g., the length direction of the bar-shaped waveguide), thereby replicating the pupil in one dimension. A larger waveguide may receive the 1D array of light beams and split each light beam into an array of light beams along another direction, thereby replicating the pupil in another dimension. Therefore, two-dimensional (2D) pupil replication may be achieved by the combination of the bar-shaped waveguide and the larger waveguide to expand the eyebox. The bar-shaped waveguide may have a relatively small FOV in at least one dimension (e.g., a line FOV with about 0° FOV in a direction perpendicular to the length direction of the bar-shaped waveguide) to avoid reflections by sidewalls that may result in optical artifacts such as ghost images. A scanning mirror (e.g., a galvanometer mirror or microelectromechanical system (MEMS) mirrors) may be used to scan the array of light beams from the bar-shaped waveguide to increase the FOV in the dimension perpendicular to the length direction of the bar-shaped waveguide, to achieve a larger 2D field of view. Using the scanning mirror may increase the size, complexity, and cost, and reduce the reliability of the waveguide display.

FIG. 6 illustrates an example of a waveguide display 600 including two waveguides for two-dimensional (2D) pupil expansion. In the illustrated example, waveguide display 600 may include a first assembly 610 that may include a light source 612 for generating display light, a projector 614 for projecting the display light onto an input coupler 617 for a first waveguide 616. Input coupler 617 may couple the display light into first waveguide 616 such that the display light may be guided by first waveguide 616 through total internal reflection to propagate within first waveguide 616 in approximately the −x direction. An output coupler 618 for first waveguide 616 may couple a portion of the display light guided by first waveguide 616 out of first waveguide 616, each time the display light is incident on output coupler 618. Therefore, first waveguide 616 may split the display light into multiple display light beams 640 that are output at multiple locations along a first direction (e.g., the x direction). The multiple display light beams 640 generated by first assembly 610 may be coupled into a second waveguide 620 by an input coupler 650 such that display light beams 640 may be guided by second waveguide 620 to propagate along approximately the −y direction. Display light guided by second waveguide 620 may be coupled out of second waveguide 620 towards user's eye 690 (or an eyebox) each time the display light is incident on an output coupler 660. Therefore, second waveguide 620 may split each display light beam 640 into multiple display light beams that are output at multiple locations along a second direction (e.g., the y direction).

Light source 612 may include, for example, one or more laser diodes, light emitting diodes (LEDs), micro-LEDs, resonant-cavity LEDs (RC-LEDs), vertical cavity surface emitting lasers (VCSELs), organic LEDs (OLEDs), micro-OLEDs, liquid crystal display (LCD) cells, and the like. Light source 612 may emit visible light of multiple colors, such as red, green, and blue light. In some embodiments, light source 612 may include one or more rows or one or more columns of light emitters of different colors, such as multiple rows of red light emitters, multiple rows of green light emitters, and multiple rows of blue light emitters. In some embodiments, light source 612 may include a 2D array of light emitters.

Projector 614 may include one or more optical components that can condition the display light from light source 612. Conditioning display light from light source 612 may include, for example, expanding, collimating, converging, diverging, or a combination thereof. In some embodiments, the optical power of projector 614 may be adjusted by, for example, mechanically translating a projection lens relative to light source 612, or using a tunable liquid crystal lens that can adjust the optical power under the control of a controller (not shown in FIG. 6). The one or more optical components may include, for example, lenses, mirrors, apertures, gratings, prisms, or a combination thereof.

Input coupler 617 may include, for example, a grating, a prism or wedge, or a reflecting surface, and may couple the display light from projector 614 into first waveguide 616 through diffraction, refraction, or reflection. First waveguide 616 may be characterized by a shape of long bar, and may have a relatively small form factor. In one example, first waveguide 616 may be approximately 50 mm or longer along the x dimension, about 5-10 mm (e.g., about 6 mm) along the y dimension, and about 0.3-1 mm along the z dimension. First waveguide 616 may be configured to expand the display light (e.g., via pupil replication) in one dimension (e.g., the x direction) through total internal reflection by surfaces of first waveguide 616 and output coupling by output coupler 618 as described above with respect to, for example, FIGS. 4 and 5. Output coupler 618 may include, for example, a surface-relief grating (SRG), a holographic grating (e.g., a volume Bragg grating(VBG)), a polarization volume hologram (PVH), partial reflectors (e.g., transflective mirrors that can partially reflect incident light and partially transmit incident light), a micro-mirror array, and the like.

Second waveguide 620 may have a larger form factor, such as having a width greater than about 40 mm, 50 mm, 60 mm, or larger. Second waveguide 620 may receive display light beams 640 at input coupler 650, which may couple the display light into second waveguide 620. Input coupler 650 may include, for example, a surface-relief grating, a holographic grating, a PVH, and the like. Second waveguide 620 may guide the received display light to output coupler 660. Output coupler 660 may include, for example, a holographic grating (e.g., VBGs) or an array of transflective mirrors, and may split and couple each display light beam 640 out of second waveguide 620 towards user's eye 690 (or an eyebox) at multiple locations along approximately the y direction, thereby replicating the exit pupil along the y direction.

As such, the exit pupil may be replicated along approximately the x direction by first waveguide 616 and may be further replicated along approximately the y direction by second waveguide 620 to achieve 2D pupil expansion. In some embodiments, the replicated exit pupils may partially overlap in the eyebox. The pupil expansion may occur in two directions that may or may not be orthogonal. The replicated pupils may fill an eyebox (e.g., ≥10-40 mm or larger in diameter or width), such that the user's eye 690 may view the displayed content even if it moves within the eyebox.

A bar-shaped waveguide (e.g., first waveguide 616) may reduce the form factor of the waveguide display, but may have a relatively small FOV in at least one dimension (e.g., in the y direction in the example shown in FIG. 6). In some implementations, a scanning mirror (e.g., a galvanometer mirror or microelectromechanical system (MEMS) mirrors) may be used to scan the array of light beams from the bar-shaped waveguide in one direction (e.g., they direction) to increase the FOV in the direction and achieve a large 2D field of view.

FIG. 7 illustrates an example of a waveguide display 700 including two waveguide assemblies for pupil expansion and a scanning mirror for 2D FOV expansion. Waveguide display 700 may include components similar to components of waveguide display 600 and may include an additional scanning mirror 730 and a controller (not shown in FIG. 7) for controlling the operation of scanning mirror 730. As waveguide display 600, waveguide display 700 may include a light source 712 for generating display light, a projector 714 for projecting the display light onto an input coupler 722 for a first waveguide 720. In some embodiments, the optical power of projector 714 may be adjustable as described above with respect to projector 614.

Input coupler 722 may couple the display light into first waveguide 720 such that the display light may be guided by first waveguide 720 through total internal reflection to propagate within first waveguide 720 in approximately the −x direction. An output coupler 724 may couple a portion of the display light guided by first waveguide 720 out of first waveguide 720, each time the display light is incident on output coupler 724. Therefore, first waveguide 720 may split the display light into multiple display light beams that are output at multiple locations along a first direction (e.g., approximately the x direction). Input coupler 722 may include, for example, a grating, a prism or wedge, or a reflecting surface. Output coupler 724 may include, for example, a surface-relief grating, a holographic grating, an array of transflective mirrors, an array of micro-mirrors, and the like.

The multiple display light beams generated by first waveguide 720 may be reflected by scanning mirror 730 towards an input coupler 742 for a second waveguide 740. Input coupler 742 may couple the display light from scanning mirror 730 into second waveguide 740 such that the display light beams may be guided by second waveguide 740 to propagate along approximately the −y direction. Display light guided by second waveguide 740 may be coupled out of second waveguide 740 towards user's eye 790 (or an eyebox) each time the display light is incident on an output coupler 744. Each of input coupler 742 and output coupler 744 may include, for example, a surface-relief grating, a holographic grating, an array of transflective mirrors, an array of micro-mirrors, and the like. First waveguide 720 and second waveguide 740 may each include a flat substrate, and the displayed image may be at an image plane that is far (e.g., ≥3 meters or at infinity) from user's eye 790.

First waveguide 720 may have a shape of a long bar and may have a small FOV in, for example, the z direction. To increase the FOV of waveguide display 700, scanning mirror 730 may be controlled by a controller (not shown in FIG. 7) that may also control the generation of the display light by light source 712, such that, at different time of an image frame period, display light for different FOVs may be generated by light source 712 and reflected by scanning mirror 730 to appropriate directions towards input coupler 742 for second waveguide 740 to form a two-dimensional image with a large 2D FOV. Scanning mirror 730 may scan incident light in one dimension or two dimensions (e.g. horizontal and/or vertical dimensions), and may include, for example, a galvanometer mirror or MEMS mirrors. In some embodiments, waveguide display 700 may also include display optics (not shown in FIG. 7) between second waveguide 740 and user's eye 790. The display optics may project the displayed image onto an image plane that is at a finite distance (e.g., ≥0.5 m, 1 meters, 2 meters, or 3 meters) in front of user's eye 790.

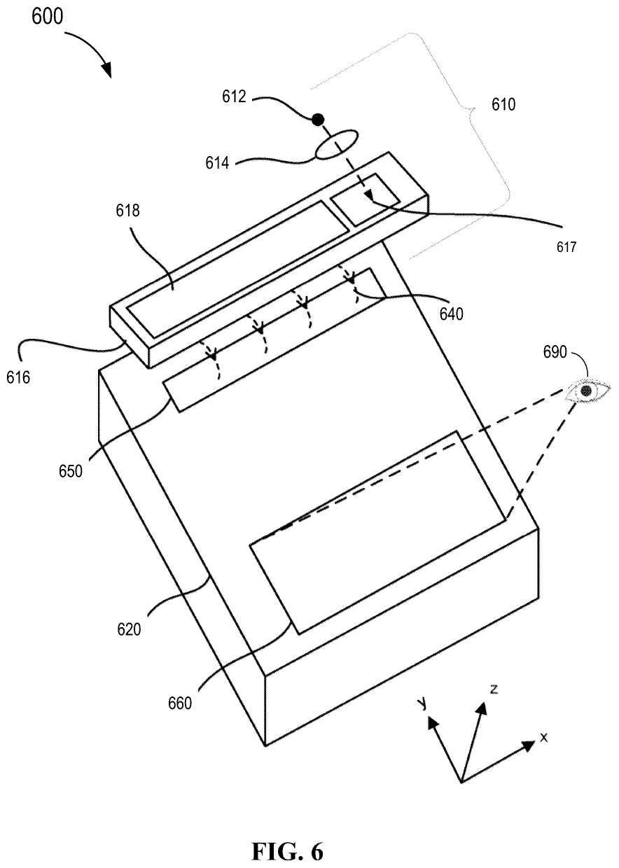

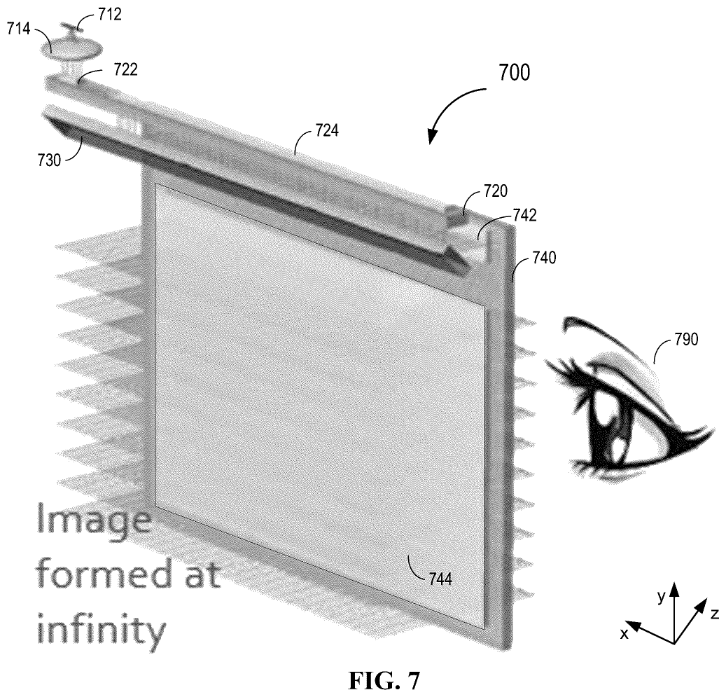

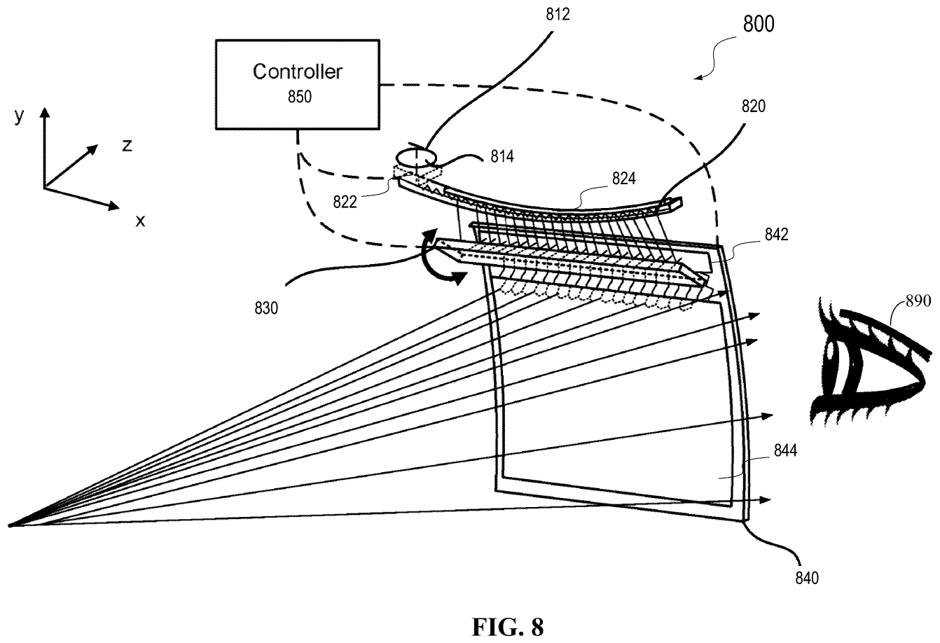

FIG. 8 illustrates an example of a waveguide display 800 including one or more curved waveguides for pupil expansion and a scanning mirror for 2D FOV expansion. Waveguide display 800 may include components similar to components of waveguide display 700, but at least one of the two waveguides may be curved and adjustable to form display images at image planes at desired distances from the user's eye. As illustrated, waveguide display 800 may include a light source 812 for generating display light, a projector 814 for projecting the display light onto a first waveguide 820.

First waveguide 820 may include an input coupler 822 that may couple the display light into first waveguide 820 such that the display light may be guided by first waveguide 820 through total internal reflection. First waveguide 820 may also include an output coupler 824 that may couple a portion of the display light guided by first waveguide 820 out of first waveguide 820, each time the display light is incident on output coupler 824. Therefore, first waveguide 820 may split the display light into multiple display light beams that are output at multiple locations along approximately a first direction (e.g., approximately the x direction). Input coupler 822 may include, for example, a grating, a prism or wedge, or a reflecting surface. Output coupler 824 may include, for example, a surface-relief grating, a holographic grating, an array of transflective mirrors, an array of micro-mirrors, and the like. In the illustrated example, first waveguide 820 may be curved, and thus may converge or diverge the display light.

The multiple display light beams generated by first waveguide 820 may be reflected by scanning mirror 830 towards an input coupler 842 of a second waveguide 840. Input coupler 842 may couple the display light from scanning mirror 830 into second waveguide 840 such that the display light may be guided by second waveguide 840 through total internal reflection. Display light guided by second waveguide 840 may be coupled out of second waveguide 840 towards user's eye 890 (or an eyebox) each time the display light is incident on an output coupler 844. Each of input coupler 842 and output coupler 844 may include, for example, a surface-relief grating, a holographic grating, an array of transflective mirrors, an array of micro-mirrors, and the like. In the illustrated example, second waveguide 840 may include a curved substrate, and thus may converge or diverge the display light such that the display image may be formed at an image plane that is at a desired distance from user's eye 890.

First waveguide 820 may have a shape of a long bar and may have a small FOV in, for example, the z direction. To increase the FOV of waveguide display 800, scanning mirror 830 may be controlled by a controller 850 that may also control the generation of the display light by light source 812, such that, at different time of an image frame period, display light for different FOVs may be generated by light source 812 and reflected by scanning mirror 830 at appropriate directions towards input coupler 842 of second waveguide 840 to form a two-dimensional image with a large 2D FOV. Scanning mirror 830 may scan incident light in one dimension or two dimensions (e.g. horizontal and/or vertical dimensions), and may include, for example, a galvanometer mirror or MEMS mirrors.

In some embodiments, projector 814 may be adjustable to change its optical power as described above with respect to projector 614. In some embodiments, first waveguide 820 and/or second waveguide 840 may include a flexible material (e.g., an organic material), and waveguide display 800 may include one or more actuators that may be controlled by controller 850 to bend first waveguide 820 and/or second waveguide 840. The one or more actuators may include, for example, a strip actuator (e.g., a bimorph strip actuator), a fluidic membrane actuator, a piezoelectric actuator, a MEMS actuator, another actuator, or a combination thereof. The one or more actuators may be placed on one or more surfaces of first waveguide 820 along one or more directions (e.g., the x direction), and/or on one or more surfaces of second waveguide 840 along one or dimensions (e.g., the y direction). In one example, first waveguide 820 may be bent to have a certain curvature to converge or diverge the display light in one dimension (e.g., in x direction), while second waveguide 840 may be bent to have a certain curvature to converge or diverge the display light in another dimension (e.g., in the y direction). As such, the distance of the image plane from user's eye 890 may be adjusted, for example, based on the content of the displayed images, by adjusting the optical power of projector 814, the radius of the curvature of first waveguide 820, the radius of the curvature of second waveguide 840, or a combination thereof.

In some embodiments, waveguide display 800 may also include display optics (e.g., a lens, such as a cylindrical lens or a spherical lens, not shown in FIG. 8) between second waveguide 840 and user's eye 890. The display optics may, in combination with the curved first waveguide 820 and/or second waveguide 840, project the display image at an image plane that is at a finite distance (e.g., ≥0.5 m, 1 meters, 2 meters, or 3 meters) in front of user's eye 890.

Using the scanning mirror (e.g., scanning mirror 730 or 830) for 2D FOV expansion as shown in FIGS. 7 and 8 may need some movable parts in the waveguide display, and may need synchronized control of the light source and the scanning mirror. This may increase the size, complexity, and cost, and reduce the reliability and durability of the waveguide display.

### III. Kaleidoscopic Waveguide

In some waveguide displays disclosed herein, a kaleidoscopic waveguide may be used to replicate the pupil of a waveguide display in one dimension and also achieve a large FOV in two dimensions, and thus a scanning mirror may not be used in the waveguide display. Compared to the bar-shaped waveguides in waveguide displays that use scanning mirrors, the kaleidoscopic waveguide may have a similar shape and size, but may be configured to guide the display light coupled into the kaleidoscopic waveguide in different manners. For example, display light coupled into a kaleidoscopic waveguide may be reflected by more than two surfaces of the kaleidoscopic waveguide, such as four surfaces of a kaleidoscopic waveguide having a rectangular cross-section, thereby creating multiple images of different parity in each round trip (e.g., including four reflections at the four surfaces due to total internal reflection). One or more of the multiple images covering a large 2D FOV may be coupled out of the kaleidoscopic waveguide by, for example, a grating or transflective mirrors, through one surface of the kaleidoscopic waveguide towards a second waveguide. The second waveguide may replicate the exit pupil in another dimension to achieve 2D pupil expansion. In this way, a waveguide display including a kaleidoscopic waveguide may have a small form factor and no moving parts (e.g., a scanning mirror), and may be able to achieve 2D pupil expansion and a large 2D FOV.

In geometrical waveguide based waveguide displays, if the waveguide displays are not properly designed, the multiple images generated by the reflections at the sidewalls of the kaleidoscopic waveguide may decrease the overall efficiency and may cause ghost images. When the orientations of the geometrical mirrors are tuned to improve efficiency and field of view while reducing ghost images, the pupil replication density may be low and the image resolution may be low. Thick waveguides may be used to improve the pupil replication density and the resolution, which may increase the size and weight of the waveguide display.

According to certain embodiments disclosed herein, a geometrical waveguide display may include a kaleidoscopic geometrical waveguide and an output geometrical waveguide arranged side by side, where the orientations and dimensions of the waveguides and the orientations of the geometrical mirrors (transflective mirrors) may be selected such that the field of view may be maximized, ghost images may be trapped in the waveguide, and more images reflected by the kaleidoscopic geometrical waveguide may be used for displaying images to the user, thereby reducing or eliminating ghost images caused by multiple images generated by the kaleidoscopic geometrical waveguide, and improving the field of view, efficiency, resolution, and pupil replication density and uniformity of the waveguide display, without using thick waveguides and/or high refractive index waveguide materials.

In one example, a geometrical waveguide display may include a kaleidoscopic geometrical waveguide and an output geometrical waveguide. The kaleidoscopic geometrical waveguide may be positioned side-by-side with the output geometrical waveguide, where the out-coupling surface (e.g., a side surface) of the kaleidoscopic geometrical waveguide may be parallel to the in-coupling surface (e.g., a side surface) of the output geometrical waveguide. The kaleidoscopic geometrical waveguide may include a mirror on a side surface opposing the out-coupling surface to improve the efficiency of the geometrical waveguide display. There may be air or another low refractive index material between the kaleidoscopic geometrical waveguide and the output geometrical waveguide to cause total internal reflection in kaleidoscopic geometrical waveguide. The kaleidoscopic geometrical waveguide and the output geometrical waveguide may have the same thickness D (e.g., less than a few millimeters, such as about 1 mm) or different thicknesses. Both the kaleidoscopic geometrical waveguide and the output geometrical waveguide may include embedded transflective mirrors. The transflective mirrors in the kaleidoscopic geometrical waveguide may be oriented at an angle about 60° (≈180°/3) with respect to the out-coupling surface of kaleidoscopic geometrical waveguide 1410, while the transflective mirrors in the output geometrical waveguide may be oriented at an angle about 36° (≈180°/5) with respect to a top or bottom surface of the output geometrical waveguide, such that a large field of view (e.g., >60°×40°) may be supported by the geometrical waveguide display, while eliminating or reducing ghost images. Display light may be coupled into the kaleidoscopic geometrical waveguide, guided by surfaces of the kaleidoscopic geometrical waveguide though total internal reflection, replicated along a first direction by the transflective mirrors, and be coupled out of the kaleidoscopic geometrical waveguide into the output geometrical waveguide. The output geometrical waveguide may replicate the display light in a second direction and couple the display light out of the output geometrical waveguide towards an eyebox of the geometrical waveguide display.

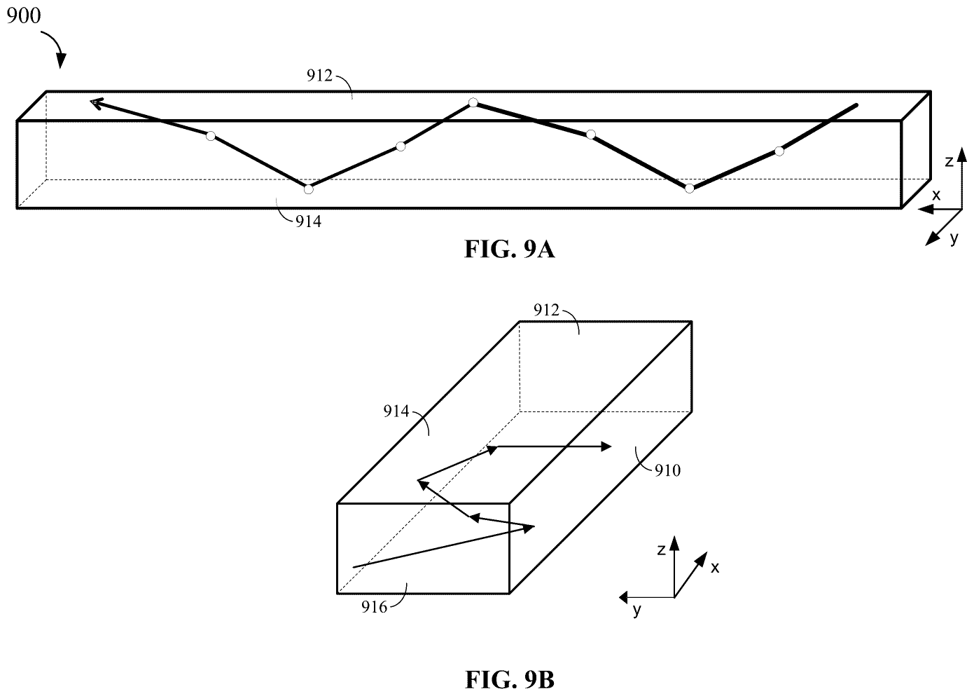

FIGS. 9A and 9B illustrate an example of a kaleidoscopic waveguide 900 for pupil expansion and 2D FOV expansion in a waveguide display according to certain embodiments. Kaleidoscopic waveguide 900 may be used as, for example, first waveguide 616 of waveguide display 600, or may be used to replace first waveguide 720 and scanning mirror 730 of waveguide display 700 or replace first waveguide 820 and scanning mirror 830 of waveguide display 800. In the illustrated example, kaleidoscopic waveguide 900 may have a shape of long bar or tube (e.g., extending in the x direction) with a rectangular cross-section (e.g., in a y-z plane). Kaleidoscopic waveguide 900 may include a material that is transparent to visible light as described above. Kaleidoscopic waveguide 900, an input coupler (not shown in FIGS. 9A and 9B), and a projector (not shown in FIGS. 9A and 9B) of the waveguide display may be arranged such that display light projected by the projector and coupled by the input coupler into kaleidoscopic waveguide 900 may be incident on and reflected by four surfaces of kaleidoscopic waveguide 900 that are parallel to the x direction through total internal reflection, such that the display light may propagate within kaleidoscopic waveguide 900 along approximately the x direction.

For example, in the example illustrated in FIGS. 9A and 9B, the display light coupled into kaleidoscopic waveguide 900 may be incident on a side surface 910 and reflected by side surface 910 towards a bottom surface 916 through total internal reflection. The display light incident on bottom surface 916 may be reflected by bottom surface 916 towards a side surface 914 through total internal reflection. The display light incident on side surface 914 may be reflected by side surface 914 towards a top surface 912 through total internal reflection. The display light incident on top surface 912 may be reflected by top surface 912 towards side surface 910 through total internal reflection. In this way, when viewed in the x direction, the display light may be reflected by four surfaces of kaleidoscopic waveguide 900 in each round trip.

Even though not shown in FIGS. 9A and 9B, kaleidoscopic waveguide 900 may include one or more output couplers, such as a surface-relief grating, a holographic grating, transflective mirrors (partially reflective mirrors), an array of micro-mirrors, and the like. The one or more output couplers may split the display light propagating within kaleidoscopic waveguide 900 and couple portions of the display light out of kaleidoscopic waveguide 900 at multiple locations through a surface, such as bottom surface 916, side surface 914, top surface 912, or side surface 910, thereby replicating the exit pupil in one dimension (e.g., approximately the x direction). As first waveguide 616, 720, or 820, kaleidoscopic waveguide 900 may have a relatively large FOV in the dimension in which kaleidoscopic waveguide 900 extends (e.g., the x direction). Due to the reflections at four surfaces of kaleidoscopic waveguide 900 (rather than only the top and bottom surfaces) in each round trip, kaleidoscopic waveguide 900 may also have a large field of view (rather than a line FOV) in a second dimension (e.g., they direction).

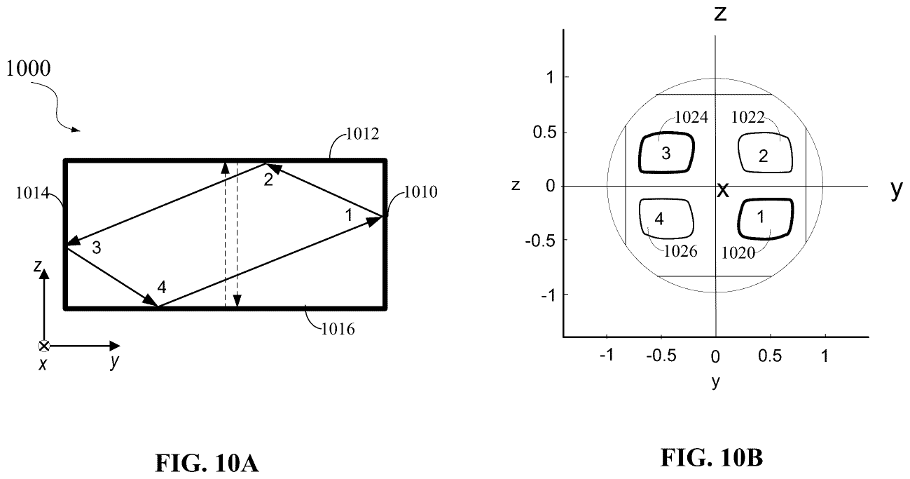

FIG. 10A illustrates light reflections by four surfaces of an example of a kaleidoscopic waveguide 1000 according to certain embodiments. FIG. 10B illustrates wave vectors of display light being reflected by the four surfaces of kaleidoscopic waveguide 1000 of FIG. 10A through total internal reflection according to certain embodiments. In the illustrated example, incident light coupled into kaleidoscopic waveguide 1000 and propagating in approximately the x direction may be reflected at a side surface 1010 of kaleidoscopic waveguide 1000 by a first total internal reflection, and the corresponding wave vectors k (in the y-z plane) of the display light before the first total internal reflection may be shown by a first region 1020 in the y-z plane of the k-space. The corresponding wave vectors k (in the y-z plane) of the display light reflected by the first total internal reflection may be shown by a second region 1022 in the y-z plane of the k-space. Display light reflected by the first total internal reflection may then be reflected at a top surface 1012 of kaleidoscopic waveguide 1000 by a second total internal reflection, and the corresponding wave vectors k (in the y-z plane) of the display light reflected by the second total internal reflection may be shown by a third region 1024 in the y-z plane of the k-space. Display light reflected by the second total internal reflection may subsequently be reflected at a side surface 1014 of kaleidoscopic waveguide 1000 by a third total internal reflection, and the corresponding wave vectors k (in the y-z plane) of the display light reflected by the third total internal reflection may be shown by a fourth region 1026 in the y-z plane of the k-space. Display light reflected by the third total internal reflection may subsequently be reflected at a bottom surface 1016 of kaleidoscopic waveguide 1000 by a fourth total internal reflection, and the corresponding wave vectors k (in the y-z plane) of the display light reflected by the fourth total internal reflection may be shown by first region 1020 in the y-z plane of the k-space. As such, four copies of the display image with different parity may be created by the reflections at the four surfaces in each round trip, where the display images after the first reflection and the third reflection may have the same parity, the display images after the second reflection and fourth reflection may have the same parity, and the display images may be the same after 4N times of reflection with N being an integer number.

FIG. 10A also shows, in dashed lines, the reflection of the display light by only the top and bottom surfaces of a bar-shaped waveguide, where the display light may propagate within the waveguide in the z direction in addition to the x direction and may have a line FOV (e.g., with an FOV about 0° in the y direction). In contrast, in kaleidoscopic waveguide 1000, the display light may propagate within the waveguide in both the y and z directions (in addition to the x direction) in each round trip. Kaleidoscopic waveguide 1000 can be configured such that the reflections by sidewalls can be tolerated, and thus the FOV of kaleidoscopic waveguide 1000 does not need to be a line FOV to avoid reflections by sidewalls and can be large in the y direction as well. As such, the FOV of the display light guided by kaleidoscopic waveguide 1000 can be large in the y direction.

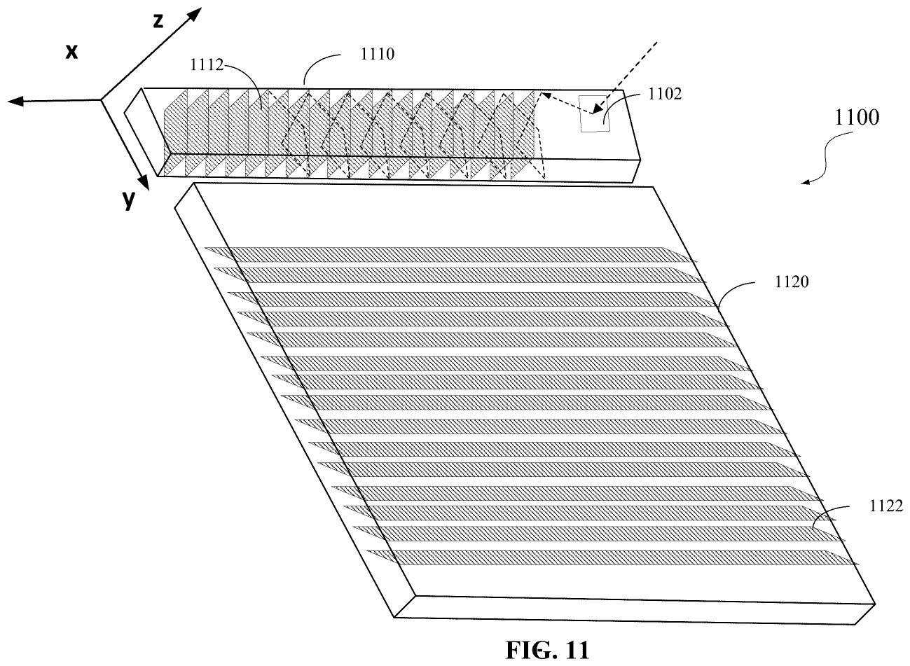

FIG. 11 illustrates an example of a geometrical waveguide display 1100 including a kaleidoscopic geometrical waveguide for pupil expansion and 2-D FOV expansion according to certain embodiments. Geometrical waveguide display 1100 may include a first geometrical waveguide 1110 and a second geometrical waveguide 1120, where first geometrical waveguide 1110 may be adjacent to one edge or on top of an input region of second geometrical waveguide 1120, and may be positioned at a certain orientation (e.g., with edges aligned or at a certain angle) with respect to second geometrical waveguide 1120. First geometrical waveguide 1110 may be a kaleidoscopic geometrical waveguide as described above with respect to FIGS. 9A-First geometrical waveguide 1110 may include an array of transflective mirrors 1112 for coupling portions of light propagating within first geometrical waveguide 1110 out of first geometrical waveguide 1110 towards second geometrical waveguide 1120. Second geometrical waveguide 1120 may include an array of transflective mirrors 1122 configured to couple display light out of second geometrical waveguide 1120.

As described above, transflective mirrors 1112 and 1122 may be partially reflective and partially transmissive, and may split incident light by partially reflecting incident light and partially transmitting the incident light, such that a portion of the incident light may be reflected and coupled out of the waveguide, while a portion of the incident light may continue to propagate within the waveguide to be split by other transflective mirrors. Each transflective mirror may include, for example, a plurality of dielectric coating layers, one or more metal coating layers, or a combination of dielectric coating layers and metal coating layers. For example, a transflective mirror may include a plurality of dielectric coating layers coated on a substrate (e.g., a glass substrate), where the plurality of dielectric coating layers may include two or more different transparent dielectric materials having different refractive indices. The number of dielectric coating layers, and the refractive index and the thickness of each dielectric coating layer may be selected to achieve the desired performance, such as the desired reflectivity, wavelength and angular bandwidth, and polarization performance. A plurality of substrates each with a transflective mirror formed thereon may be stacked and bonded (e.g., glued) together using, for example, optically clear adhesives. The bonded stack may be cut at a certain angle to form one or more geometrical waveguides each including a plurality of transflective mirrors embedded therein and having certain desired tilt angles.

In the example shown in FIG. 11, the display light may be coupled into first geometrical waveguide 1110 by an input coupler 1102, such as a grating, a wedge, or a prism, such that the display light may propagate within first geometrical waveguide 1110 through total internal reflections at four surfaces of first geometrical waveguide 1110 as described above. Therefore, the display light can have a wide FOV in both the x direction and the y direction. Due to the FOV expansion by the kaleidoscopic waveguide, scanning mirrors such as scanning mirror 730 or 830 may not be needed. Transflective mirrors 1112 may couple the display light guided by first geometrical waveguide 1110 out of a surface (e.g., a bottom or sidewall surface) of first geometrical waveguide 1110 at multiple locations along the x directions to replicate the pupil along the x direction.

Display light coupled out of first geometrical waveguide 1110 may be coupled into second geometrical waveguide 1120 directly or by a coupler, through an edge of second geometrical waveguide 1120, to propagate in approximately the y direction within second geometrical waveguide 1120 due to total internal reflection at surfaces of second geometrical waveguide 1120. Display light propagating within second geometrical waveguide 1120 may be coupled out of second geometrical waveguide 1120 (e.g., in directions around the +z or −z direction) at a plurality of locations along approximately the y direction by transflective mirrors 1122. As such, the display light may be replicated along approximately the y direction by second geometrical waveguide 1120. Therefore, first geometrical waveguide 1110 and second geometrical waveguide 1120 in combination may replicate the display light in two dimensions.

In some embodiments, different transflective mirrors in the array of transflective mirrors 1112 or 1122 may have different reflectivity efficiencies. For example, the reflectivity of a first transflective mirror 1112 that may receive the display light before a second transflective mirror 1112 may have a lower reflectivity than the second transflective mirror 1112, such that the portion of the display light reflected by the first transflective mirror 1112 may have a similar intensity as the portion of the display light reflected by the second transflective mirror 1112. Transflective mirrors 1112 and 1122 may have much wider angular and spectral bandwidths and may have higher efficiency than grating based couplers.

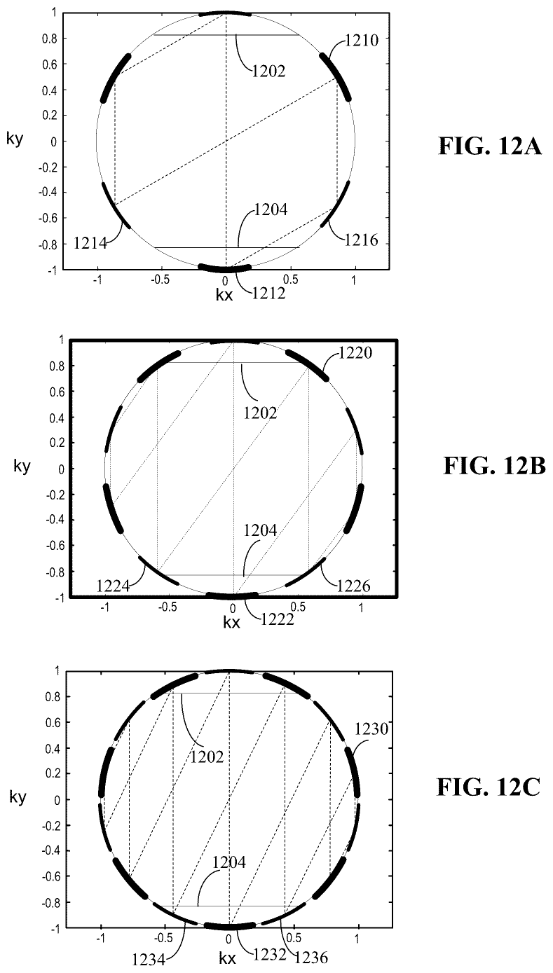

FIGS. 12A-12C illustrate k-vectors of light frustums propagating within a geometrical waveguide and reflected by mirrors and surfaces of the geometrical waveguide. FIGS. 12A-12C show the k-vectors projected onto an x-y plane (a k-circle). The region between lines 1202 and 1204 represents k-vectors of light that may be guided by a geometrical waveguide, while regions above line 1202 and below line 1204 represent k-vectors of light that may be refracted out of the geometrical waveguide. In the illustrated example, the transflective mirrors in the geometrical waveguide may be tilted at angle θ 180/N (where N is an odd number) with respect to the top or bottom surface (e.g., on x-y planes) of the waveguide. The k-frustum of the displayed image may fall on the same position on the k-circle with the same parity after 2N times of reflections. In FIGS. 12A-12C, slanted and dashed lines indicate reflections by transflective mirrors, while vertical dashed lines indicate reflection by the top and bottom surfaces of the geometrical waveguide. The light frustum may change parity each time it is reflected, as indicated by the different thicknesses of the arcs on the k-circle. In FIGS. 12A-12C, arcs having the same thickness represent images having the same parity.

FIG. 12A illustrates k-vectors of light beams in a light frustum propagating within an example of a geometrical waveguide and reflected by surfaces and transflective mirrors having a first orientation in the geometrical waveguide (e.g., about 180/3=60° with respect to an out-coupling surface of the geometrical waveguide). As illustrated, when the tilt angle of the transflective mirrors is about 180°/N, where N is an odd number, there may be 2N arcs evenly distributed on the k-circle, where the 2N arcs represent light frustums (images) reflected by transflective mirrors and surfaces of the waveguide. In the example shown in FIG. 12A, N=3, and there may be 6 different light frustums reflected by transflective mirrors and surfaces of the geometrical waveguide, as indicated by the 6 arcs 1210. An arc 1212 below line 1204 or above line 1202 represents the light frustum of an image that may be coupled out of the top or bottom surface of the geometrical waveguide because the total internal reflection condition is not met. FIG. 12A shows that images (represented by arcs 1214 and 1216) having parity different from the parity of a displayed image (represented by arc 1212) may be far from the displayed image, and may not be coupled out of a same surface of the geometrical waveguide, even when the FOV of the light frustum is large. Therefore, when N is small, the FOV supported by the geometrical waveguide can be increased to a large value, without causing ghost images that may overlap the displayed images, even when the refractive index of the waveguide is low.

FIG. 12B illustrates k-vectors of light beams propagating within an example of a geometrical waveguide and reflected by surfaces and transflective mirrors having a second orientation (e.g., about 180/5=36° with respect to an out-coupling surface of the geometrical waveguide) in the geometrical waveguide. In the example shown in FIG. 12B, N=5, and there may be 10 different light frustums reflected by transflective mirrors and surfaces of the waveguide, as indicated by the 10 arcs 1220. Therefore, to avoid signal-ghost overlapping, the FOV supported by the waveguide display may be smaller than that of the waveguide display shown in FIG. 12A. An arc 1222 above line 1202 or below line 1204 represents the light frustum of a displayed image that may be coupled out of the top or bottom surface of the geometrical waveguide. FIG. 12B shows that portions of two ghost images (represented by arcs 1224 and 1226) having a parity different from the parity of the displayed image (represented by arc 1222) may also be coupled out the geometrical waveguide. But the k-frustums of the two ghost images closest to the displayed image and coupled out of the geometrical waveguide may be located symmetrically with respect to (having equal distance from) the k-frustum of the displayed image. Therefore, the supported FOV can be optimized to a large value, without causing signal-ghost overlapping.

FIG. 12C illustrates k-vectors of light beams propagating within an example of a geometrical waveguide and reflected by surfaces and transflective mirrors having a third orientation (e.g., about 180/7=25.7° with respect to an out-coupling surface of the geometrical waveguide) in the geometrical waveguide. In the example shown in FIG. 12C, N=7, and there may be 14 different light frustums reflected by mirrors and surfaces of the geometrical waveguide, as indicated by the 14 arcs 1230. Therefore, to avoid signal-ghost overlapping, the FOV supported by the waveguide display may be smaller than that of the waveguide display shown in FIG. 12B. An arc 1232 above line 1202 or below line 1204 represents the light frustum of a displayed image that may be coupled out of the top or bottom surface of the geometrical waveguide. FIG. 12C shows that two ghost images (represented by arcs 1234 and 1236) having a parity different from the parity of the displayed image (represented by arc 1232) may also be coupled out the geometrical waveguide. But the k-frustums of the two ghost images closest to the displayed image may be located symmetrically with respect to (having equal distance from) the k-frustum of the displayed image. Therefore, the supported FOV may be optimized to a relatively large value, without causing signal-ghost overlapping.

FIGS. 12A-12C show that, when the transflective mirrors are tilted at an angle equal to about 180°/N (e.g., within about ±5% or ±10%) in a geometrical waveguide, where N is an odd number, k-frustums of the two images closest to the displayed image and having parity opposite to the parity of the displayed image may be located symmetrically with respect to (having equal distance from) the k-frustum of the displayed image. Therefore, the supported FOV can be optimized to a relatively large value, without causing signal-ghost overlapping. FIGS. 12A-12C also show that, when N is smaller, a lager FOV may be supported by the waveguide display, and the ghost images may be trapped in the waveguide, even if the refractive index of the waveguide is lower.

In contrast, when the transflective mirrors are tilted at an angle equal to 180°/N within a geometrical waveguide, with N being an even number, there may be 2N different light frustums reflected by transflective mirrors and surfaces of the geometrical waveguide, but the 2N different light frustums may be at N different locations of the k-circle, because the k-frustum of the displayed image may go back to the original position with the opposite parity after an odd number of reflection. As such, a ghost image with the opposite parity may also be coupled out of the geometrical waveguide and may overlap the displayed image to degrade the quality of the displayed image. Therefore, to reduce or avoid ghost images, the transflective mirrors in geometrical waveguide displays may need to be oriented at angle about 180°/N, with N being an odd number.

In an optical system, when the optical aperture of the optical system has a limited size (e.g., a limited diameter D), the minimum size of the center bright region of the best-focused light spot may be limited by the diffraction limit due to the limited size of the optical aperture. The best-focused light spot may have the first minimum at an angle θ (e.g., viewed from the optical aperture) that is approximately given by:

$$sin θ \approx 1.22 \frac{λ}{D} ,$$

where λ is the wavelength of the light beam. Therefore, a larger optical aperture or a larger input light beam may result in a better resolution (smaller spots). Increasing the size of the optical aperture or the light beam may improve the modulation transfer function (MTF), and thus may improve the contrast of the images in addition to the resolution of the images. In geometrical waveguide displays, when the angle between the transflective mirrors and the out-coupling surface (e.g., broadside surface) of the waveguide is large (e.g., close to 90°), the sizes of the light beams reflected by the transflective mirrors may be small. Therefore, the minimum spot size of the images on the image plane may be large, and thus the optical resolution of the waveguide display system may be low.

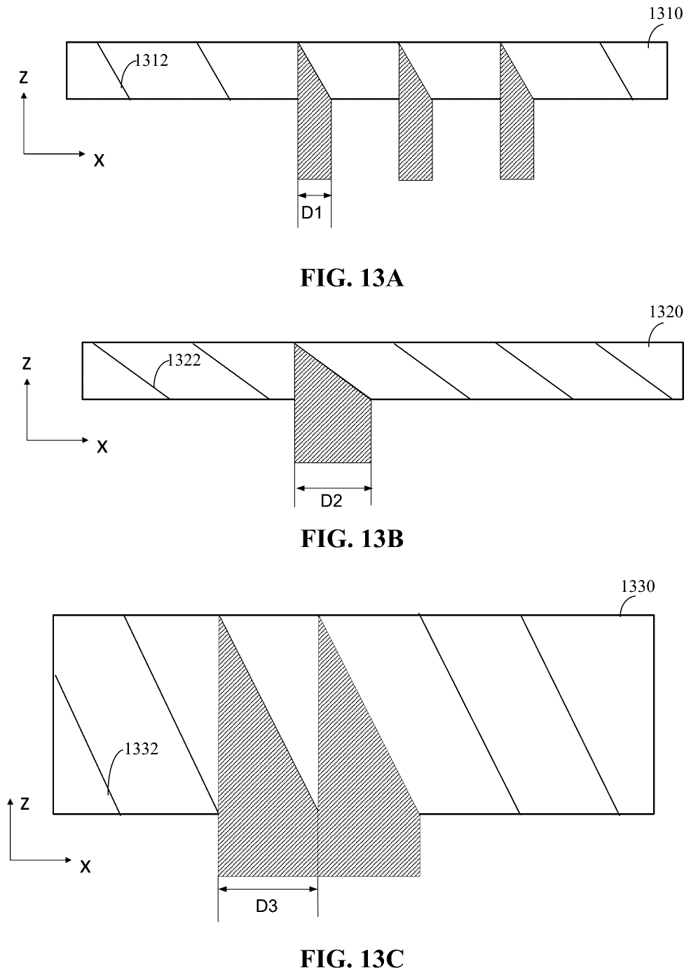

FIG. 13A illustrates an example of a pupil expander in the form of a geometrical waveguide 1310 that includes a set of transflective mirrors 1312 within geometrical waveguide 1310. In the illustrated example, the angle between transflective mirrors 1312 and broadside surfaces (e.g., x-y planes) of geometrical waveguide 1310 may be large (e.g., about 180/3=60°), and the diameter D1 of the reflected beam (measured in the x direction) may be small. As such, the modulation transfer function (MTF) of the pupil expander may be low, and the resolution and/or the contrast of the images displayed to the user's eye may be low. In addition, as shown in FIG. 13A, due to the small size of each replicated pupil, there may be gaps between the replicated pupils. As such, the pupil replication density may be low, and the replicated pupils may not fill the eyebox. Therefore, the image uniformity in the eyebox may be low.

FIG. 13B illustrates another example of a pupil expander in the form of a geometrical waveguide 1320 that includes a set of transflective mirrors 1322 within geometrical waveguide 1320 according to certain embodiments. In the illustrated example, the angle between transflective mirrors 1322 and the out-coupling surface of geometrical waveguide 1320 may be small (e.g., about 180/5=36°), and thus the diameter D2 of the reflected beam (measured in the x direction) may be large. As such, the MTF of the pupil expander may be higher, the resolution and/or the contrast of the images displayed to the user's eye may be better, and the replicated pupils may more uniformly fill the eyebox.

Therefore, as shown by FIGS. 12A-12C, in geometrical waveguide based waveguide displays, if the waveguide displays are not properly designed, the multiple images generated by the reflections at surfaces of the transflective mirrors may decrease the overall efficiency and may cause ghost images. For example, when the orientations of the geometrical mirrors are tuned (e.g., at large angles with respect to the surfaces of the waveguides) to improve the efficiency and field of view and reduce ghost images, the pupil replication density may be low and the image resolution may be low. Thick waveguides with transflective mirrors having large tilt angles with respect to the surfaces of the waveguides may be used to improve the pupil size and the resolution, but may increase the size and weight of the waveguide display.

FIG. 13C illustrates an example of a pupil expander in the form of a geometrical waveguide 1330 that includes a set of transflective mirrors 1332 within geometrical waveguide 1330 according to certain embodiments. In the illustrated example, the angle between transflective mirrors 1332 and the out-coupling surface of geometrical waveguide 1330 may be large (e.g., about 180/3=60°). But the thickness (in z direction) may be much higher than that of geometrical waveguide 1310. As such, the diameter D3 of the reflected beam (measured in the x direction) may be large. Therefore, the MTF of the pupil expander may be higher, the resolution and/or the contrast of the images displayed to the user's eye may be better, and the replicated pupils may more uniformly fill the eyebox. However, increasing the thickness of the geometrical waveguide as shown in FIG. 13C may significantly increase the size and weight of the waveguide display.

According to certain embodiments disclosed herein, a geometrical waveguide display may include a kaleidoscopic geometrical waveguide and an output geometrical waveguide arranged side by side, where the orientations and dimensions of the waveguides and the orientations of the geometrical mirrors (transflective mirrors) may be selected such that the field of view may be maximized, ghost images may be trapped in the waveguide, and more images reflected by the kaleidoscopic geometrical waveguide may be used for displaying images to the user, thereby reducing or eliminating ghost images caused by multiple images generated by the kaleidoscopic geometrical waveguide, and improving the field of view, efficiency, resolution, and pupil replication density and uniformity of the waveguide display, without using thick waveguides and/or high refractive index waveguide materials.

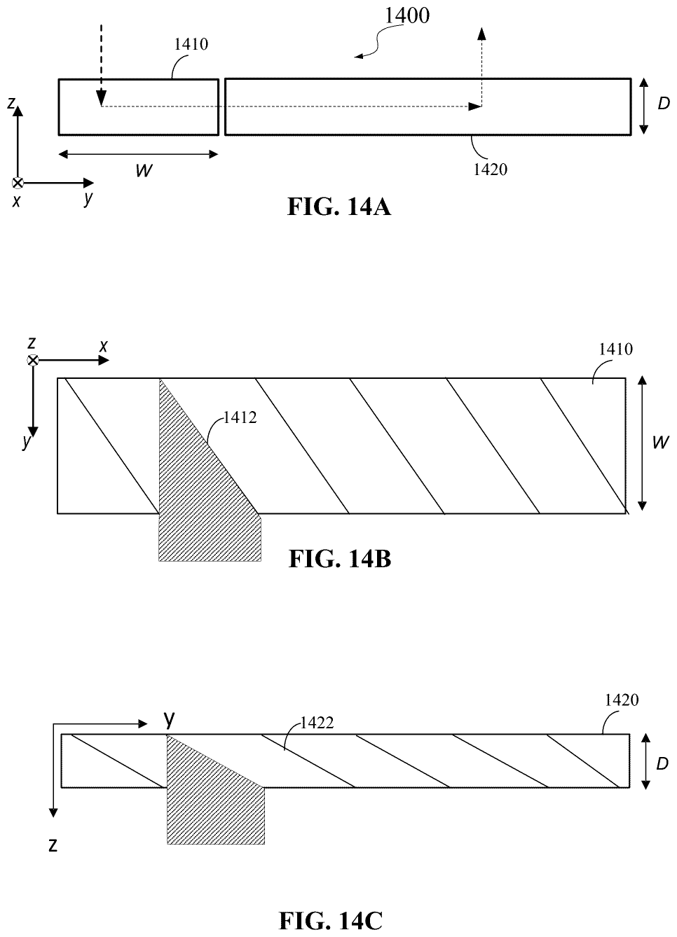

FIGS. 14A-14C illustrate an example of a geometrical waveguide display 1400 including a kaleidoscopic geometrical waveguide 1410 according to certain embodiments. Geometrical waveguide display 1400 may be an example of geometrical waveguide display 1100. In the illustrated example, kaleidoscopic geometrical waveguide 1410 may be positioned side-by-side with an output geometrical waveguide 1420, where the output surface (e.g., a side surface on an x-z plane) of kaleidoscopic geometrical waveguide 1410 may be parallel to the input surface (e.g., a side surface) of output geometrical waveguide 1420 and there may be air or another low refractive index material between kaleidoscopic geometrical waveguide 1410 and output geometrical waveguide 1420 to cause total internal reflection in kaleidoscopic geometrical waveguide 1410. Kaleidoscopic geometrical waveguide 1410 and output geometrical waveguide 1420 may have the same thickness D (e.g., less than a few millimeters, such as about 1 mm) or different thicknesses. Both kaleidoscopic geometrical waveguide 1410 and output geometrical waveguide 1420 may include embedded transflective mirrors. Display light may be coupled into kaleidoscopic geometrical waveguide 1410 (e.g., in approximately −z direction), guided by surfaces of kaleidoscopic geometrical waveguide 1410, replicated along the x direction by transflective mirrors, and be coupled out of kaleidoscopic geometrical waveguide 1410 in approximately the y direction into output geometrical waveguide 1420. Output geometrical waveguide 1420 may replicate the display light in approximately the y direction and couple the display light out of output geometrical waveguide 1420 in approximately the z direction as shown in FIG. 14A.

In the illustrated example, to improve the field of view, efficiency, resolution, and pupil replication density and uniformity of the waveguide display without using thick waveguides and high refractive index material, kaleidoscopic geometrical waveguide 1410 and output geometrical waveguide 1420 may be positioned side by side. Transflective mirrors 1412 in kaleidoscopic geometrical waveguide 1410 may be oriented at an angle about 60° (≈180°/3) with respect to a side surface (e.g., in an x-z plane) of kaleidoscopic geometrical waveguide 1410, while transflective mirrors 1422 in output geometrical waveguide 1420 may be oriented at an angle about 36° (≈180°/5) with respect to a top or bottom surface (e.g., in an x-y plane) of output geometrical waveguide 1420.

As illustrated, kaleidoscopic geometrical waveguide 1410 may have a width W (e.g., 5 mm or larger) in the y direction, and display light guided by kaleidoscopic geometrical waveguide 1410 may be coupled out of kaleidoscopic geometrical waveguide 1410 in the y direction through a side surface. Therefore, width W may be the effective thickness of kaleidoscopic geometrical waveguide 1410 in the light out-coupling direction. As shown in FIG. 14B and described above with respect to FIG. 13C, when transflective mirrors 1412 in kaleidoscopic geometrical waveguide 1410 are oriented at an angle about 60° (≈180°/3) with respect to an out-coupling surface (e.g., in an x-z plane) of kaleidoscopic geometrical waveguide 1410, and the width W of kaleidoscopic geometrical waveguide 1410 in the light out-coupling direction is large, the diameter of the reflected beam (measured in the x direction) may be large. Therefore, the MTF of kaleidoscopic geometrical waveguide 1410 may be higher, the resolution and/or the contrast of the images replicated by kaleidoscopic geometrical waveguide 1410 may be better, and the pupil replication density and uniformity may be improved in the x direction. In addition, as described above with respect to FIG. 12A, when transflective mirrors 1412 are oriented at about 60° (≈180°/3) with respect to the out-coupling surface of kaleidoscopic geometrical waveguide 1410, the FOV supported by kaleidoscopic geometrical waveguide 1410 can be large, and the ghost images may be trapped within the waveguide (without being coupled out), even when the refractive index of the waveguide is low.

For output geometrical waveguide 1420 that may have a large area and may out-couple display light in approximately the z direction, the tilt angle of transflective mirrors 1422 with respect to the out-coupling surface (e.g., an x-y plane) may be selected to a be a smaller value, in order to improve the MTF, resolution, and pupil replication density and uniformity of the waveguide display, and avoid using thick and heavy output geometrical waveguide 1420 and/or high refractive index materials. On the other hand, in order to reduce ghost images and achieve a large field of view, the tilt angle of transflective mirrors 1422 with respect to an x-y plane may need to be large as described above with respect to FIGS. 12A-12C. In the illustrated example, transflective mirrors 1422 in output geometrical waveguide 1420 may be oriented at an angle about 36° (≈180°/5) with respect to an out-coupling surface of output geometrical waveguide 1420, such that a good image quality may be achieved and the size of the waveguide display may be small.

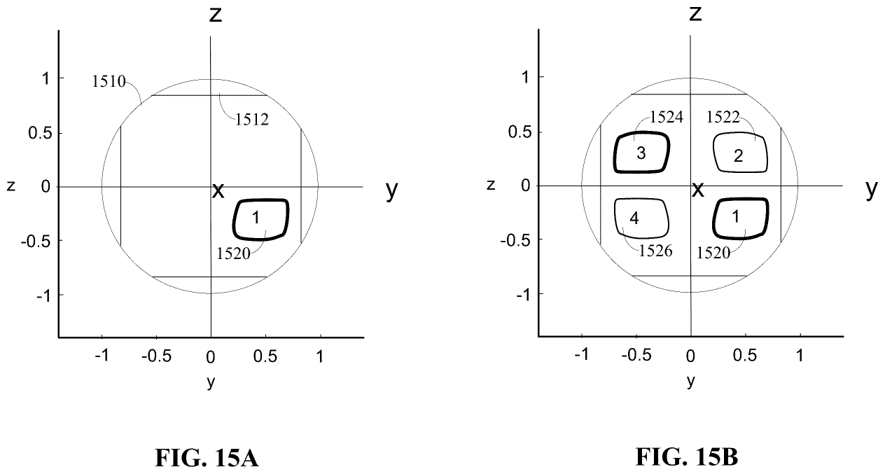

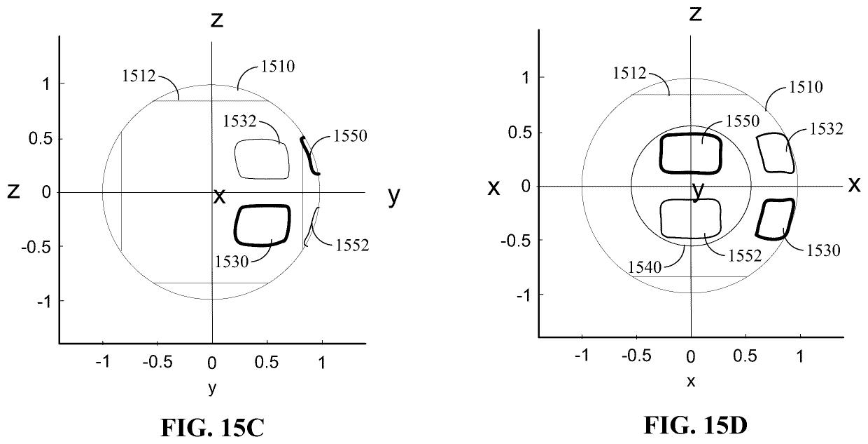

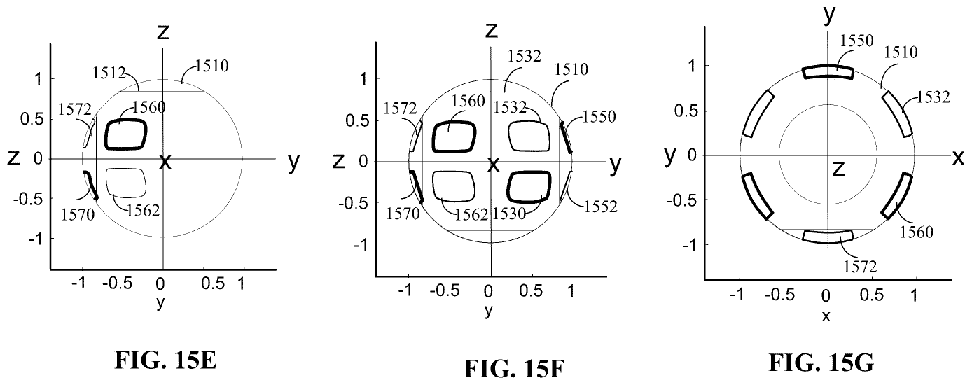

FIG. 15A illustrates wave vectors of display light coupled into the kaleidoscopic geometrical waveguide (e.g., kaleidoscopic geometrical waveguide 1410) of geometrical waveguide display 1400 of FIGS. 14A-14C according to certain embodiments. FIG. 15A shows the k-vectors of in-coupled display light projected onto a y-z plane (in a k-circle 1510). Lines 1512 indicate the total internal reflection boundary at four sidewalls of kaleidoscopic geometrical waveguide 1410, where the region bounded by lines 1512 indicates wave vectors of light that may be guided by kaleidoscopic geometrical waveguide 1410, while other regions outside of lines 1202 represent k-vectors of light that may be refracted out of kaleidoscopic geometrical waveguide 1410. FIG. 15A shows one k-frustum 1520 representing a single image coupled into kaleidoscopic geometrical waveguide 1410. The image may have a field of view, for example, about 60°×40°.

FIG. 15B illustrates wave vectors of display light reflected by surfaces (sidewalls) of kaleidoscopic geometrical waveguide 1410 of geometrical waveguide display 1400 according to certain embodiments. A k-frustum 1522 in FIG. 15B represents an image of the in-coupled image reflected by a first surface of kaleidoscopic geometrical waveguide 1410, which may have the opposite parity compared with the in-coupled image represented by k-frustum 1520. A k-frustum 1524 represents an image reflected by a second surface of kaleidoscopic geometrical waveguide 1410, which may have the same parity (due to two reflections) as the in-coupled image represented by k-frustum 1520. A k-frustum 1526 represents an image reflected by a third surface of kaleidoscopic geometrical waveguide 1410, which may have the opposite parity compared with the in-coupled image represented by k-frustum 1520. The image represented by k-frustum 1526 may be reflected by a fourth surface of kaleidoscopic geometrical waveguide 1410, where the reflected image may be represented by the same k-frustum 1520 as described above with respect to FIG. 10B.

FIG. 15C illustrates k-vectors of display light reflected by transflective mirrors 1412 of kaleidoscopic geometrical waveguide 1410 according to certain embodiments, where the k-vectors are projected onto a plane (e.g., a y-z plane) of the k-sphere. FIG. 15D illustrates k-vectors of display light reflected by transflective mirrors 1412 of kaleidoscopic geometrical waveguide 1410 according to certain embodiments, where the k-vectors are projected onto a plane (e.g., an x-z plane) of the k-sphere. As described above, transflective mirrors 1412 may be oriented at an angle about 60° with respect to the x direction or an x-z plane. Images reflected by transflective mirrors 1412 may be represented by k-frustums 1530, 1532, 1550, and 1552, where images represented by k-frustums 1550 and 1552 may be within a circle 1540 representing k-vectors of light that may not meet the TIR condition and thus may be refracted out a surface (e.g., in an x-z plane) of kaleidoscopic geometrical waveguide 1410.

FIG. 15E illustrates wave vectors of display light reflected by transflective mirrors 1412 and the reflected by surfaces (sidewalls) of kaleidoscopic geometrical waveguide 1410 of geometrical waveguide display 1400 according to certain embodiments. Images reflected by transflective mirrors 1412 and sidewalls of kaleidoscopic geometrical waveguide 1410 may be represented by k-frustums 1560, 1562, 1570, and 1572, where images represented by k-frustums 1570 and 1572 may not meet the TIR condition and thus may be refracted out a surface (e.g., in an x-z plane) of kaleidoscopic geometrical waveguide 1410. The images shown by the k-frustums of FIGS. 15D and 15E may continue to be reflected by transflective mirrors 1412 and surfaces of kaleidoscopic geometrical waveguide 1410 as the display light propagates within kaleidoscopic geometrical waveguide 1410 along, for example, approximately the x direction.

FIG. 15F illustrates wave vectors of display light reflected by surfaces and transflective mirrors of kaleidoscopic geometrical waveguide 1410 of geometrical waveguide display 1400 according to certain embodiments, where the wave vectors are projected onto a y-z plane of a k-sphere. FIG. 15G illustrates wave vectors of display light reflected by surfaces and transflective mirrors of kaleidoscopic geometrical waveguide 1410 of geometrical waveguide display 1400 according to certain embodiments, where the wave vectors are projected onto an x-y plane of a k-sphere. Since transflective mirrors 1412 are oriented at an angle about 60° with respect to the x direction or an x-z plane, the k-frustums of the reflected images by both the transflective mirrors and the waveguide surface may fall on 12 different regions representing 12 different images, where four images represented by k-frustums 1550, 1552, 1570, and 1572 may be coupled out of kaleidoscopic geometrical waveguide 1410 in ±y directions. Other images represented by other k-frustums may be trapped within kaleidoscopic geometrical waveguide 1410. To improve the efficiency of geometrical waveguide display 1400, it may be desirable to only couple the display light out of kaleidoscopic geometrical waveguide 1410 in approximately the y direction such that the out-coupled light may be coupled into output geometrical waveguide 1420 for further pupil expansion and image projection to user's eyes.

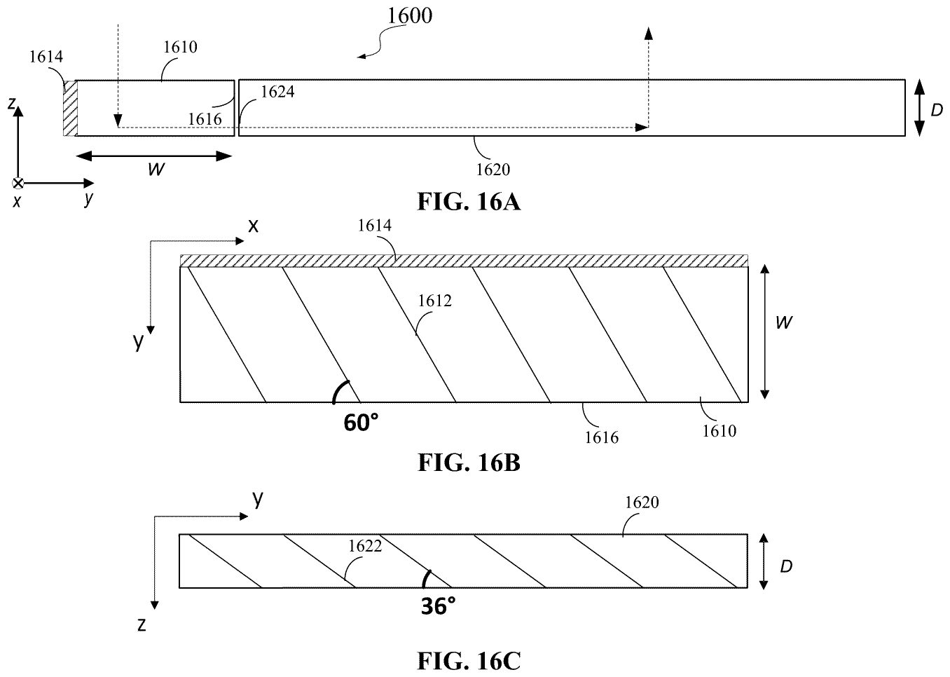

FIGS. 16A-16C illustrate an example of a geometrical waveguide display 1600 including a kaleidoscopic geometrical waveguide 1610 according to certain embodiments. Geometrical waveguide display 1600 may be similar to geometrical waveguide display 1400. As illustrated, geometrical waveguide display 1600 may include transflective mirrors 1612 in kaleidoscopic geometrical waveguide 1610, where transflective mirrors 1612 may be oriented at about 60° (e.g., within about ±5% or ±10%) with respect to the x direction or an x-z plane. Geometrical waveguide display 1600 may also include an output geometrical waveguide 1620 including transflective mirrors 1622 formed therein. Transflective mirrors 1612 may be oriented at about 36° (e.g., within about ±5% or ±10%) with respect to the y direction or an x-y plane. Kaleidoscopic geometrical waveguide 1610 and output geometrical waveguide 1620 may be positioned side-by-side as shown in FIG. 16A, where an air gap or a low refractive index material may be between kaleidoscopic geometrical waveguide 1610 and output geometrical waveguide 1620, to cause total internal reflection at a surface 1616. The thicknesses D of kaleidoscopic geometrical waveguide 1610 and output geometrical waveguide 1620 may be, for example, about 1 mm in the z direction, and the width W of kaleidoscopic geometrical waveguide 1610 may be about, for example, 5 mm.

In addition, geometrical waveguide display 1600 may include a mirror 1614 on a surface of kaleidoscopic geometrical waveguide 1610 opposing surface 1616. Mirror 1614 may have a reflectivity close to 100% such that images represented by k-frustums 1570 and 1572 may not be coupled out of kaleidoscopic geometrical waveguide 1610, and may be further reflected until they become images represented by k-frustums 1550 and 1552, which may then be coupled out of kaleidoscopic geometrical waveguide 1610 through surface 1616. Display light coupled out of surface 1616 of kaleidoscopic geometrical waveguide 1610 may be coupled into output geometrical waveguide 1620 from an edge 1624 adjacent to surface 1616 of kaleidoscopic geometrical waveguide 1610.

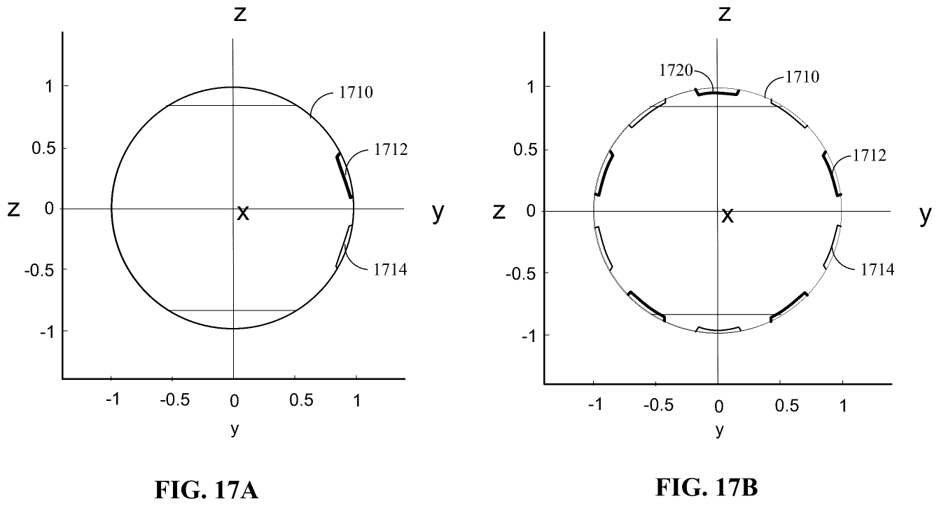

FIG. 17A illustrates wave vectors of display light coupled out of kaleidoscopic geometrical waveguide 1410 or 1610 and into output geometrical waveguide 1420 or 1620 and propagating within output geometrical waveguide 1420 or 1620 of the geometrical waveguide display disclosed herein according to certain embodiments. FIG. 17A shows k-frustums 1712 and 1714 on a k-circle 1710. K-frustums 1712 and 1714 represent two images having opposite parity and propagating within the output geometrical waveguide. Both images may be used as the signal for displaying to the user.

FIG. 17B illustrates wave vectors of display light reflected by surfaces and geometric mirrors of output geometrical waveguide 1620 of geometrical waveguide display 1600 of FIGS. 16A-16C according to certain embodiments. As described above with respect to FIG. 12B, when the transflective mirrors are oriented at an angle about 36° (≈180°/5) with respect to the out-coupling surface, there may be about 10 different images reflected by the transflective mirrors and surfaces (e.g., top and bottom surfaces) of output geometrical waveguide 1620. One image represented by a k-frustum 1720 may be coupled out of output geometrical waveguide 1620 in the z direction towards the user's eye. As described above and shown in FIG. 17B, when the transflective mirrors are tilted at an angle equal to about 180°/N (e.g., within about ±5% or ±10%) with N being an odd number, k-frustums of two images closest to the displayed image and having a parity opposite to the parity of the displayed image may be located symmetrically with respect to (having equal distance from) k-frustum 1720 of the displayed image. Therefore, the supported FOV can be optimized to a large value, without displaying ghost images to the user.

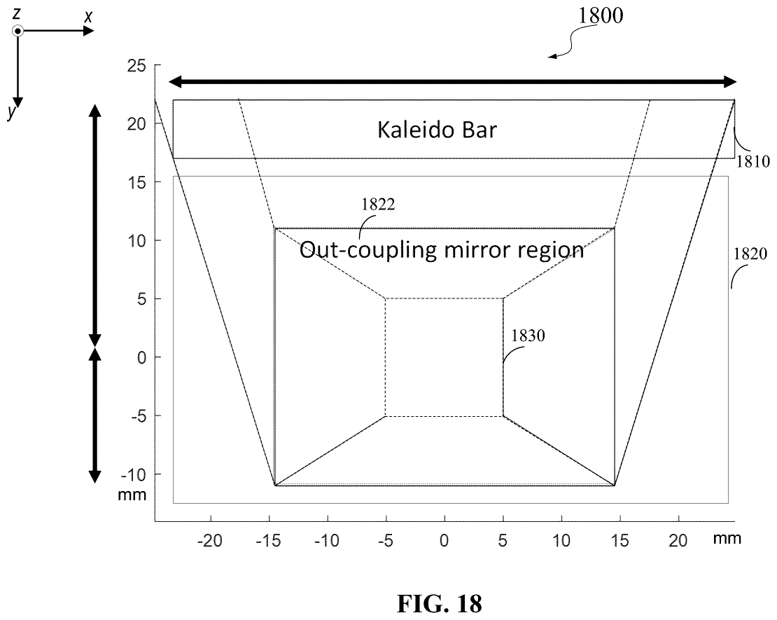

FIG. 18 illustrates an example of a geometrical waveguide display 1800 including a kaleidoscopic geometrical waveguide 1810 and an output geometrical waveguide 1820 according to certain embodiments. Geometrical waveguide display 1800 may be an example of geometrical waveguide display 1400 or 1600. FIG. 18 shows the dimensions of the example of geometrical waveguide display 1800. As described above, kaleidoscopic geometrical waveguide 1810 may include transflective mirrors oriented at about 60° with respect to the x direction or an x-z plane. Kaleidoscopic geometrical waveguide 1810 may also include a mirror on a surface in an x-z plane as described above with respect to FIGS. 16A-16C. Output geometrical waveguide 1820 may include transflective mirrors in a region 1822 for coupling display light out of output geometrical waveguide 1820 in the z direction towards an eyebox 1830 of geometrical waveguide display 1800. Transflective mirrors in a region 1822 may be oriented at an angle about 180°/N with N being an odd number, such as 5 or 7.

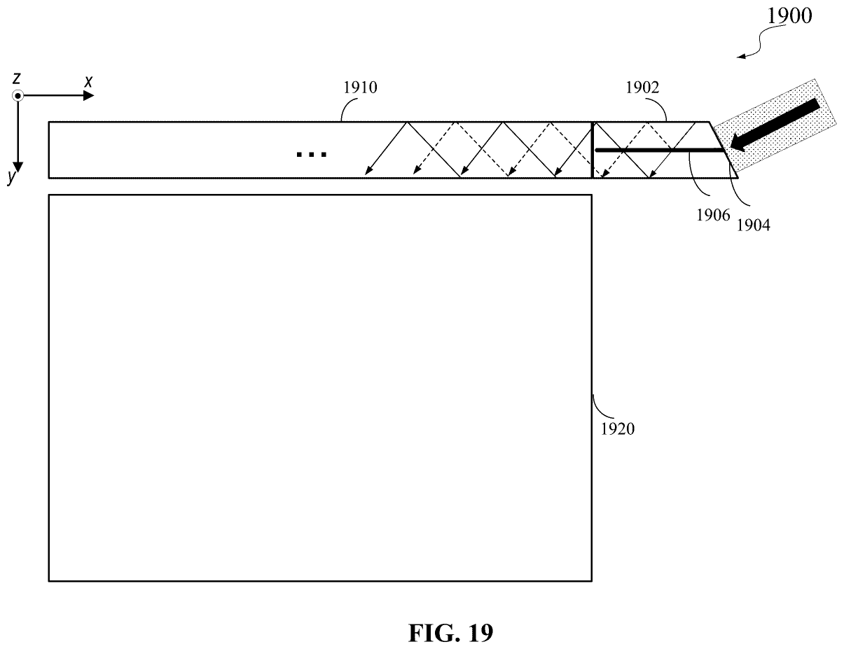

FIG. 19 illustrates an example of a geometrical waveguide display 1900 including a kaleidoscopic geometrical waveguide 1910 according to certain embodiments. Geometrical waveguide display 1900 may be an example of geometrical waveguide display 1400, 1600, or 1800. Kaleidoscopic geometrical waveguide 1910 may be similar to kaleidoscopic geometrical waveguide 1610 or 1810. An output geometrical waveguide 1920 may be similar to output geometrical waveguide 1620 or 1820 described above.

Geometrical waveguide display 1900 may include an input coupler 1902 for coupling display light of an image into kaleidoscopic geometrical waveguide 1910. In the illustrated example, input coupler 1902 may have a wedge shape such that light incident on a slanted surface 1904 of input coupler 1902 may be refracted into input coupler 1902 and kaleidoscopic geometrical waveguide 1910 at a direction such that the coupled light may be reflected by four surfaces of kaleidoscopic geometrical waveguide 1910. In the illustrated example, input coupler 1902 may include a 50:50 beam splitter 1906 (or a partial reflector) in an x-z plane. Beam splitter 1906 may split the input image into two images that may reach a surface of kaleidoscopic geometrical waveguide 1910 at interleaved locations as shown by the solid lines and dashed lines in FIG. 19, such that the pupil density may be doubled and the image uniformity in the eyebox may be improved. In some embodiments, a 50:50 beam splitter or partial reflector may be positioned in an x-y plane in input coupler 1902 or kaleidoscopic geometrical waveguide 1910 to further increase the pupil replication density and the image uniformity in the eyebox.

In view of this description, embodiments may include different combinations of features. Certain embodiments are described in the following examples.

In Example 1, a waveguide display may include a first geometrical waveguide comprising: a first substrate extending in a first direction; an input coupler configured to couple display light into the first substrate such that the display light is reflected through total internal reflection by three or more surfaces of the first substrate that are parallel to the first direction to propagate within the first substrate along the first direction; and a first plurality of transflective mirrors in the first substrate and configured to couple the display light out of a first surface of the first substrate at a first plurality of locations along the first direction towards a second direction that is different from the first direction. The waveguide display may also include a second geometrical waveguide comprising: a second substrate; and a second plurality of transflective mirrors in the second substrate and configured to deflect, at a second plurality of locations along substantially the second direction, the display light from the first substrate towards an eyebox of the waveguide display.

In Example 2, the first substrate and the second substrate in the waveguide display of Example 1 are separated in the second direction by an air gap or a low refractive index material.

In Example 3, the first substrate and the second substrate in the waveguide display of Example 1 or 2 are characterized by a same thickness in a third direction perpendicular to the first direction and the second direction.

Example 4 includes the waveguide display of Example 3, wherein: the first substrate has a bar shape and has a cross-section characterized by a shape of a rectangle; a width of the first substrate in the second direction is greater than the thickness in the third direction; and the first plurality of transflective mirrors is characterized by a tilt angle about 60° with respect to the first direction.

Example 5 includes the waveguide display of Example 4, wherein the width of the first substrate in the second direction is greater than two times of the thickness in the third direction.

Example 6 includes the waveguide display of any of Examples 1-5, wherein the second plurality of transflective mirrors is tilted at an angle about 180°/N with respect to the second direction, wherein N is an odd number.

Example 7 includes the waveguide display of Example 6, wherein the second plurality of transflective mirrors is tilted at an angle about 36° with respect to the second direction.

Example 8 includes the waveguide display of any of Examples 1-7, wherein the first geometrical waveguide comprises a mirror on a surface opposing the first surface, the mirror characterized by a reflectivity greater than 90%.

Example 9 includes the waveguide display of any of Examples 1-8, wherein the input coupler comprises a wedge or a prism.

Example 10 includes the waveguide display of any of Examples 1-9, wherein the input coupler includes: a 50:50 beam splitting layer substantially parallel to the first direction and the second direction; a 50:50 beam splitting layer substantially parallel to the first direction and substantially perpendicular to the second direction; or a combination thereof.

Example 11 includes the waveguide display of any of Examples 1-10, wherein a field of view of the waveguide display is greater than 60°×40°.

In Example 12, a near-eye display system comprising: an image source configured to emit display light for displaying images; display optics configured to project the display light; a first pupil expander extending in a first direction and including a first plurality of transflective mirrors, the first pupil expander configured to reflect the display light from the display optics through total internal reflection at three or more surfaces that are parallel to the first direction to guide the display light in the first direction, and couple, by the first plurality of transflective mirrors, the display light out of a first surface of the first pupil expander at a first plurality of locations along the first direction towards a second direction that is different from the first direction; and a second pupil expander including a second plurality of transflective mirrors configured to couple the display light from each location of the first plurality of locations of the first pupil expander out of the second pupil expander at a second plurality of locations along the second direction, wherein the display light from each location of the first plurality of locations of the first pupil expander is coupled into the second pupil expander through an edge of the second pupil expander.

Example 13 includes the near-eye display system of Example 12, wherein the first plurality of transflective mirrors is tilted at an angle about 60° with respect to the first direction.

Example 14 includes the near-eye display system of Example 12 or 13, wherein the second plurality of transflective mirrors is tilted at an angle about 180°/N with respect to the second direction, where N is an odd number.

Example 15 includes the near-eye display system of Example 14, wherein the second plurality of transflective mirrors is tilted at an angle about 36° with respect to the second direction.

Example 16 includes the near-eye display system of any of Examples 12-15, wherein the first pupil expander and the second pupil expander are characterized by a same thickness in a third direction perpendicular to the first direction and the second direction.

Example 17 includes the near-eye display system of Example 16, wherein a width of the first pupil expander in the second direction is greater than two times of the thickness in the third direction.

Example 18 includes the near-eye display system of any of Examples 12-17, wherein the first pupil expander comprises a mirror on a surface opposing the first surface, the mirror characterized by a reflectivity greater than 90%.

In Example 19, the near-eye display system of any of Examples 12-18 further comprises an input coupler configured to couple the display light from the display optics into the first pupil expander such that the display light from the display optics is reflected at the three or more surfaces through total internal reflection.

Example 20 includes the near-eye display system of Example 19, wherein the input coupler includes: a 50:50 beam splitting layer substantially parallel to the first direction and the second direction; a 50:50 beam splitting layer substantially parallel to the first direction and substantially perpendicular to the second direction; or a combination thereof.

### IV. Improving Pupil Replication Density in Geometrical Waveguide

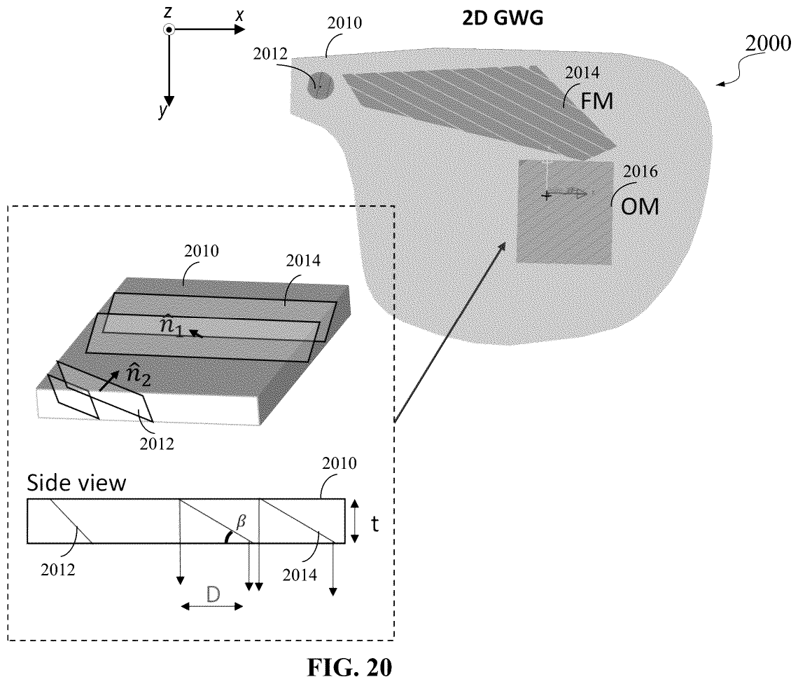

FIG. 20 illustrates an example of a waveguide display 2000 including three groups of reflective and/or transflective mirrors for two-dimensional pupil expansion according to certain embodiments. Waveguide display 2000 may be an example of a geometrical waveguide display. In the example illustrated in FIG. 20, waveguide display 2000 may include a waveguide 2010 that includes multiple groups of mirrors and may be referred to as a geometrical waveguide (GWG). Waveguide display 2000 may include an input coupler 2012 that may include one or more reflective and/or transflective mirrors and may be referred to as the input mirror. The input mirror may be used to couple display light into waveguide 2010 such that the display light may propagate within waveguide 2010 through total internal reflection.

Waveguide display 2000 may include a middle mirror 2014 (also referred to as a folding mirror) that may include a group of reflective and/or transflective mirrors having the same orientation. One or more reflective and/or transflective mirrors of middle mirror 2014 may be used to direct display light from input coupler 2012 towards other reflective and/or transflective mirrors of middle mirror 2014, which may replicate the pupil in a first dimension (e.g., approximately the x direction) by reflecting portions of the display light at multiple locations along the first dimension (e.g., the x direction). For example, a first mirror and a last mirror (e.g., in x direction) in middle mirror 2014 may be reflective mirrors with reflectivity close to 100%, and mirrors between the first mirror and the last mirror in middle mirror 2014 may be transflective mirrors that have reflectivity less than 100% and are partially transmissive.

In some embodiments, middle mirror 2014 may include a first middle mirror and a second middle mirror. The first middle mirror may include one or more reflective and/or transflective mirrors that may direct display light from input coupler 2012 towards the second middle mirror. For example, the first middle mirror may be a reflective mirror with reflectivity close to 100%. The second middle mirror may include a plurality of reflective and/or transflective mirrors and may expand the pupil in a first dimension (e.g., approximately the x direction) by reflecting portions of the display light at multiple locations along the first dimension. In one example, the last mirror (e.g., in x direction) in the second middle mirror may be a reflective mirror with reflectivity close to 100%, and other mirrors in the second middle mirror may be transflective mirrors that are partially transmissive.

Waveguide display 2000 may also include an output mirror 2016, which may include a plurality of reflective and/or transflective mirrors. As described above, the transflective mirrors in output mirror 2016 may reflect, at multiple locations along a second dimension (e.g., approximately the y direction), portions of the display light from each location of the multiple locations of middle mirror 2014 to the eyebox to replicate the exit pupil in the second dimension. Therefore, middle mirror 2014 and output mirror 2016 may replicate the pupil in two-dimensions to fill the eyebox. In one example, the last mirror (e.g., in the y direction) in output mirror 2016 may be a reflective mirror with reflectivity close to 100%, and other mirrors in output mirror 2016 may be transflective mirrors that are partially transmissive.

In some embodiments, input coupler 2012 and output mirror 2016 may have the same or similar orientations and may reflect light in opposite manners (e.g., into or out of waveguide 2010), and thus may compensate the dispersion caused by each other to achieve dispersion-free pupil expansion. Similarly, a first portion of middle mirror 2014 (or the first middle mirror) and a second portion of middle mirror 2014 (or the second middle mirror) may have the same or similar orientations and may reflect light in opposite manners (e.g., from −y direction to x direction or form x direction to −y direction), and thus may compensate the dispersion caused by each other to achieve dispersion-free pupil expansion.

FIG. 20 also illustrates examples of transflective mirrors in the geometrical waveguide (e.g., waveguide 2010). The transflective mirrors may be tilted with respect to a surface or a surface-normal direction of the waveguide. The surface-normal direction of the transflective mirror is indicated by a vector \hat{n}. For example, the surface-normal direction of input coupler 2012 may be indicated by a vector \hat{n}₂, and the surface-normal direction of middle mirror 2014 may be indicated by a vector \hat{n}₁. The incident angle of incident light may be the angle with respect to vector \hat{n}.

Geometrical waveguides are generally thicker than other types of waveguide due to the imbedded mirror width and the fabrication process. There may need to be a tradeoff between the mirror width and resolution since beam size D=t/tan β, and the diffraction limit θ˜λ/D, where t is the thickness of the geometrical waveguide, β is the tilt angle of the geometrical mirrors, λ is the wavelength of the display light. Generally, the thickness t of GWG may need to be equal to or greater than 1 mm to have a large beam size and thus a resolution better than (smaller than) 1 arcmin. However, GWGs with high thicknesses may not have sufficiently high pupil replication densities to more uniformly fill the eyebox.

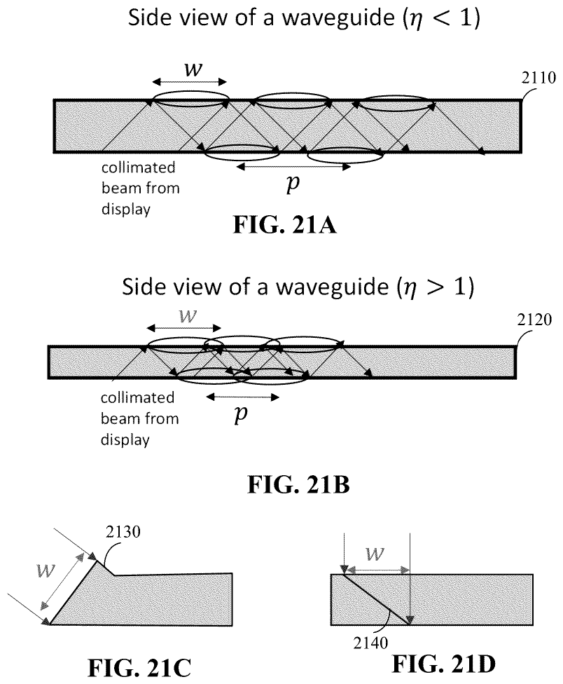

FIG. 21A illustrates an example a waveguide 2110 with a higher thickness. The beam size of the input beam (e.g., a collimated beam from a display device such as a projector) may be about w at the surface of waveguide 2110. When the thickness of waveguide 2110 is high and the beam size of the input beam at the surface of waveguide 2110 is not very large, the output beams may not fully fill the eyebox. Pupil replication density η in the waveguide may be defined as the ratio of the beam size w to the pitch p of the replicated beams:

$$η = \frac{w}{p} ,$$

In the example shown in FIG. 21A, η<1 and there are gaps between adjacent beams.

FIG. 21B illustrates an example a waveguide 2120 with a lower thickness. The beam size of the input beam (e.g., a collimated beam from a display device such as a projector) may be about w at the surface of waveguide 2120. When the thickness of waveguide 2120 is low, the output beams may fully fill the eyebox. In the example shown in FIG. 21A, η>1 and thus the replicated beam can cover the entire surface of waveguide 2120 at the output region. It is desirable that the waveguides have η>1 in order to have sufficient pupil and field uniformity (for combiner optics) and uniform illumination (for illumination component). It is very challenge to have GWGs with η>1, because the maximum beam width wₘₐₓ is constrained by the input coupler (mirror or prism) size, while the minimum pitch pₘᵢₙ an of the replicated beams is constrained by thickness t of the waveguide.

FIGS. 21C and 21D illustrate examples of input couplers for waveguide display. In the example shown in FIG. 21C, the input coupler may be a wedge 2130. In the example shown in FIG. 21D, the input coupler may be a mirror 2140. Both wedge 2130 and mirror 2140 may have limited sizes, and thus the beam size of the light beam coupled into the waveguide may be limited. When the thickness of the waveguide needs to be high (e.g., in order to achieve the desired resolution), pₘᵢₙ may be large and thus 77 may be small for guided light beams with limited beam size w. As such, the pupil replication density may not be high enough in GWG waveguides.

According to certain embodiments, various techniques may be used to increase the beam replication density in waveguide displays, including geometrical waveguide displays. For general 1-D or 2-D GWG displays or mixed waveguide (MWG) displays (including geometrical mirrors and other types of couplers such as gratings), the beam (pupil) replication density can be increased by, for example, adding embedded beam splitter(s), using rectangular/elliptical pupil instead of circular input pupil with extended size in one dimension, using a pupil replication film (e.g., a general film or birefringent material) lamination on the surface(s) of the waveguide, and the like. For example, for Kaleidoscopic waveguides described above, the waveguides may include ‘cross cube’ beam splitter, or may include pupil replication films (including isotropic materials or birefringent materials) laminated on one or more outer surfaces of the Kaleidoscopic waveguides.

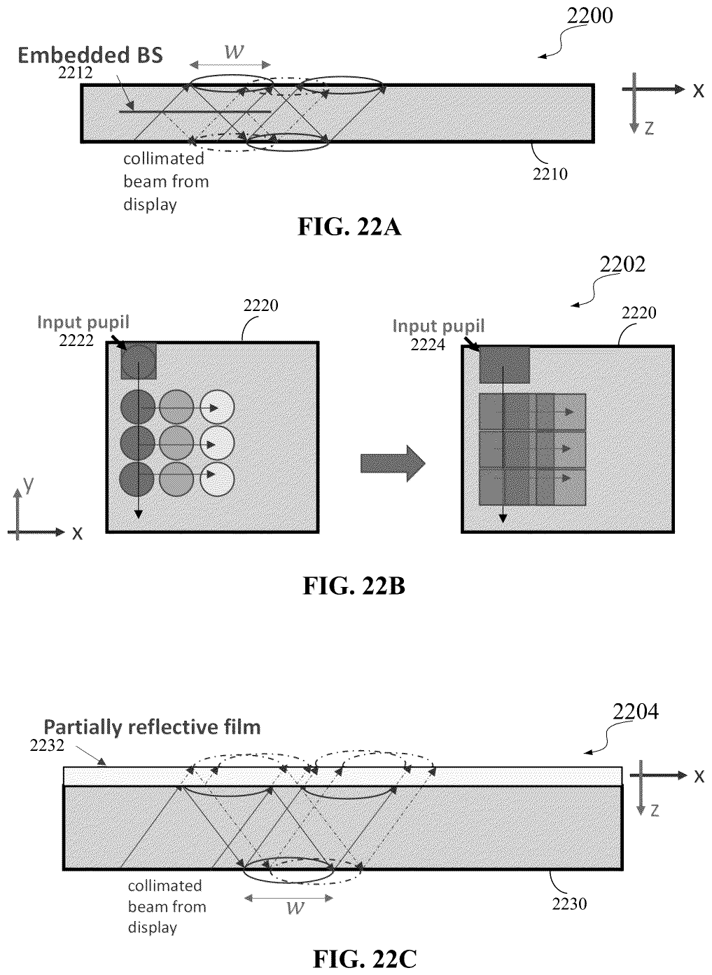

FIG. 22A illustrates an example of a waveguide display 2200 including a waveguide 2210 and a beam splitter 2212 embedded in waveguide 2210 (e.g., sandwiched by two sublayers of waveguide 2210) according to certain embodiments. In the illustrated example, the input light beam coupled into waveguide 2210 may be split by beam splitter 2212, where a portion of the input light beam may be reflected by beam splitter 2212 toward a bottom surface of waveguide 2210, whereas the remaining portion of the input light beam may pass through beam splitter 2212 and reach the top surface of waveguide 2210. Beam splitter 2212 may include, for example, a partial reflector, such as a 50:50 transflective mirror. Beam splitter 2212 embedded in waveguide 2210 effectively reduce the thickness of waveguide 2210, without reducing the beam size. The split input light beams may be reflected by the top and bottom surfaces of waveguide 2210, thereby doubling the number of replicated light beams and thus the replication density.

FIG. 22B illustrates an example of a waveguide display 2202 that includes a waveguide 2220 according to certain embodiments. When the input pupil 2222 (input light beam) has a shape of a circle or a square, the replicated light beams may not fill the surface of waveguide 2220, and there may be gaps between the replicated light beams (pupils). With an input pupil 2224 having a shape of a rectangle or an oval, the replicated light beams (pupils) may partially overlap such that there may not be gaps between the replicated light beams.

FIG. 22C illustrates an example of a waveguide display 2204 including a waveguide 2230 and a partial reflective film 2232 on a surface of waveguide 2230 according to certain embodiments. In the illustrate example, partial reflective film 2232 may be on the top surface of waveguide 2230. Partial reflective film 2232 may partially reflect incident light at the top surface of waveguide 2230 and may allow some incident light to pass through and be reflected at the top surface of partial reflective film 2232. Partially reflective film 2232 may have a certain thickness, such that the light beam reflected at the bottom surface of partially reflective film 2232 (top surface of waveguide 2230) and the light beam reflected at the top surface of partially reflective film 2232 may be offset from each other in the horizontal direction (e.g., x direction) to fill any gaps that may otherwise exist between the replicated light beams if partially reflective film 2232 is not used. As such, the pupil replication density may be increased.

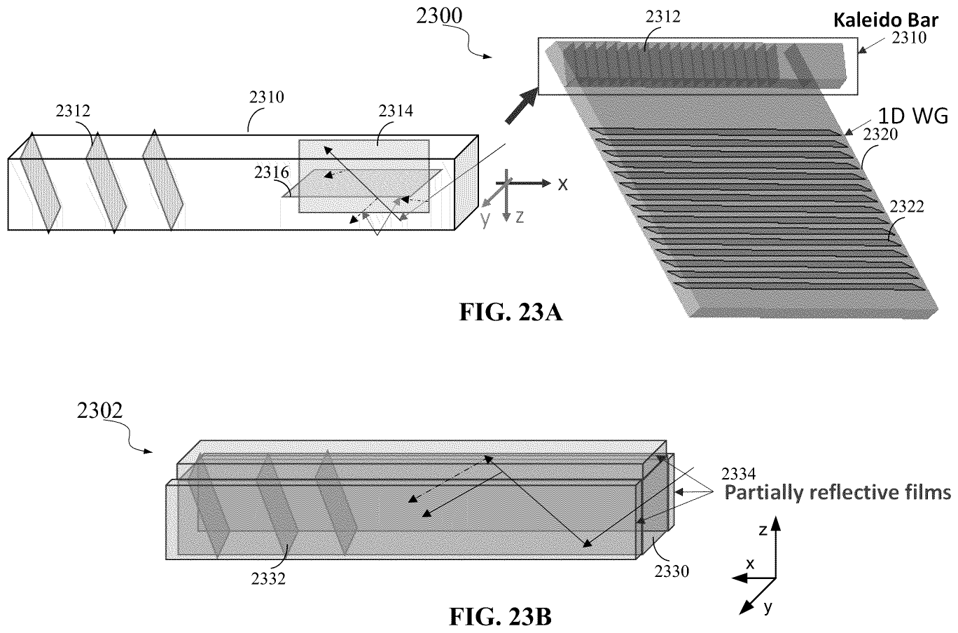

FIG. 23A illustrates an example of a geometrical waveguide display 2300 including beam splitters in a kaleidoscopic waveguide according to certain embodiments. As described above, kaleidoscopic waveguide is special 2D folded waveguide, which may include GWG, MWG, polarization volume holograms (PVH), SRGs, VBGs, and the like. Geometrical waveguide display 2300 may include a first waveguide 2310 and a second waveguide 2320, where first waveguide 2310 may be adjacent to one edge or on top of an input region of second waveguide 2320 and may be positioned at a certain orientation (e.g., with edges aligned or at a certain angle) with respect to second waveguide 2320. First waveguide 2310 may be a kaleidoscopic waveguide including an input coupler and an output coupler as described above, and may extend in a first direction (e.g., the x direction). Display light from a projector may be coupled into first waveguide 2310, and may propagate within first waveguide 2310 in the first direction (e.g., the x or −x direction) due to total internal reflection at four surfaces of first waveguide 2310 that are parallel to the first direction (e.g., the x direction). The display light propagating within first waveguide 2310 may be coupled out of first waveguide 2310 by an output coupler (e.g., an array of transflective mirrors 2312) at multiple locations along the first direction (e.g., the x direction) to replicate the exit pupil in the first direction.

In the illustrated example, the display light coupled out of first waveguide 2310 at each of the multiple locations along the first direction may be coupled into second waveguide 2320 at an edge of second waveguide 2320. The display light coupled into second waveguide 2320 may propagate within second waveguide 2320 in a second direction (e.g., the y direction), and may be coupled out of second waveguide 2320 by an array of transflective mirrors 2322 at multiple locations along approximately the second direction (e.g., the y direction) so as to replicate the exit pupil in the second direction.

In the example illustrated in FIG. 23A, first waveguide 2310 (which may be a kaleidoscopic waveguide) may include two crossed beam splitters 2314 and 2316 near the input coupler. Beam splitters 2314 and 2316 may be partial reflectors (e.g., 50:50 transflective mirrors) and may be in the x-z plane and x-y plane, respectively. Therefore, light beams propagating within the kaleidoscopic waveguide along substantially the x direction due to reflections at the four sidewall surfaces as described above with respect to, for example, FIGS. 9A-10B, may be partially reflected by beam splitters 2314 and 2316. As described above with respect to, for example, FIG. 22A, beam splitters 2314 and 2316 may effectively reduce the thickness of the waveguide without reducing the beam size, and thus may increase the pupil replication density of geometrical waveguide display 2300.

FIG. 23B illustrates an example of a geometrical waveguide display 2302 including a kaleidoscopic waveguide 2330 and partially reflective films 2334 on one or more sidewalls of kaleidoscopic waveguide 2330 according to certain embodiments. Kaleidoscopic waveguide 2330 may include a plurality of transflective mirrors 2332 configured to at least partially reflect incident light out of Kaleidoscopic waveguide 2330. Kaleidoscopic waveguide 2330 may be configured to reflect in-coupled light beam at four sidewalls that are parallel to the x direction. One or more partially reflective films 2334 may be formed at one or more sidewalls of kaleidoscopic waveguide 2330. As described above with respect to, for example, FIG. 22C, each partially reflective film 2334 may be configured to partially reflect incident light at the interface between partially reflective film 2334 and kaleidoscopic waveguide 2330, and totally internally reflect incident light at the interface between partially reflective film 2334 and air. Partially reflective film 2334 may have a certain thickness, such that the light beams reflected at the two surfaces of partially reflective film 2334 may be offset from each other in at least one direction (e.g., x direction) to fill any gaps that may otherwise exist between the replicated light beams if partially reflective film 2334 is not used. As such, the pupil replication density may be increased.

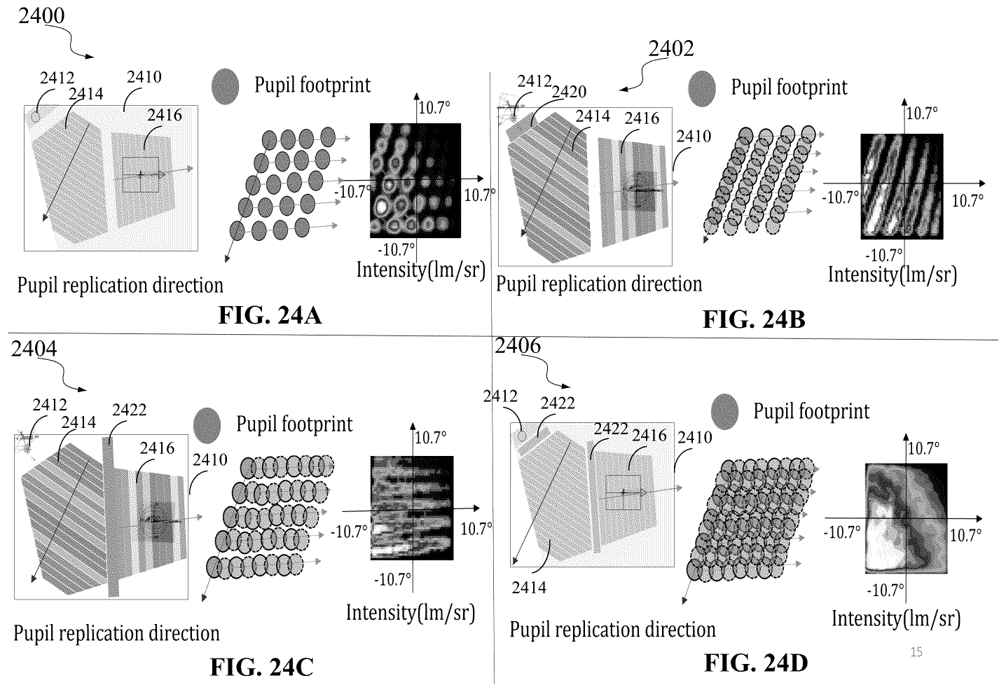

FIGS. 24A-24D illustrate examples of pupil replication by waveguide displays with and without beam splitters. FIG. 24A shows an example of a waveguide display 2400 that includes a waveguide 2410, an input coupler 2412, a first pupil replicator 2414 (e.g., a grating or a set of geometrical mirrors configured to replicate the pupil or light beam in one direction), and a second pupil replicator 2416 (e.g., a grating or a set of geometrical mirrors configured to replicate the pupil or light beam in another direction). Waveguide display 2400 may not include a beam splitter between input coupler 2412 and first pupil replicator 2414 or between first pupil replicator 2414 and second pupil replicator 2416. The input pupil or light beam may have a shape of a circle. As shown in FIG. 24A, the replicated beams may be sparse and may not fully cover the output region of waveguide display 2400 or the eyebox.

FIG. 24B shows an example of a waveguide display 2402 that includes waveguide 2410, input coupler 2412, first pupil replicator 2414 (e.g., a grating or a set of geometrical mirrors configured to replicate the pupil or light beam in one direction), and second pupil replicator 2416 (e.g., a grating or a set of geometrical mirrors configured to replicate the pupil or light beam in another direction). The input pupil or light beam may have a shape of a circle. Waveguide display 2402 may include a beam splitter 2420 between input coupler 2412 and first pupil replicator 2414, which may increase the pupil replication density in one direction as described above and as shown in FIG. 24B. But the replicated beams may be sparse in another direction and may not fully cover the output region of waveguide display 2402 or the eyebox.

FIG. 24C shows an example of a waveguide display 2404 that includes waveguide 2410, input coupler 2412, first pupil replicator 2414 (e.g., a grating or a set of geometrical mirrors configured to replicate the pupil or light beam in one direction), and second pupil replicator 2416 (e.g., a grating or a set of geometrical mirrors configured to replicate the pupil or light beam in another direction). The input pupil or light beam may have a shape of a circle. Waveguide display 2404 may include a beam splitter 2422 between first pupil replicator 2414 and second pupil replicator 2416, which may increase the pupil replication density in one direction as described above and as shown in FIG. 24C. But the replicated beams may be sparse in another direction and may not fully cover the output region of waveguide display 2404 or the eyebox.

FIG. 24D shows an example of a waveguide display 2406 that includes waveguide 2410, input coupler 2412, first pupil replicator 2414 (e.g., a grating or a set of geometrical mirrors configured to replicate the pupil or light beam in one direction), and second pupil replicator 2416 (e.g., a grating or a set of geometrical mirrors configured to replicate the pupil or light beam in another direction). The input pupil or light beam may have a shape of a circle. Waveguide display 2406 may include beam splitter 2420 between input coupler 2412 and first pupil replicator 2414, which may increase the pupil replication density in one direction. Waveguide display 2406 may also include beam splitter 2422 between first pupil replicator 2414 and second pupil replicator 2416, which may increase the pupil replication density in another direction as described above. Thus, as shown in FIG. 24D, the replicated beams may be dense in two orthogonal directions and may fully cover the output region of waveguide display 2406 or the eyebox.

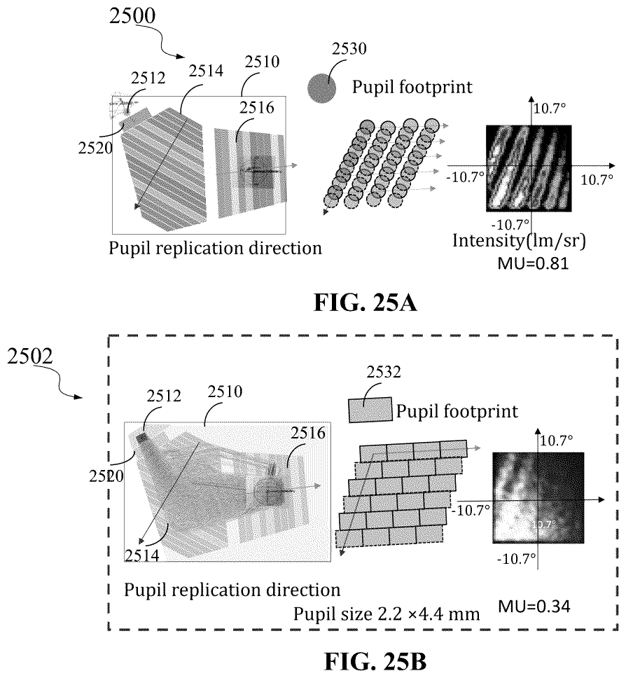

FIG. 25A illustrates an example of a waveguide display 2500 that includes a waveguide 2510, an input coupler 2512, a first pupil replicator 2514 (e.g., a grating or a set of geometrical mirrors configured to replicate the pupil or light beam in one direction), and a second pupil replicator 2516 (e.g., a grating or a set of geometrical mirrors configured to replicate the pupil or light beam in another direction). The input pupil 2530 or light beam may have a shape of a circle. Waveguide display 2500 may include a beam splitter 2520 between input coupler 2512 and first pupil replicator 2514, which may increase the pupil replication density in one direction as described above and as shown in FIG. 25A. But the replicated beams may be sparse in another direction and may not fully cover the output region of waveguide display 2500 or the eyebox.

FIG. 25B illustrates an example of a waveguide display 2502 according to certain embodiments. Waveguide display 2502 may be similar to waveguide display 2500, but the input pupil 2532 or input beam may have a rectangular shape (e.g., 2.2 mm×4.4 mm). Waveguide display 2502 may include beam splitter 2520 between input coupler 2512 and first pupil replicator 2514, which may increase the pupil replication density in one direction as described above and as shown in FIG. 25A. Due to beam splitter 2520 and the rectangle-shaped input pupil, the replicated beams may be dense in two orthogonal directions and may fully cover the output region of waveguide display 2502 or the eyebox.

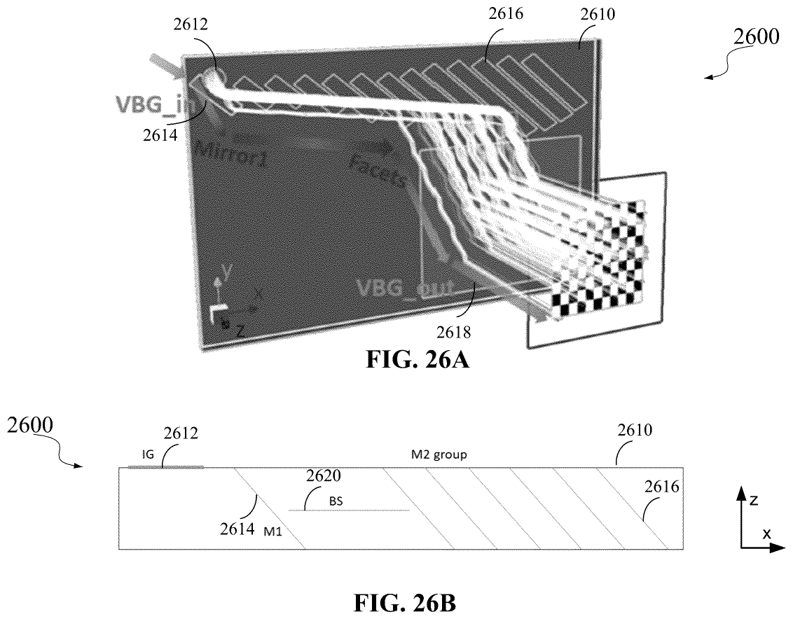

FIGS. 26A-26B show an example of a waveguide display 2600 according to certain embodiments. In the illustrated example, waveguide display 2600 includes a waveguide 2610, an input coupler 2612, a first set of geometrical mirrors configured to replicate the pupil or light beam in one direction, and a second set of geometrical mirrors 2618 configured to replicate the pupil or light beam in another direction. Input coupler 2612 may include a VBG configured to couple an input beam into waveguide 2610. The first set of geometrical mirrors may include a first mirror 2614 that may redirect the in-coupled light beam towards substantially the x direction, and a set of mirrors 2616 configured to reflect the incident light beam towards substantially the y direction. Waveguide display 2600 may also include a beam splitter 2620 between first mirror 2614 and mirrors 2616. Beam splitter 2620 may include, for example, a partially reflective mirror or film. Beam splitter 2620 may split the light beam into two light beams that may be offset from each other, and may effectively reduce the thickness of the waveguide 2610 without reducing the beam size, as described above. Thus, the pupil replication density of waveguide display 2600 may be increased by beam splitter 2620.

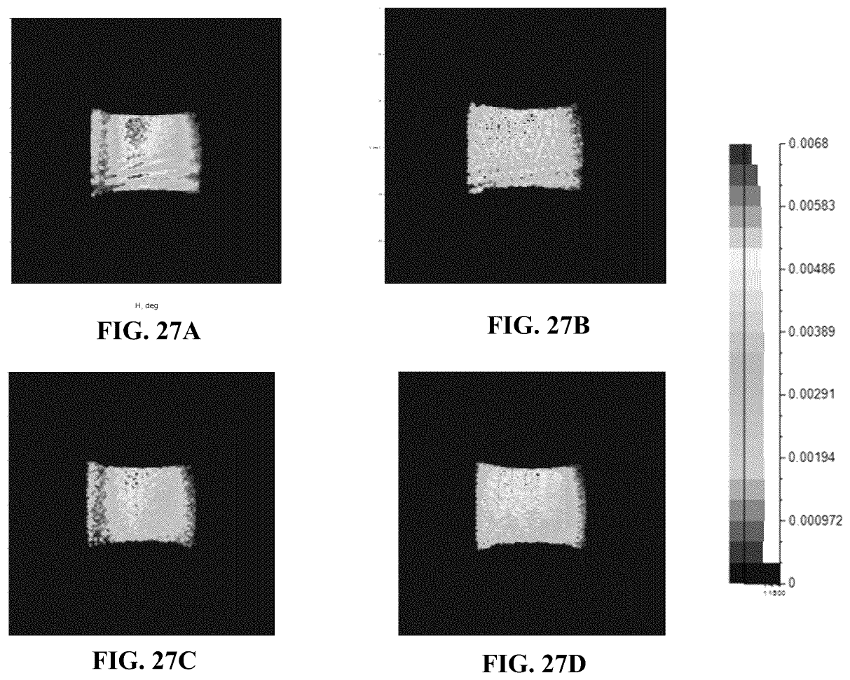

FIGS. 27A-27D illustrate examples of pupil replication by geometrical waveguide displays including kaleidoscopic waveguides, such as geometrical waveguide display 1100 or 2300 described above. In the example shown in FIG. 27A, the kaleidoscopic waveguide (e.g., first geometrical waveguide 1110) may not include beam splitters 2314 and 2316, and thus the pupil replication density may be low and the replicated light field may not be uniform. In the example shown in FIG. 27B, the kaleidoscopic waveguide may include one beam splitter (e.g., beam splitter 2316), and thus the pupil replication density may be improved in one dimension, but there may still be gaps between the replicated beams in another dimension. In the example shown in FIG. 27C, the kaleidoscopic waveguide may include one beam splitter (e.g., beam splitter 2314), and thus the pupil replication density may be improved in one dimension, but there may still be gaps between the replicated beams in another dimension. In the example shown in FIG. 27D, the kaleidoscopic waveguide may include two orthogonal beam splitter (e.g., beam splitters 2314 and 2316), and thus the pupil replication density may be improved in two dimensions, and there may not be gaps between the replicated beams.

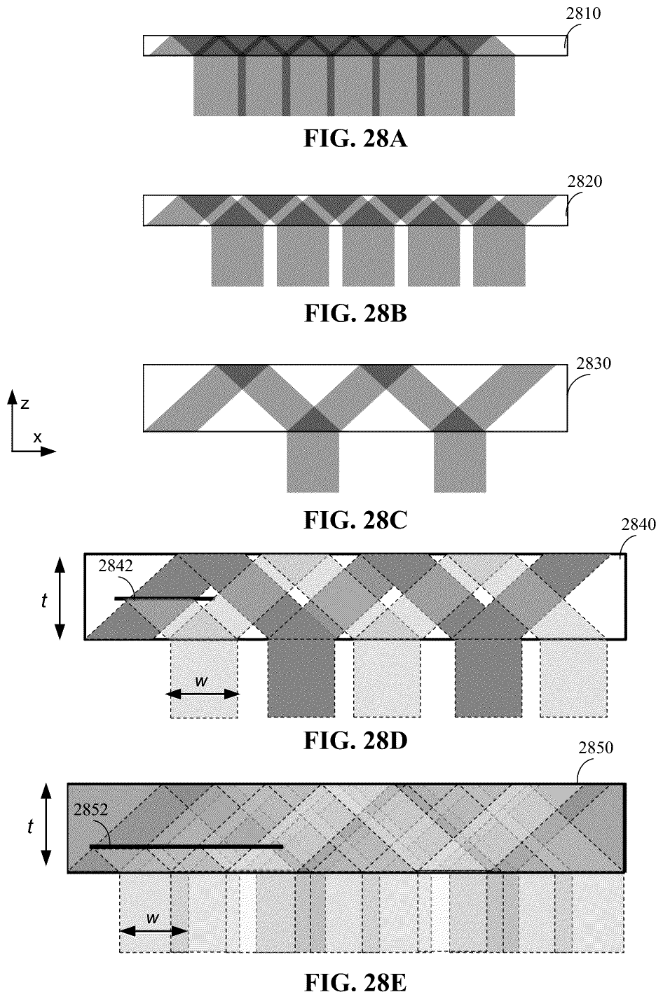

FIGS. 28A-28C show that the pupil replication density may depend on the thickness of the waveguide. As illustrated, for an input beam with the same beam size, a thin waveguide 2810 may replicate the light beam at a high density in at least the light propagation direction (e.g., x direction), a waveguide 2820 with a higher thickness (in the z direction) may replicate the light beam at a lower pupil replication density, and a waveguide 2830 with an even higher thickness (in the z direction) may replicate the light beam at a much lower pupil replication density.

FIGS. 28D-28E show that the location of the embedded beam splitter in the waveguide may also affect the pupil replication density. FIG. 28D shows that for a waveguide 2840 with a thickness t, when a beam splitter 2842 is positioned in the middle (in the thickness direction such as z direction) of waveguide 2840, waveguide 2840 may replicate the light beam at a lower pupil replication density for an input light beam with a beam width w. FIG. 28E shows that for a waveguide 2850 with thickness t, when a beam splitter 2852 is positioned away from the middle (in the thickness direction such as z direction) of waveguide 2850, waveguide 2850 may replicate the light beam at a higher pupil replication density for an input light beam with a beam width w.

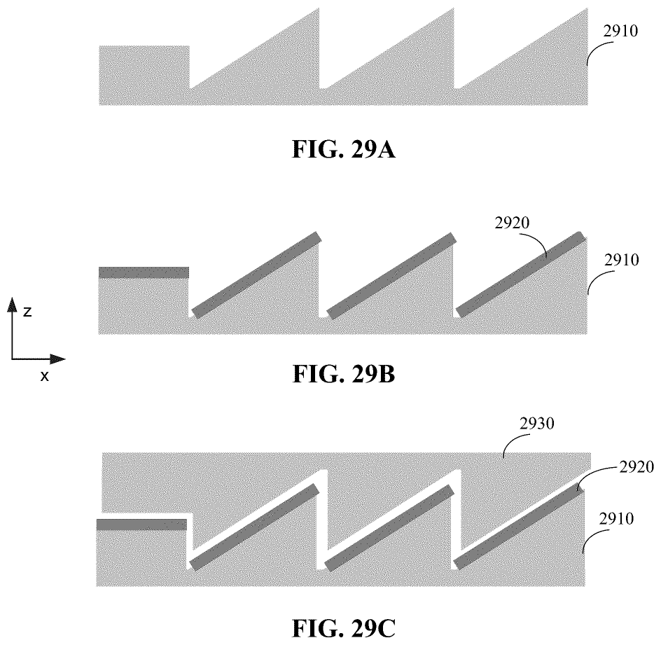

FIGS. 29A-29C illustrate an example of a process of fabricating a geometrical waveguide including an embedded beam splitter to improve the pupil replication density according to certain embodiments. FIG. 29A shows that a component 2910 may be formed by, for example, molding a plastic material. Component 2910 may include a flat facet and a set of slanted facets. FIG. 29B shows that partial reflective films 2920 may be deposited on the facets of component 2910. Partial reflective films 2920 may different reflectivity. For example, the partial reflective film 2920 on the flat facet may have a reflectivity about 50%, and may be used to form a 50:50 beam splitter. Partial reflective films 2920 formed on the slanted facets of component 2910 may have reflectivity that may gradually increase in, for example, the x direction. In one example, in the x direction, the first partial reflective films 2920 may have a reflectivity about 10%, the second partial reflective films 2920 may have a reflectivity about 11%, the third partial reflective films 2920 may have a reflectivity about 15%, and so on. FIG. 29C shows that, after the formation of partial reflective films 2920, a component 2930 may be formed on partial reflective films 2920 and component 2910, for example, by bonding using optically clear adhesive, or by a molding or imprinting process and a polishing process. In some embodiments, component 2930 may include a plastic material, such as a resin or a polymer material. In some embodiments, component 2930 may be formed using a thermally or optically curable material.

In view of the description, embodiments may include different combinations of features described herein. Certain embodiments are described in the following examples.

In Example 1, a waveguide display may include a waveguide; an input coupler configured to couple a light beam into the waveguide; a first beam splitter within the waveguide and configured to split the light beam into two light beams, wherein the first beam splitter is parallel to a surface of the waveguide, and wherein the two light beams are guided by the waveguide through total internal reflection at surfaces of the waveguide; and a pupil expander configured to replicate the two light beams in one or two dimensions.

Example 2 includes the waveguide display of Example 1, wherein the input coupler is configured to couple the light beam into the waveguide such that the two light beams are guided by the waveguide through total internal reflection at four surfaces of the waveguide.

In Example 3, the waveguide display of Example 1 or 2 further includes a second beam splitter within the waveguide, wherein the second beam splitter is orthogonal to the first beam splitter.

Example 4 includes the waveguide display of any of Examples 1-3, wherein the pupil expander includes one or two sets of transflective mirrors within the waveguide.

Example 5 includes the waveguide display of any of Examples 1-4, wherein the input coupler is configured to couple a light beam having a rectangular cross-section into the waveguide.

Example 6 includes the waveguide display of any of Examples 1-5, wherein the first beam splitter is at a location different from a center of the waveguide in a thickness direction of the waveguide.

Example 7 includes the waveguide display of any of Examples 1-5, wherein the first beam splitter is at a location different from a center of the waveguide in a width direction of the waveguide.

In Example 8, a waveguide display may include a waveguide; an input coupler configured to couple a light beam into the waveguide; a partial reflective film on a first surface of the waveguide and configured to split the light beam into two light beams, wherein the two light beams are guided by the waveguide through total internal reflection at surfaces of the waveguide; and a pupil expander configured to replicate the two light beams in one or two dimensions.

Example 9 includes the waveguide display of Example 8, wherein the input coupler is configured to couple the light beam into the waveguide such that the two light beams are guided by the waveguide through total internal reflection at four surfaces of the waveguide.

In Example 10, the waveguide display of Example 8 or 9 further includes two partial reflective films on a second surface and a third surface of the waveguide.

Example 11 includes the waveguide display of any of Examples 8-10, wherein the pupil expander includes one or two sets of transflective mirrors within the waveguide.

Example 12 includes the waveguide display of any of Examples 8-11, wherein the input coupler is configured to couple a light beam having a rectangular cross-section into the waveguide.

In Example 13, the waveguide display of any of Examples 8-12 further includes a beam splitter within the waveguide and configured to split the light beam into two light beams, wherein the first beam splitter is parallel to a surface of the waveguide.

V. Liquid-Crystal Display (LCD) with Improved Brightness Uniformity

In AR or VR displays, the user's viewing angle and the chief-ray angle (CRA) of the display optics for different regions of the display panel may vary across the display panel. Display panels are generally designed to have uniform brightness and viewing angle properties, where the light beam emitted by each region of the display panel may have, for example, a Gaussian beam intensity profile with the peak luminance direction perpendicular to the display panel. The mismatch between the peak luminance angle of the display panel and the CRAs of the display optics for some regions of the display panel can lead to brightness variations depending on the user's gaze direction, which is often referred to as the Brightness-Roll-Off (BRO) effect.

According to certain embodiments, a liquid crystal display (LCD) of a near-eye display comprises a backlight unit configured to emit light, a thin-film-transistor (TFT) array including pixel control circuits and an array of apertures configured to transmit light, and a diffractive optical element between the TFT array and the backlight unit. The diffractive optical element is configured to, at two or more different locations of the diffractive optical element, deflect the light emitted from the backlight unit by different respective deflection angles towards the TFT array. The LCD further comprises a color filter on a side of the TFT array opposite to the diffractive optical element. The color filter comprises an array of color filter elements, and each color filter element of the array of color filter elements is positioned along a chief ray direction of the near-eye display with respect to a corresponding aperture of the array of apertures of the TFT array. The LCD further comprises a liquid crystal layer between the TFT array and the color filter and controlled by the pixel control circuits.

According to certain embodiments, a near-eye display comprises a liquid crystal display (LCD) configured to display an image, and display optics configured to project the image to a user's eye. The LCD comprises a backlight unit configured to emit light, a thin-film-transistor (TFT) array including control circuits and an array of apertures configured to transmit light, and a diffractive optical element between the TFT array and the backlight unit. The diffractive optical element is configured to, at two or more different locations of the diffractive optical element, deflect the light emitted from the backlight unit by different respective deflection angles towards the TFT array. The LCD further comprises a color filter on a side of the TFT array opposite to the diffractive optical element. The color filter comprises an array of color filter elements and each color filter element of the array of color filter elements is positioned along a chief ray direction of the near-eye display with respect to a corresponding aperture of the array of apertures of the TFT array. The LCD further comprises a liquid crystal layer between the TFT array and the color filter and controlled by the control circuits to modulate incident light.

According to certain embodiments, a near-eye display with chief ray walk-off compensation and high-efficiency light coupling from a backlight unit (BLU) into display optics and eventually into the user's eyes is disclosed. According to certain embodiments, the luminance profiles of the BLU may be controlled to align the peak luminance angle with the CRA for regions across the display panel. In some embodiments, a diffractive optical element may be used between the BLU and the Thin-Film-Transistor (TFT) array of a liquid crystal (LC) panel to deflect the light from the BLU such that the peak luminance angle may substantially align with the CRA across the display panel.

For example, the diffractive optical element may include a geometric phase grating (e.g., a PBP lens) that may be sensitive to circularly polarized light, and a circular polarizer (e.g., including a quarter-wave plate and a linear polarizer). In some embodiments, the geometric phase grating may diffract right-handed circularly polarized light and left-handed circularly polarized light to different directions. The quarter-wave plate may convert the right-handed circularly polarized light and left-handed circularly polarized light into linearly polarized light with perpendicular polarization directions. The linear polarizer may allow linearly polarized light with one polarization direction to pass and may block (e.g., absorb or reflect) linearly polarized light with a perpendicular polarization direction. In some embodiments, the diffractive optical element may be an optical geometric phase element (e.g., configured to modulate the phase of incident light).

In some embodiments, the diffractive optical element may include one or more layers of birefringent materials, such as LC materials, form-birefringent medium, metasurface patterns, and/or a surface plasmonic medium. In some embodiments, to further increase the performance of the LCD display, black-mask (BM) shifting may be implemented on the color filter (CF)/BM array of the LCD display. For example, instead of placing the color filters in the CF/BM array to align with the TFT pixels in the TFT array, the CFs/BMs in the CF/BM array may be shifted according to the chief ray angles to allow the chief rays to pass through the centers of the color filters and allow the display emission peaks to be centered around the CRAs.

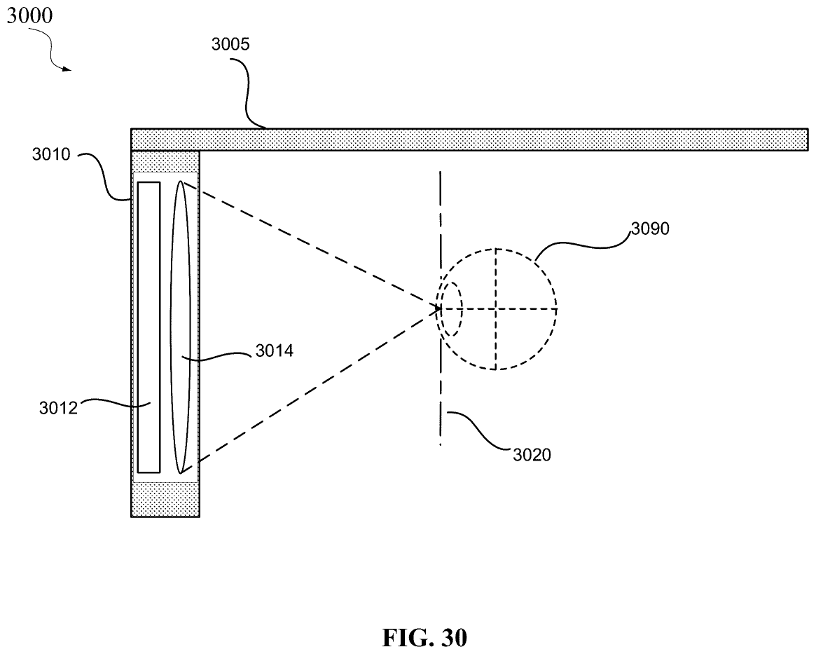

FIG. 30 is a cross-sectional view of an example of a near-eye display 3000 according to certain embodiments. Near-eye display 3000 may include at least one display assembly 3010. Display assembly 3010 may be configured to direct image light (e.g., display light) to an eyebox located at an exit pupil 3020 and to user's eye 3090. It is noted that, even though FIG. 30 and other figures in the present disclosure show an eye of a user of the near-eye display for illustration purposes, the eye of the user is not a part of the corresponding near-eye display.

As HMD device 200 and near-eye display 300, near-eye display 3000 may include a frame 3005 and display assembly 3010 that may include a display 3012 and/or display optics 3014 coupled to or embedded in frame 3005. As described above, display 3012 may display images to the user electrically (e.g., using LCDs, LEDs, OLEDs) or optically (e.g., using a waveguide display and optical couplers) according to data received from a processing unit, such as console 110. In some embodiments, display 3012 may include a display panel that includes pixels made of LCDs, LEDs, OLEDs, and the like. Display 3012 may include sub-pixels to emit light of a predominant color, such as red, green, blue, white, or yellow. In some embodiments, display assembly 3010 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 3014 may be similar to display optics 124 and may display image content optically (e.g., using optical waveguides and optical couplers), correct optical errors associated with the image light, combine images of virtual objects and real objects, and present the corrected image light to exit pupil 3020 of near-eye display 3000, where the user's eye 3090 may be located. In some embodiments, display optics 3014 may also relay the images to create virtual images that appear to be away from display 3012 and further than just a few centimeters away from the eyes of the user. For example, display optics 3014 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 3014 may also magnify the source image to make the image appear larger than the actual size of the source image. More details of display 3012 and display optics 3014 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

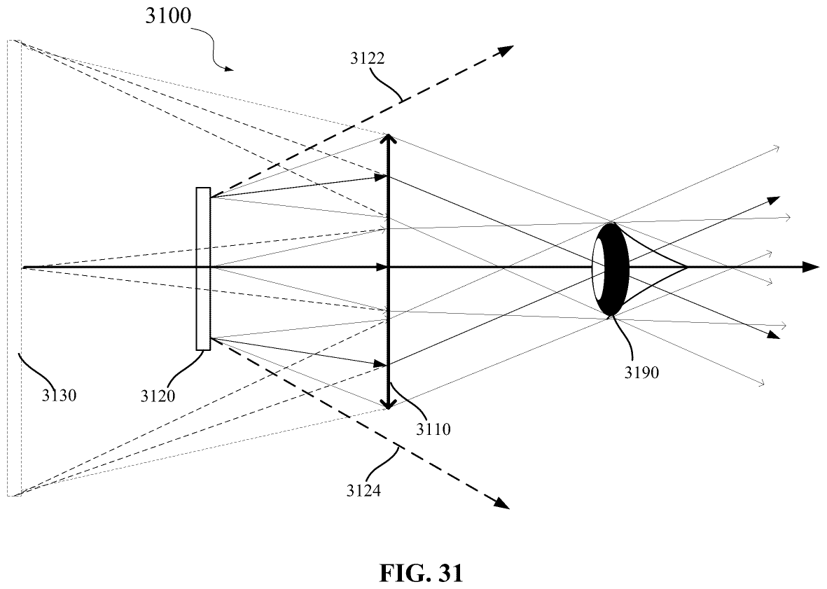

FIG. 31 illustrates an example of an optical system 3100 with a non-pupil forming configuration for a near-eye display device according to certain embodiments. Optical system 3100 may be an example of near-eye display 3000 and may include display optics 3110 and an image source 3120 (e.g., a display panel). Display optics 3110 may function as a magnifier. FIG. 31 shows that image source 3120 is in front of display optics 3110. In some other embodiments, image source 3120 may be located outside of the field of view of the user's eye 3190. For example, one or more deflectors or directional couplers may be used to deflect light from an image source to make the image source appear to be at the location of image source 3120 shown in FIG. 31. Image source 3120 may be an example of display 3012 described above. For example, image source 3120 may include a two-dimensional array of light emitters, such as semiconductor micro-LEDs or micro-OLEDs. The dimensions and pitches of the light emitters in image source 3120 may be small. For example, each light emitter may have a diameter less than 2 μm (e.g., about 1.2 μm) and the pitch may be less than 2 μm (e.g., about 1.5 μm). As such, the number of light emitters in image source 3120 can be equal to or greater than the number of pixels in a display image, such as 960×720, 1280×720, 1440×1080, 1920×1080, 2160×1080, or 2560×1080 pixels. Thus, a display image may be generated simultaneously by image source 3120.

Light from an area (e.g., a pixel or a light emitter) of image source 3120 may be directed to a user's eye 3190 by display optics 3110. Light directed by display optics 3110 may form virtual images on an image plane 3130. The location of image plane 3130 may be determined based on the location of image source 3120 and the focal length of display optics 3110. A user's eye 3190 may form a real image on the retina of user's eye 3190 using light directed by display optics 3110. In this way, objects at different spatial locations on image source 3120 may appear to be objects on an image plane far away from user's eye 3190 at different viewing angles. Image source 3120 may have a size larger or smaller than the size (e.g., aperture) of display optics 3110. Some light emitted from image source 3120 with large emission angles (as shown by light rays 3122 and 3124) may not be collected and directed to user's eye 3190 by display optics 3110 and may become stray light.

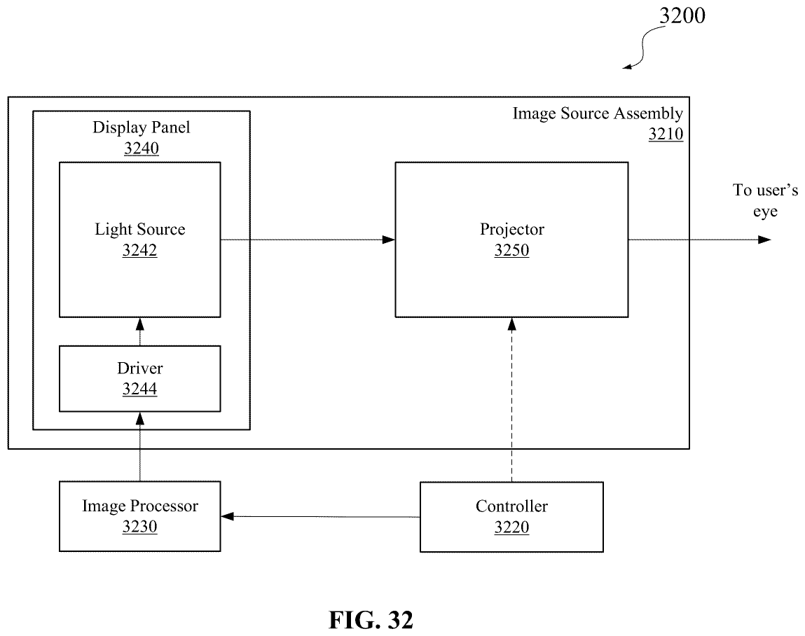

FIG. 32 illustrates an example of an image source assembly 3210 in a near-eye display system 3200 according to certain embodiments. Image source assembly 3210 may include, for example, a display panel 3240 that may generate display images to be projected to a user's eyes, and a projector 3250 that may project the display images generated by display panel 3240 to the user's eye. Display panel 3240 may include a light source 3242 and a drive circuit 3244 for controlling light source 3242. Light source 3242 may include, for example, LEDs, OLEDs, micro-OLEDs, micro-LEDs, resonant cavity light emitting diodes (RC-LEDs), or other light emitters. Projector 3250 may include, for example, a diffractive optical element, a freeform optical element, a scanning mirror, and/or other display optics. In some embodiments, near-eye display system 3200 may also include a controller 3220 that synchronously controls light source 3242 and projector 3250 (e.g., including a scanner). Image source assembly 3210 may generate and output an image to user's eyes.

Light source 3242 may include a plurality of light emitters arranged in an array or a matrix. Each light emitter may emit monochromatic light, such as red light, blue light, green light, infra-red light, and the like. While RGB colors are often used, embodiments described herein are not limited to using red, green, and blue as primary colors. Other colors can also be used as the primary colors of near-eye display system 3200. In some embodiments, a display panel in accordance with an embodiment may use more than three primary colors. Each pixel in light source 3242 may include three subpixels that include a red LED, a green LED, and a blue LED. A semiconductor LED generally includes an active light emitting layer within multiple layers of semiconductor materials. The multiple layers of semiconductor materials may include different compound materials or a same base material with different dopants and/or different doping densities. For example, the multiple layers of semiconductor materials may include an n-type material layer, an active region that may include hetero-structures (e.g., one or more quantum wells), and a p-type material layer.

Controller 3220 may control the image rendering operations of image source assembly 3210, such as the operations of light source 3242 and/or projector 3250. For example, controller 3220 may determine instructions for image source assembly 3210 to render one or more display images. The instructions may include display instructions and/or scanning instructions. In some embodiments, the display instructions may include an image file (e.g., a bitmap file). The display instructions may be received from, for example, a console, such as console 110 described above with respect to FIG. 1. Controller 3220 may include a combination of hardware, software, and/or firmware not shown here so as not to obscure other aspects of the present disclosure. In some embodiments, controller 3220 may be a graphics processing unit (GPU) of a display device. In other embodiments, controller 3220 may be other kinds of processors.

Image processor 3230 may be a general-purpose processor and/or one or more application-specific circuits that are dedicated to performing the features described herein. In one example, a general-purpose processor may be coupled to a memory to execute software instructions that cause the processor to perform certain processes described herein. In another embodiment, image processor 3230 may be one or more circuits that are dedicated to performing certain features. While image processor 3230 in FIG. 32 is shown as a stand-alone unit that is separate from controller 3220 and drive circuit 3244, image processor 3230 may be a sub-unit of controller 3220 or drive circuit 3244 in other embodiments. In other words, in those embodiments, controller 3220 or drive circuit 3244 may perform various image processing functions of image processor 3230. Image processor 3230 may also be referred to as an image processing circuit.

In the example shown in FIG. 32, light source 3242 may be driven by drive circuit 3244, based on data or instructions (e.g., display and scanning instructions) sent from controller 3220 or image processor 3230. In one embodiment, drive circuit 3244 may include a circuit panel that connects to and mechanically holds various light emitters of light source 3242. Light source 3242 may emit light in accordance with one or more illumination parameters that are set by the controller 3220 and potentially adjusted by image processor 3230 and drive circuit 3244. The illumination parameters may be used by light source 3242 to generate light. The illumination parameters may include, for example, source wavelength, pulse rate, pulse amplitude, beam type (continuous or pulsed), other parameter(s) that may affect the emitted light, or any combination thereof. In some embodiments, the source light generated by light source 3242 may include multiple beams of red light, green light, and blue light, or any combination thereof.

Projector 3250 may perform a set of optical functions, such as focusing, combining, conditioning, or scanning the image light generated by light source 3242. In some embodiments, projector 3250 may include a combining assembly, a light conditioning assembly, or a scanning mirror assembly. Projector 3250 may include one or more optical components that optically adjust and potentially re-direct the light from light source 3242. One example of the adjustment of light may include conditioning the light, such as expanding, collimating, correcting for one or more optical errors (e.g., field curvature, chromatic aberration, etc.), some other adjustments of the light, or any combination thereof. The optical components of projector 3250 may include, for example, lenses, mirrors, apertures, gratings, polarizers, waveplates, prisms, or any combination thereof.

In some near-eye display systems, the user's viewing angle and the chief-ray angle (CRA) for different regions of a display panel (e.g., a near-eye LCD) may vary across the display panel. However, display panels are generally designed to have uniform viewing angle properties, where the light beam emitted by each region of the display panel may have, for example, a Gaussian beam profile with the peak luminance direction perpendicular to the display panel. The mismatch between the display peak luminance angle and the CRA can lead to brightness variations depending on the user's gaze direction, which is often referred to as Brightness-Roll-Off (BRO) effects. Techniques disclosed herein provide a mechanism for chief ray walk-off compensation and high-efficiency light coupling from a backlight unit (BLU) into the display optics of a display system and eventually into the user's eyes. Accordingly, the efficiency and brightness uniformity of the display system may be significantly improved.

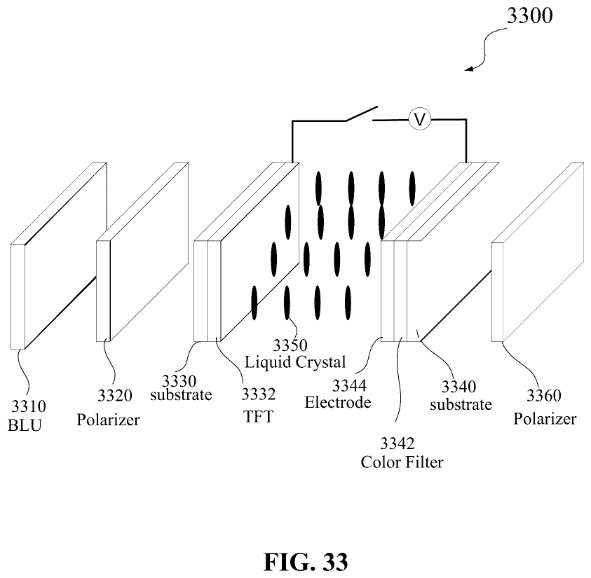

FIG. 33 illustrates an example of an LCD 3300. As illustrated, LCD 3300 may include a backlight unit (BLU) 3310 configured to emit light (e.g., a light source for emitting white light), a first polarizer 3320 configured to control the type of light that can pass through (e.g., control the polarization state of the light), and an LC panel that may modulate the incident light. The LC panel may include a first substrate 3330, a thin-film transistor (TFT) array 3332 including circuits for controlling the intensity of each pixel (e.g., by controlling the orientations of the liquid crystal molecules in a liquid crystal layer, thereby controlling the rotation angle of the polarization direction of the incident light), one or more liquid crystal layers 3350, a common electrode 3344, a color filter/black-mask array 3342, and a second substrate 3340. LCD 3300 may also include a second polarizer 3360 (e.g., a linear polarizer) configured to filter the light from the LC panel according to the polarization state of the output light from the LC panel. In some embodiments, BLU 3310 may include one or more cold-cathode fluorescent lamps configured to emit light, or may include blue light-emitting diodes and quantum dots or phosphors for converting some blue light into green or red light, thereby generating white light. As described in detail below, in some embodiments, a black-mask layer with an array of apertures may be formed on TFT array 3332. The color filter/black-mask array 3342 may also include a black-mask layer and a plurality of color filter elements in the black-mask layer. The color filter elements may be used to form a plurality of color sub-pixels (e.g., including red, green, and/or blue sub-pixels). For example, the center of each color filter element of the plurality of color filter elements may be aligned with the center of a respective aperture of the array of apertures in the black-mask layer formed on TFT array 3332 as shown in, for example, FIG. 8, such that light passing through the aperture may be modulated by liquid crystal molecules (controlled by a TFT pixel) and filtered by the color filter element to form a color sub-pixel.

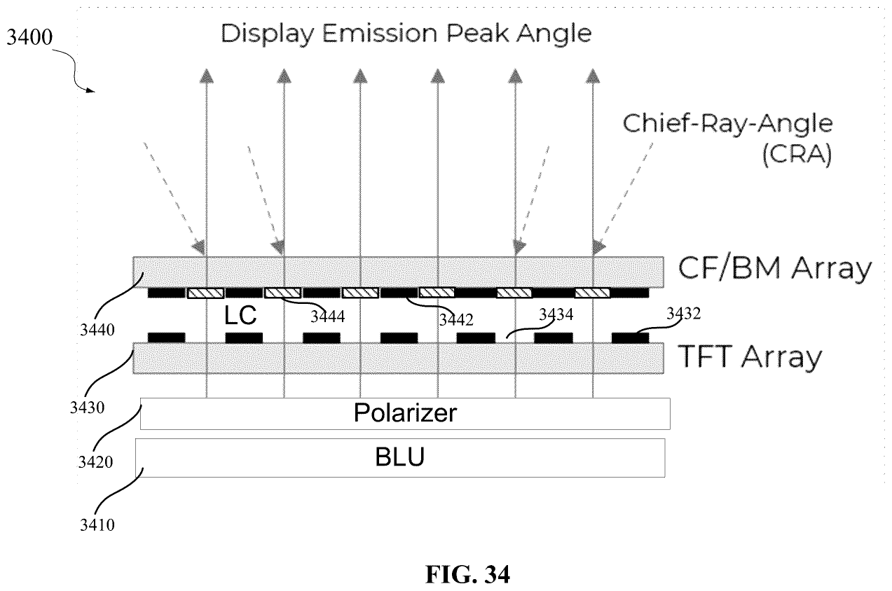

FIG. 34 illustrates a mismatch between the display peak emission angle of an LCD 3400 of a near-eye display and the chief-ray angles of the near-eye display for some regions of LCD 3400. LCD 3400 may include a BLU 3410, a polarizer 3420, a TFT array 3430 including a black-mask layer 3432 and an array of apertures 3434, and a CF/BM array 3440 including a black-mask layer 3442 and an array of color filter elements 3444 in black-mask layer 3442. Color filter elements 3444 may include red, green, and blue color filters. Centers of color filter elements 3444 may align with centers of apertures 3434 in black-mask layer 3432 on TFT array 3430.

As shown in FIG. 34, display panels are generally designed to have uniform viewing angle properties, where the light beam emitted by each region of the display panel may have, for example, a Gaussian beam profile with the peak luminance direction perpendicular to the display panel. However, the user's viewing angle (and the CRA of the near-eye display) for different regions of the display panel may vary across the display panel. For example, as illustrated, the chief ray of the near-eye display for the center region of LCD 3400 may be in the surface-normal direction of LCD 3400, but the chief ray of the near-eye display for other regions of LCD 3400 may be tilted at different angles with respect to the surface-normal direction of LCD 3400. The mismatch between the display peak luminance angle and the CRA can lead to brightness variations depending on the user's gaze direction, which is often referred to as the Brightness-Roll-Off (BRO) effect.

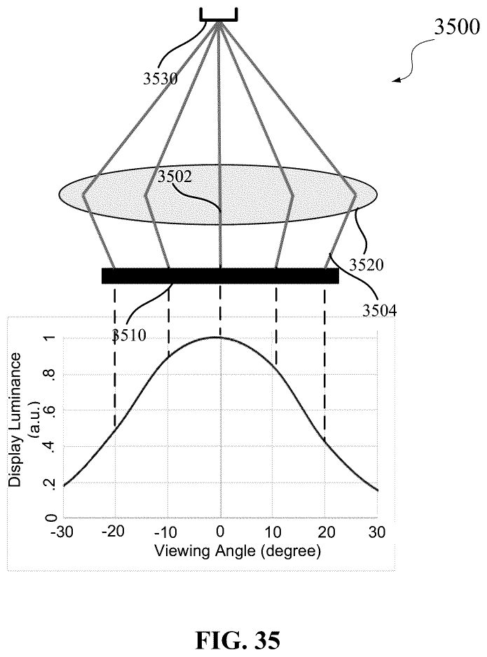

FIG. 35 illustrates a relationship between the display luminance and the chief-ray angle of a near-eye display 3500 that includes an LCD 3510 (e.g., LCD 3300 or 3400) and viewing optics 3520. FIG. 35 also shows an exit pupil 3530 of near-eye display 3500, a chief ray 3502 for the center region of LCD 3510, and a chief ray 3504 for a peripheral region of LCD 3510. The direction of chief ray 3502 for the center region of LCD 3510 may match the peak luminance direction (e.g., the surface-normal direction) of LCD 3510, and thus the portion of the light emitted by the center region of LCD 3510 that reaches exit pupil 3530 of near-eye display 3500 may have a higher intensity. Therefore, the center region of LCD 3510 may appear to have a higher brightness to the user's eye. The direction of chief ray 3504 for the peripheral region of LCD 3510 may not match the peak luminance direction of LCD 3510, and thus the portion of the light emitted by the peripheral region of LCD 3510 that reaches exit pupil 3530 of near-eye display 3500 may have a lower intensity. Therefore, the peripheral region of LCD 3510 may appear to have a lower brightness to the user's eye.

Techniques for chief ray walk-off compensation and high-efficiency light coupling from a BLU into a display system and eventually into the user's eyes are disclosed herein. According to certain embodiments, the luminance profile of the BLU may be controlled to align the peak luminance angle with the CRA for regions across the display panel. In some embodiments, a diffractive optical element may be used between the BLU and the TFT array of an LC panel to deflect the light beam from the BLU such that the peak luminance angle may substantially align with the CRA.

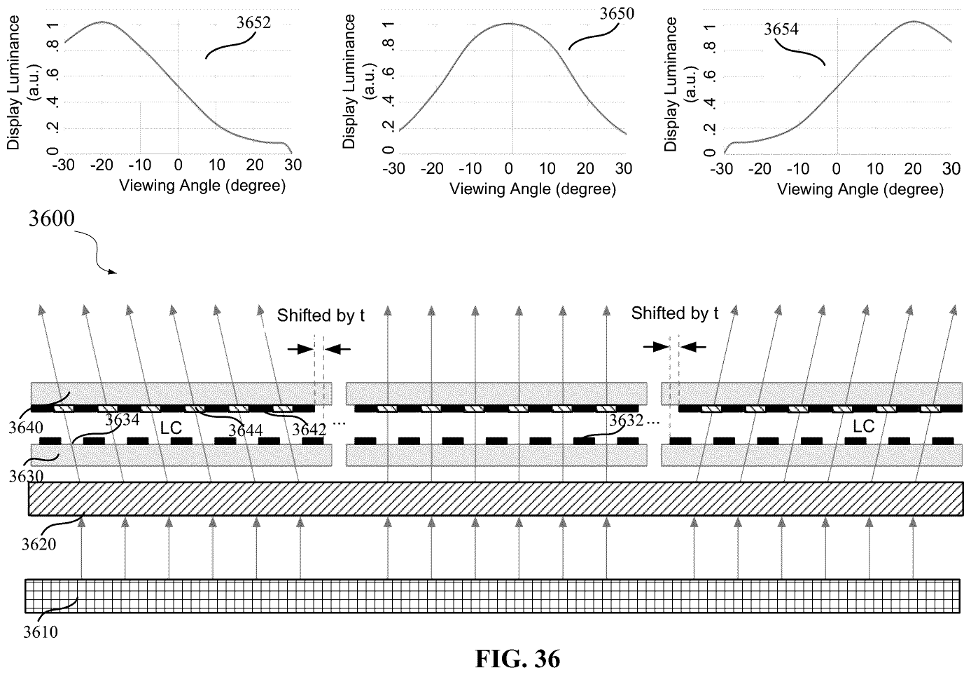

FIG. 36 illustrates an example of an LCD 3600 for a near-eye display according to certain embodiments. LCD 3600 may include a BLU 3610, a diffractive optical element 3620, a TFT array 3630 including a black-mask layer 3632 and an array of apertures 3634, and a CF/BM array 3640 including a black-mask layer 3642 and an array of color filter elements 3644 in black-mask layer 3642. Color filter elements 3644 may include red, green, and blue color filters. As illustrated in FIG. 36, diffractive optical element 3620 may be disposed between BLU 3610 and TFT array 3630 to deflect the light from different regions of BLU 3610 by different deflection angles such that the peak luminance angle may substantially align with the CRA for any region of BLU 3610. For example, diffractive optical element 3620 may substantially maintain the peak luminance angle (e.g., about 0°) of the light emitted by the center region of the BLU 3610 as shown by a diagram 3650, while changing the peak luminance angle (e.g., to about ±20° in the illustrated example) of the light emitted by the peripheral regions of BLU 3610 to align with the CRA for the peripheral regions of LCD 3600 as shown by diagrams 3652 and 3654. In addition, as shown in FIG. 36, the CF elements in CF/BM array 3640 may be shifted with respect to the apertures in the black-mask layer on TFT array 3630 (e.g., shifted by a distance t as shown in FIG. 36), such that the chief rays may pass through the centers of the apertures on TFT array 3630 and the centers of the CF elements in CF/BM array 3640. In this way, the portion of the light with the peak intensity may pass through the apertures and the color filter elements and reach the exit pupil of the near-eye display. As such, the brightness, the uniformity of the brightness, and the efficiency of the near-eye display may be improved.

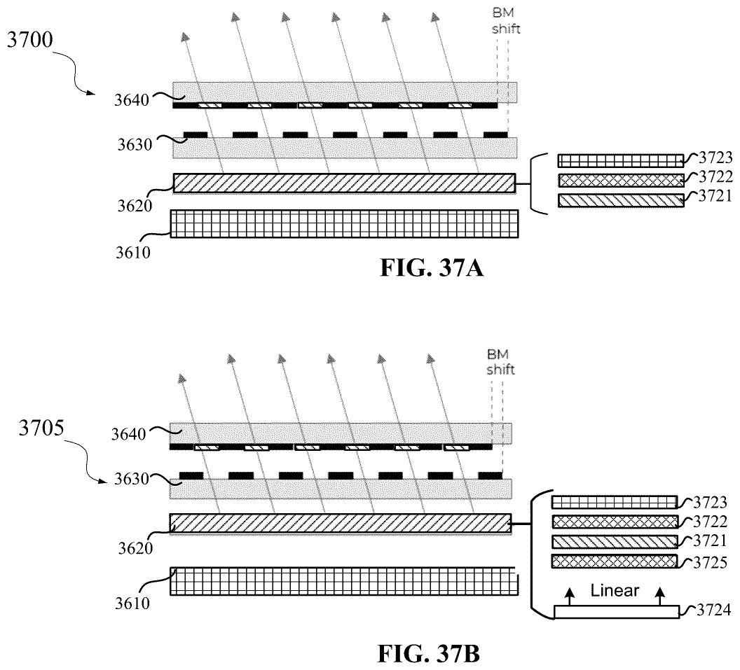

FIG. 37A illustrates an example of an LCD 3700 including a diffractive optical element according to certain embodiments. LCD 3700 may be an example of LCD 3300. In the example illustrated in FIG. 37A, diffractive optical element 3620 may include a geometric phase grating 3721 (e.g., a PBP lens) that may be sensitive to circularly polarized light, and a circular polarizer (e.g., including a quarter-wave plate 3722 and a linear polarizer 3723). Geometric phase grating 3721 may diffract right-handed circularly polarized light and left-handed circularly polarized light to different directions. Quarter-wave plate 3722 may convert the right-handed circularly polarized light and left-handed circularly polarized light into linearly polarized light with perpendicular polarization directions. Linear polarizer 3723 may allow linearly polarized light with one polarization direction to pass through and may block (e.g., reflect or absorb) linearly polarized light with a perpendicular polarization direction. Thus, light passing through diffractive optical element 3620 may be linearly polarized light with modified peak emission directions.

FIG. 37B illustrates another example of an LCD 3705 including a diffractive optical element according to certain embodiments. LCD 3705 may be another example of LCD 3300. In the example illustrated in FIG. 37B, diffractive optical element 3620 may include geometric phase grating 3721 (e.g., a PBP lens) that may be sensitive to circularly polarized light, and a circular polarizer (e.g., including a first quarter-wave plate 3722 and a linear polarizer 3723) as described above with respect to FIG. 37A, and may further include a reflective polarizer 3724 and a second QWP 3725 for increasing the brightness of LCD 3705. In some embodiments, reflective polarizer 3724 may be a thin-film reflective polarizer that may pass light of a first polarization state (e.g., a first linear polarization state) and reflect (instead of absorbing) light of a second polarization state (e.g., an orthogonal linear polarization state), where the reflected light may be at least partially recycled into light of the first polarization state and directed back to the reflective polarizer. The light of the first linear polarization state passing through the reflective polarizer may be converted to a circularly polarized light by second QWP 3725, where the circularly polarized light may be deflected by geometric phase grating 3721, converted to a linearly polarized light by QWP 3722, and optionally filtered by linear polarizer 3723, before entering the LC panel.

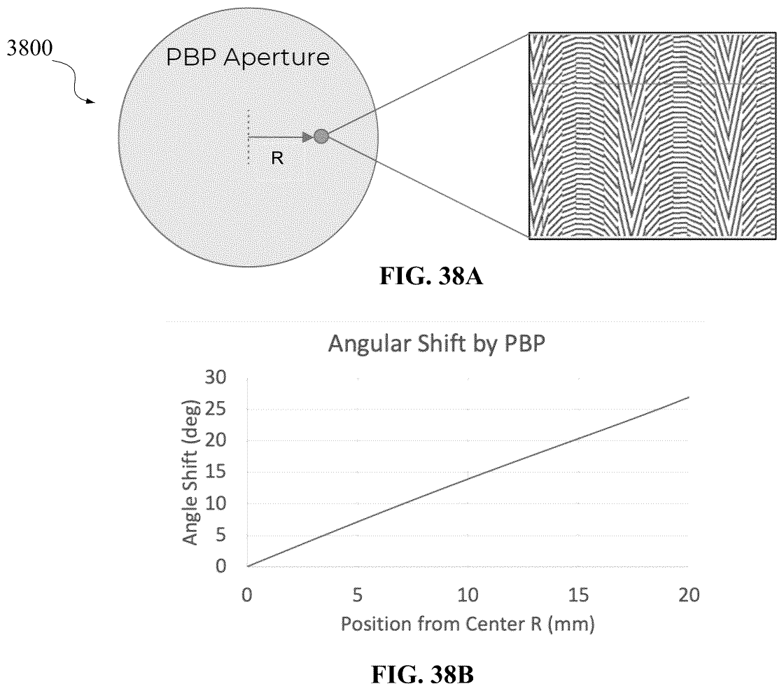

In some embodiments, the diffractive optical elements may be optical geometric phase elements (e.g., configured to modulate the phase of incident light). In some embodiments, the diffractive optical elements may include one or more layers of birefringent materials, such as LC materials, form-birefringent medium, metasurface patterns, and/or the surface plasmonic medium. For example, as illustrated in FIGS. 38-41, the optical geometric phase elements may include a PBP grating or a PBP lens designed such that, at different locations of the PBP grating or PBP lens, the angle shifts (or deflection angles) of the light emitted from the backlight unit with respect to a normal direction of the diffractive optical element may be different.

For example, the angle shifts may be determined based on the chief-ray angles of the near-eye display for different regions of the LCD as illustrated in FIGS. 35-37B. In some embodiments, as illustrated in FIGS. 36, 37A, and 37B, to further increase the performance of the near-eye display, the color filter/black-mask array may be shifted with respect to the TFT array. For example, instead of aligning the color filter elements of the color filter/black-mask array with the TFT pixels in the TFT array (i.e., the apertures in the TFT array), the color filter elements may be shifted toward the chief rays. This allows the chief rays passing through the apertures to pass through the centers of the color filter elements, resulting in display emission peaks that are centered around the chief rays.

In some embodiments, to avoid crosstalk between adjacent sub-pixels (e.g., due to the tunneling effect), a pixel pitch size of the sub-pixel may be smaller than about 30 micrometers and a lateral size of the color filter element may be smaller than about 10 micrometers.

FIG. 38A illustrates an example of a PBP lens 3800 that may be used in the diffractive optical element shown in FIGS. 36-37B. For example, PBP lens 3800 may be an example of geometric phase grating 3721 of diffractive optical element 3620 in FIG. 37A or 37B. An inset in FIG. 38A shows the orientations of the liquid crystal molecules at a region of PBP lens 3800. FIG. 38B illustrates a relationship between the desired angle shift of the incident light by PBP lens 3800 and the position of the incident point from the center of PBP lens 3800 shown in FIG. 38A. As shown in FIGS. 38A and 38B and described in detail below, the orientations of the liquid crystal molecules in the one or more liquid crystal material layers of PBP lens 3800 may be configured such that the angle shifts of the light emitted from the backlight unit by different regions of the PBP lens, with respect to a normal direction of the diffractive optical element, may be determined based on the distances (e.g., shown as “R” in FIG. 38A and FIG. 38B) of the different regions from a center of PBP lens 3800.

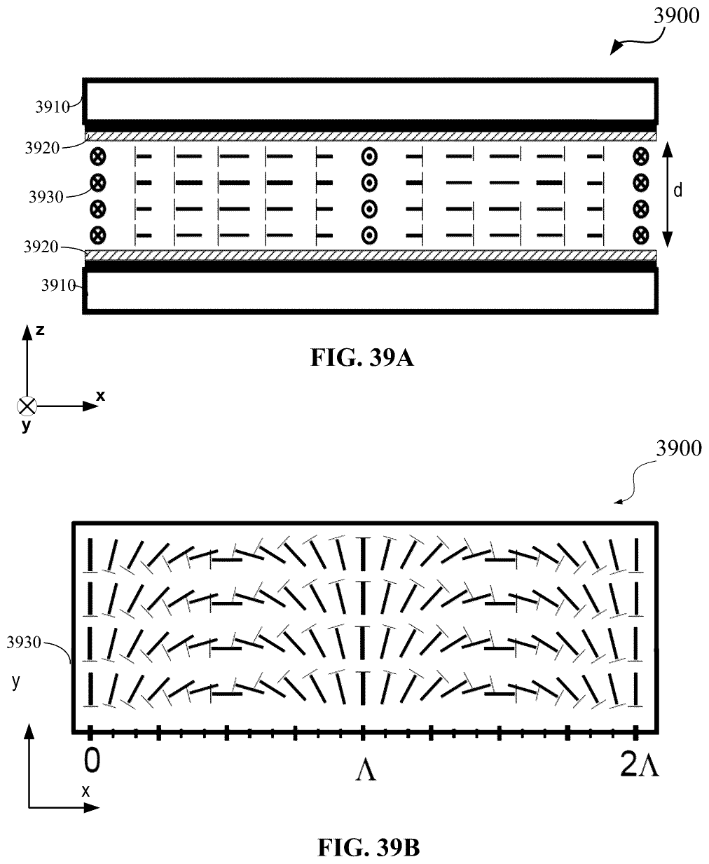

In some embodiments, depending on the chief-ray angles of the near-eye display (e.g., depending on the relative size of the aperture of the viewing optics shown in FIG. 35 compared with the lateral size of the BLU), PBP lenses may be designed to converge or diverge the incident light from the BLU. FIGS. 39A-41 below illustrate examples of PBP gratings or PBP lenses that may be used for deflecting incident light from the BLU of an LCD.

FIG. 39A is a view of an x-z plane of an example of a PBP grating. FIG. 39B is a view of an x-y plane of the example of PBP grating shown in FIG. 39A. In the illustrated example, PBP grating 3900 may include a pair of substrates 3910, one or two surface alignment layers 3920, and a liquid crystal layer 3930. Substrates 3910 may be transparent to visible light. Surface alignment layer(s) 3920 may have a predefined surface pattern, such that liquid crystal molecules in liquid crystal layer 3930 may self-align according to the predefined surface pattern. The surface pattern of the alignment layer may be formed by, for example, photo-alignment, micro-rubbing, non-uniform surface polymerization combined with rubbing, creation of surface polymer network, and the like. In some embodiments, PBP grating 3900 may include one substrate and a cured film attached to the substrate or may include a freestanding film that does not need to be attached to a substrate.

As illustrated, liquid crystal layer 3930 in PBP grating 3900 may include liquid crystal molecules that are oriented in a repetitive rotational pattern in the x-y plane when viewed in the light propagation direction (e.g., z direction). The repetitive rotational pattern may be created by, for example, recording the interference pattern of two orthogonally circular-polarized laser beams in a polarization-sensitive photo-alignment material in surface alignment layer 3920. Due to the repetitive rotational pattern of liquid crystal molecules in an x-y plane of liquid crystal layer 3930, PBP grating 3900 may have an in-plane, uniaxial birefringence that varies with position. The liquid crystal structure having the repetitive rotational pattern may give rise to a geometric-phase shift of incident light due to the polarization evolution as the light propagates through liquid crystal layer 3930 along the z direction. In the example shown in FIG. 39A, the liquid crystal molecules in liquid crystal layer 3930 may not be twisted along the z direction (e.g., with twist angle about 0° along the z direction) at any x-y location. In some embodiments, the liquid crystal molecules in liquid crystal layer 3930 may be twisted along the z direction to form helical structures, and the twist angle along the z direction may be about the same at different x-y locations.

The diffraction efficiency of PBP grating 3900 for surface-normal incident light (e.g., light propagating in the z direction) may be approximately determined by:

$${η}_{0} = {cos}^{2} ( \frac{πΔ nd}{λ} ) , and$$

$${η}_{\pm 1} = \frac{1 ∓ {s}_{3}^{′}}{2} {sin}^{2} ( \frac{πΔ nd}{λ} ) ,$$

where ηₘ is the diffraction efficiency of the mth diffraction order, Δn is the birefringence of liquid crystal layer 3930, d is the thickness of liquid crystal layer 3930, λ is the wavelength of the incident light, and S₃′=S₃/S₀ is the normalized Stokes parameter corresponding to the ellipticity of the polarization of the incident light. As indicated by the above equations, if the grating thickness d=λ/(2Δn) in the z direction (i.e., a half-wave retardation by liquid crystal layer 3930), the zeroth order transmission η₀ may be zero, and all incident light may be diffracted to the ±1 diffraction orders. The zeroth diffraction order may be polarization independent, while the ±1 diffraction orders may be sensitive to S₃′. For example, when the grating thickness d=λ/2Δn and the incident light has a right-handed circular polarization (S₃′=+1), η₊₁=0 and η₋₁=1, which indicates that all incident light passing through PBP grating 3900 may be diffracted into the −1 diffraction order. When the grating thickness d=λ/2Δn and the incident light has a left-handed circular polarization (S₃′=−1), η₊₁=1 and η₋₁=0, which indicates that all incident light is diffracted into the +1 diffraction order. Although m=+1 diffraction order is herein considered as the primary order and the m=−1 diffraction order is considered the conjugate order, the designation of the orders may be reversed or otherwise changed. In general, only the zeroth and the two first diffracted orders may be possible, regardless of the grating period Λ and the thickness d.

Moreover, after passing through PBP grating 3900, the circularly polarized light may be changed to light of the opposite circular polarization state, because the light may experience a relative phase shift about a half wavelength in liquid crystal layer 3930. For example, after the right-handed circularly polarized light (S₃=1) passes through PBP grating 3900, the polarization state of the light (e.g., in the −1 diffraction order) may be changed to the left-handed circular polarization (S₃=−1). After the left-handed circularly polarized light (S₃=−1) passes through PBP grating 3900, the polarization state of the light (e.g., in the +1 diffraction orders) may be changed to the right-handed circular polarization (S₃=1).

The pitch A (or period) of the repetitive rotational pattern of the liquid crystal molecules in an x-y plane of PBP grating 3900 may determine, in part, certain optical properties of PBP grating 3900. For example, the pitch A may determine the diffraction angles of the different diffraction orders according to the grating equation. Generally, the smaller the pitch, the larger the diffraction angle for light of a given wavelength and a given diffraction order.

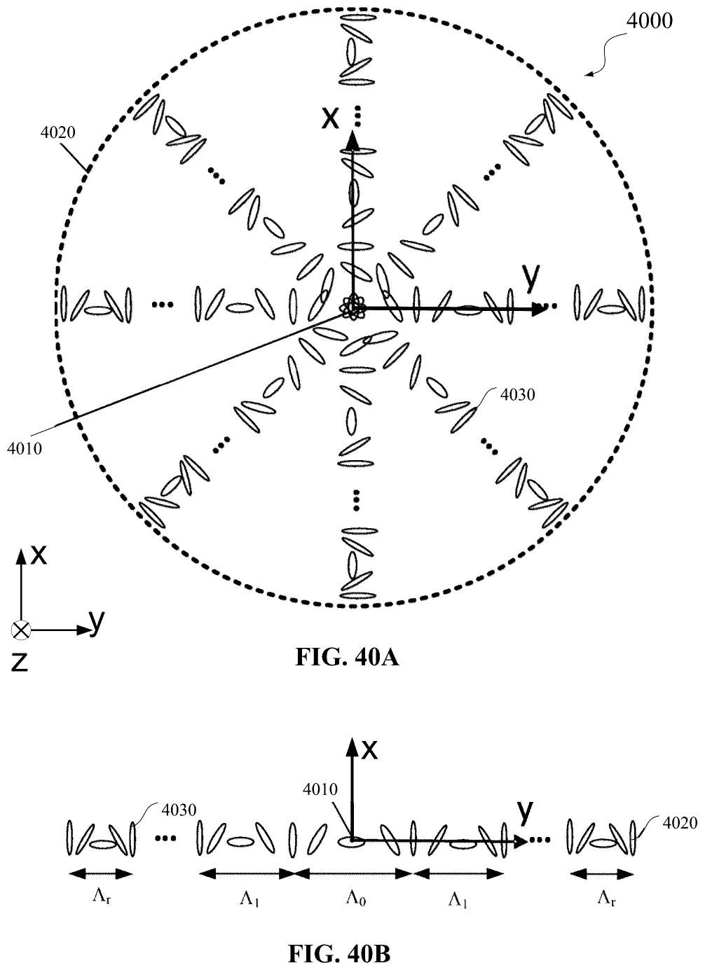

FIG. 40A illustrates LC molecule orientations in an example of a PBP lens 4000 according to certain embodiments. FIG. 40B illustrates the LC molecule orientations of a portion of the PBP lens of FIG. 40A according to certain embodiments. PBP lens 4000 may focus or diverge light due to the gradient of geometric phase within the lens. As shown in FIG. 40A, PBP lens 4000 may have a phase profile of a lens created by LC molecules 4030 with different in-plane orientations, where the phase delay φ(r) at a location may be a function of the azimuth angle ψ(r) of the optical axis (e.g., orientations of LC molecules 4030) at the location: φ(r)=±2ψ(r). The azimuth angles ψ(r) of LC molecules 4030 may be continuously changed from a center 4010 to an edge 4020 of PBP lens 4000. The pitch Λ of the rotational pattern of liquid crystal molecules 4030 within which the azimuth angles of LC molecules 4030 are rotated by 1140° may vary from center 4010 to edge 4020 of PBP lens 4000 to vary the diffraction angle. Accordingly, PBP lens 4000 can have a large aperture size and can be made with a thin LC layer to cause a half-wave retardation. PBP lens 4000 may have a twisted or non-twisted structure along the z-axis. A dual twist or multiple twisted structure along the z-axis may offer achromatic performance in PBP lens 4000. A non-twisted structure along the z-axis may be easier to fabricate than a twisted structure but may not offer achromatic performance.

The portion of PBP lens 4000 shown in FIG. 40B may be taken along a radial direction, such as along the y-axis. As shown in FIG. 40B, the pitch Λ of the rotational pattern of liquid crystal molecules 4030 may be a function of the distance from center 4010 and may progressively decrease as the distance from center 4010 increases. For example, the pitch Λ₀ at center 4010 may be the longest, the pitch Λᵣ at edge 4020 may be the shortest, and the pitch Λₙ between center 4010 and edge 4020 may be between pitch Λ₀ and pitch Λᵣ. Therefore, light incident on the center region of PBP lens 4000 may be diffracted by a smaller diffraction angle due to a longer pitch, while light incident on the edge region of PBP lens 4000 may be diffracted by a larger diffraction angle due to a shorter pitch.

The Jones vectors of LHCP light and RHCP light can be described as:

$${J}_{\pm } = \frac{1}{\sqrt{2}} [ \begin{matrix}1 \\ \pm j\end{matrix} ] ,$$

where J₊ and J₋ represent the Jones vectors of LHCP light and RHCP light, respectively. For a PBP lens with focal length f, the local azimuthal angle ψ(r) in an x-y plane may vary according to:

$$\pm 2 ψ ( r ) = ϕ ( r ) = - \frac{ω}{c} ( \sqrt{{r}^{2} + {f}^{2}} - f )$$

in order to achieve a centrosymmetric parabolic phase distribution, where φ, ω, c, and r are the relative phase, angular frequency, speed of light in vacuum, and radial coordinate of the lens, respectively. After passing through the PBP lens, the Jones vectors may be changed to:

$$\begin{matrix}{J}_{\pm }^{′} & = R ( - ψ ) W ( π ) R ( ψ ) {J}_{\pm } \\ & = [ \begin{matrix}cos ψ & - sin ψ \\ sin ψ & cos ψ\end{matrix} ] [ \begin{matrix}{e}^{- j \frac{π}{2}} & 0 \\ 0 & {e}^{- j \frac{π}{2}}\end{matrix} ] [ \begin{matrix}cos ψ & sin ψ \\ - sin ψ & cos ψ\end{matrix} ] \frac{1}{\sqrt{2}} [ \begin{matrix}1 \\ \pm j\end{matrix} ] \\ & = \frac{- j {e}^{\pm 2 j ψ}}{\sqrt{2}} [ \begin{matrix}1 \\ ∓ j\end{matrix} ] = - j {e}^{\pm 2 j ψ} {J}_{∓} ,\end{matrix}$$

where R(ψ) and W(π) are the rotation matrix and the retardation Jones matrix, respectively. As can be seen from the equation above, the handedness of the output light is switched relative to the incident light. In addition, a spatial-varying phase depending on the local azimuthal angle ψ(r) is accumulated. Furthermore, the phase accumulation has opposite signs for RHCP light and LHCP light, and thus the PBP lens may modify the wavefront of RHCP and LHCP incident light differently. For example, a PBP lens may have a positive optical power for RHCP light and a negative optical power for LHCP light, or vice versa.

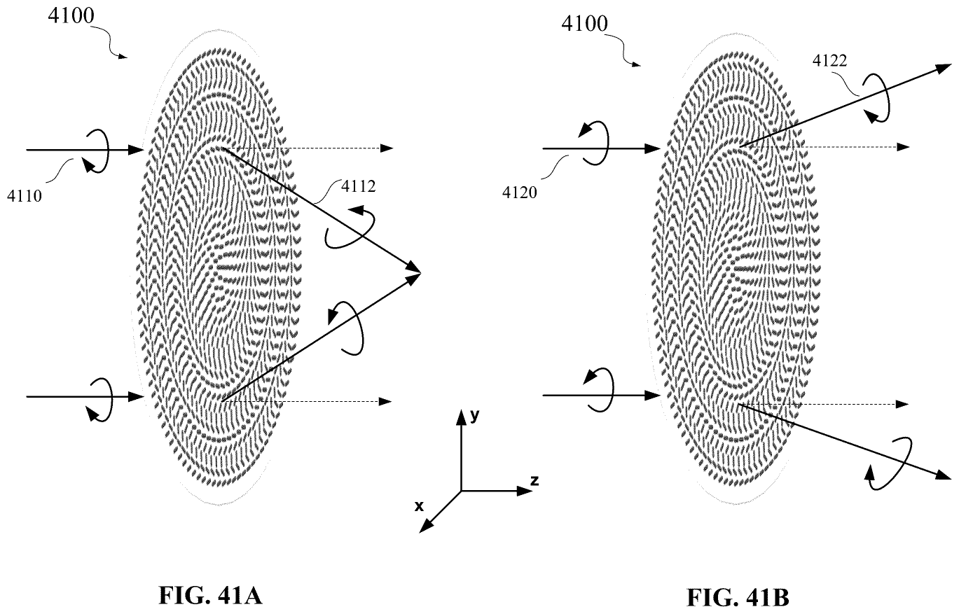

FIGS. 41A and 41B illustrate an example of a PBP lens that is sensitive to circularly polarized light according to certain embodiments. PBP lens 4100 may be an example of PBP lens 4000. FIGS. 41A and 41B show the LC molecule orientation of PBP lens 4100 in the x-y plane. The thickness d of PBP lens 4100 may be selected to achieve a half-wave retardation according to d=λ/(2Δn) as described above. PBP lens 4100 can be a passive or active lens and can have a positive or negative optical power for RHCP or LHCP light in various embodiments. In the illustrated example, PBP lens 4100 may have a positive optical power for RHCP light and thus may focus collimated RHCP light 4110 as shown in FIG. 41A. As described above, the handedness of the output light 4112 may be switched relative to the incident collimated RHCP light 4110 and thus may become LHCP light. As shown in FIG. 41B, PBP lens 4100 may have a negative optical power for LHCP light, and thus may diverge collimated RHCP light 4120. The handedness of the output light 4122 may become RHCP. When the half-wave retardation is not achieved, some input light may not be converted to the orthogonal polarization state and may not be diffracted as shown by the dashed lines in FIGS. 41A and 41B.

As described above, PBP lenses may be fabricated by coating liquid crystal polymer materials on an alignment layer with alignment patterns formed thereon. The alignment patterns may include alignment patterns for a lens, and may be formed by, for example, polarization interference patterning, direct laser writing patterning, imprint lithography, and the like. The liquid crystal polymer materials may be coated on the patterned surface of the alignment layer, for example, layer by layer, until a desired thickness is reached. A curing (e.g., UV or thermal curing) process may be performed to cure the liquid crystal polymer layers and fix the twist pattern of the liquid crystal molecules.

In one example, a photoalignment material (e.g., including a photocurable monomer material) may be coated on the surface of a substrate using, for example, spin coating or spray coating, to form a photoalignment material layer. The photoalignment material may include, for example, brilliant yellow (BY) dissolved in dimethylformamide (DMF). After the coating, the photoalignment material layer may be dried by, for example, baking at an elevated temperature (e.g., greater than about 100° C.) to remove the solvent. The photoalignment material layer may have a thickness about, for example, 10 nm to 50 nm. In one example, the photoalignment material layer may be exposed to an interference pattern generated by two overlapping circularly polarized light beams to form an alignment layer on the substrate. The circularly polarized light beams may include a left-handed circularly polarized beam and a right-handed circularly polarized beam and may be incident on a same area of the photoalignment material layer at desired incident angles to generate a desired polarization interference pattern and record the polarization interference pattern in the photoalignment material layer. The incident angles of the two circularly polarized beams may be selected to achieve the desired pattern in the alignment layer. The exposure of the photoalignment material layer to the interference pattern may cause the polymerization of the photocurable monomers of the photoalignment material at the bright regions of the interference pattern to form polymerized chains. Thus, the orientation of the alignment pattern in the alignment layer may vary across the alignment layer according to the interference pattern.

A layer of a birefringent material may be deposited on the alignment layer, for example, by spin coating or spray coating. The birefringent material may include optically anisotropic molecules (e.g., liquid crystal molecules) and a curable stabilizing material (e.g., photocurable monomers or polymers). For example, the birefringent material may include liquid crystal molecules mixed with photocurable monomers or polymers to form polymerizable liquid crystal reactive mesogens (RMs), such as polymer-stabilized nematic liquid crystals or polymer-dispersed nematic liquid crystals. The birefringent material may have a birefringence greater than about 0.1, greater than about 0.15, greater than about 0.2, or larger. In some embodiments, the birefringent material may also include a photo-initiator, a chiral dopant, and/or a dichroic dye. The optically anisotropic molecules in the layer of the birefringent material deposited on the alignment layer may align with the alignment pattern in the alignment layer. In some embodiments, the optically anisotropic molecules in the layer of the birefringent material may form helical structures. The layer of the birefringent material may be cured to fix the curable stabilizing material, which may stabilize the liquid crystal molecules in the layer of the birefringent material. In one example, the curing may be performed by exposing the layer of the birefringent material using an ultraviolet (UV) light beam to polymerize the photocurable monomers or cross-link the polymers to form crosslinked polymers. The layer of the birefringent material with the optically anisotropic molecules stabilized or fixed by the crosslinked polymers may from a polarization diffraction lens. In some embodiments, multiple liquid crystal reactive mesogen layers may be coated layer by layer on the alignment layer, until a desired thickness (e.g., to achieve a half-wave retardation for high efficiency) is reached. The multiple liquid crystal reactive mesogen layers may be cured together or layer by layer using UV light beam.

Embodiments may include different combinations of features. Certain embodiments are described in the following examples.

In Example 1, a liquid crystal display (LCD) of a near-eye display may include: a backlight unit configured to emit light; a thin-film-transistor (TFT) array including pixel control circuits and an array of apertures configured to transmit light; a diffractive optical element between the TFT array and the backlight unit, wherein the diffractive optical element is configured to, at two or more different locations of the diffractive optical element, deflect the light emitted from the backlight unit by different respective deflection angles towards the TFT array; a color filter on a side of the TFT array opposing the diffractive optical element, wherein the color filter comprises an array of color filter elements, and wherein each color filter element of the array of color filter elements is positioned along a chief ray direction of the near-eye display with respect to a corresponding aperture of the array of apertures of the TFT array; and a liquid crystal layer between the TFT array and the color filter and controlled by the pixel control circuits.

In Example 2, the diffractive optical element of the LCD of Example 1 is configured to deflect the light emitted from the backlight unit by deflection angles that match chief ray angles of the near-eye display.

Example 3 includes the LCD of Example 1 or 2, wherein a pitch of the array of color filter elements is smaller than 30 micrometers.

Example 4 includes the LCD of any of Examples 1-3, wherein a lateral size of each color filter element of the array of color filter elements is smaller than 10 micrometers.

Example 5 includes the LCD of any of Examples 1-4, wherein deflection angles at different locations of the diffractive optical element increase as distances of the different locations from a center of the diffractive optical element increase.

Example 6 includes the LCD of any of Examples 1-5, wherein the diffractive optical element is configured to deflect, at peripheral regions of the diffractive optical element, the light emitted from the backlight unit inwardly in a surface-normal direction of the diffractive optical element.

Example 7 includes the LCD of any of Examples 1-6, wherein the diffractive optical element is configured to deflect, at peripheral regions of the diffractive optical element, the light emitted from the backlight unit outwardly in a surface-normal direction of the diffractive optical element.

Example 8 includes the LCD of any of Examples 1-7, wherein the diffractive optical element comprises a Pancharatnam-Berry phase (PBP) element that is sensitive to circularly polarized light.

Example 9 includes the LCD of Example 8, wherein the PBP element includes one or more patterned birefringent layers that include a liquid crystal material, a form-birefringent structure, a meta-surface, a surface plasmonic layer, or any combination thereof.

Example 10 includes the LCD of Example 8, wherein the diffractive optical element further comprises a first quarter-wave plate configured to convert circularly polarized light into linearly polarized light.

Example 11 includes the LCD of Example 10, wherein the diffractive optical element further comprises a linear polarizer configured to selectively transmit the linearly polarized light converted by the first quarter-wave plate.

In Example 12, the LCD of Example 11 further comprises a brightness enhancement film and a second quarter-wave plate between the backlight unit and the TFT array, wherein the brightness enhancement film is configured to transmit linearly polarization light of a first linear polarization state and reflect linearly polarization light of a second linear polarization state that is orthogonal to the first linear polarization state.

In Example 13, the LCD of any of Examples 1-12 further comprises a second linear polarizer on a side of the color filter opposing the liquid crystal layer.

Example 14 includes the LCD of any of Examples 1-13, wherein: the TFT array includes a black-mask layer; and the array of apertures is formed in the black-mask layer.

In Example 15, the LCD of any of Examples 1-14 further comprises a black-mask layer, wherein the array of color filter elements is formed in the black-mask layer.

In Example 16, a near-eye display may include a liquid crystal display (LCD) configured to display an image; and display optics configured to project the image to a user's eye, wherein the LCD comprises: a backlight unit configured to emit light; a thin-film-transistor (TFT) array including control circuits and an array of apertures configured to transmit light; a diffractive optical element between the TFT array and the backlight unit, wherein the diffractive optical element is configured to, at two or more different locations of the diffractive optical element, deflect the light emitted from the backlight unit by different respective deflection angles towards the TFT array; a color filter on a side of the TFT array opposing the diffractive optical element, wherein the color filter comprises an array of color filter elements, and wherein each color filter element of the array of color filter elements is positioned along a chief ray direction of the near-eye display with respect to a corresponding aperture of the array of apertures of the TFT array; and a liquid crystal layer between the TFT array and the color filter and controlled by the control circuits to modulate incident light.

Example 17 includes the near-eye display of Example 16, wherein a pitch of the array of color filter elements is smaller than 30 micrometers.

Example 18 includes the near-eye display of Example 16 or 17, wherein the diffractive optical element is configured to deflect the light emitted from the backlight unit by deflection angles that match chief ray angles of the near-eye display.

Example 19 includes the near-eye display of any of Examples 16-18, wherein deflection angles at different locations of the diffractive optical element increase or decrease as distances of the different locations from a center of the diffractive optical element increase.

Example 20 includes the near-eye display of any of Examples 16-19, wherein the diffractive optical element comprises a Pancharatnam-Berry phase (PBP) element that is sensitive to circularly polarized light.

### VI. Hybrid High Efficiency BLU for VR HMD Brightness Uniformity Improvement

LCD panels may offer many advantages over other display technologies, such as lower cost, longer lifetime, higher energy efficiencies, larger sizes, and the like. However, transmissive LCD panels may have a resolution limit at about 2000 pixels per inch (PPI), even using the most advanced technologies. In addition, high-resolution LC panels (e.g., with a PPI greater than about 600 or higher such as 1400 or higher) may have low panel transmission and thus low power efficiency due to, for example, the reduced aperture ratio (e.g., the pixel active area over the pixel area) of each pixel. Therefore, it may be desirable to improve the efficiency of the BLU to improve the overall efficiency of the LCD panel. Many techniques can be utilized to improve the efficiency of BLU, such as prism-based brightness enhancement films (BEFs) that can manage the angular output of the light from BLU and focus light towards on-axis viewers of the display, reflective polarizer-based brightness enhancement films that can reflect polarized light not used by the LC panel to recycle the reflected light, and the like. However, further improvement of the efficiency may still be needed for LCD panels with high resolution.

In addition, display panels are often designed to have uniform viewing angle properties, where the light beam emitted by each region of a display panel may have, for example, a Gaussian beam profile with the peak luminance direction perpendicular to the display panel. However, the user's viewing angles (gazing angles) and the chief ray angles for different regions of the display panel may vary across the display panel. For example, the chief ray for the center region of an LCD panel may be in the surface-normal direction of the LCD panel, but the chief ray for other regions of the LCD panel may be tilted at different angles with respect to the surface-normal direction of the LCD panel. The mismatch between the display peak luminance angle and the chief ray angle may lead to brightness variations depending on the user's gaze direction, which may be referred to as the brightness-roll-off (BRO) effect.

For example, pancake optics may be used in near-eye display to achieve thin and light form factor. However, the light collection efficiency of pancake lens strongly depends on the emission profile of the display and the location of the light emission region, there may be perceived brightness drop due to mismatch between the lens collection angle and the display emission angle that has limited full-width half-magnitude (FWHM) range. For example, when the eye fixates at about 0°, pixels at peripheral regions may appear dimmer than the pixels at the center of the optical axis, even if these pixels have the same brightness. When the eye fixates at about +30°, pixels at the FOV about 30° may appear much dimmer than pixels at FOVs less than +30°, even if these pixels have the same brightness. One way to avoid such brightness roll-off (BRO) effect is to have broad emission cones from display, but this will dramatically reduce the efficiency of display.

According to certain embodiments, to reduce the BRO effect caused by the mismatch between the peak luminance angle of a display panel and the chief ray angles for some regions of the display panel that includes a pancake lens, a hybrid high efficiency backlight unit may be used to generate customized emission profiles based on, for example, characteristics of the display optics (e.g., a pancake lens). For example, the display panel may have a narrower emission profile at the center portion of the display active area but a wider emission profile at peripheral regions of the display active area. The beam profile variation can be achieved by, for example, using a backlight unit that includes a diffuser layer having different diffusion properties at different regions of the diffuser layer of the backlight unit. The diffuser layer may be an additional layer or may be an existing layer or structure of the BLU, with different amounts, shapes, or sizes of diffusive particles (e.g., micro-beads) added at different regions. In some embodiments, micro-structures (e.g., pyramids or prisms) of some layers of the BLU, such as some brightness enhancement films (BEFs), may be varied across the display panel to achieve different diffusion properties and thus different light emission profiles at different regions. This technique may improve the BRO performance for more gazing angles, while achieving better optical efficiency than displays with wide emission profiles across the entire active area.

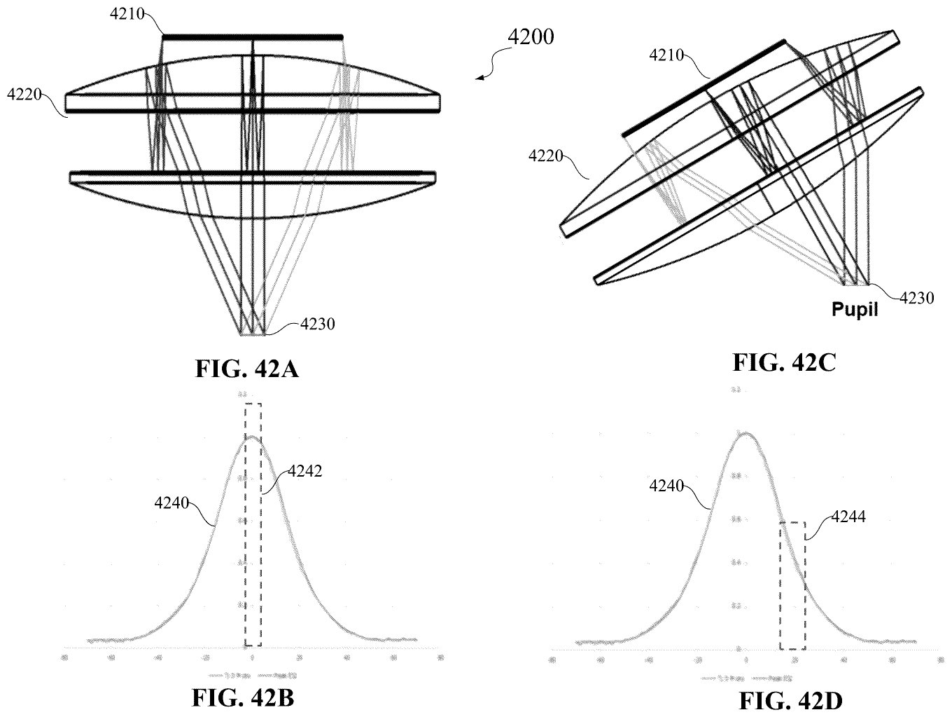

FIG. 42A illustrates an example of a near-eye display 4200 viewed by a user's eye having a gazing angle about 0°. In the illustrated example, near-eye display 4200 includes a display panel 4210 (e.g., an LCD panel) and display optics 4220 (e.g., a folded lens such as a pancake lens), which may project images generated by display panel 4210 onto a pupil 4230. As shown in FIG. 42A, at each region of display panel 4210, only light within a certain collection cone may be projected to the pupil and the user's eye. The chief ray angle and the collection cone may be different at different regions of display panel 4210. In the illustrated example, the gazing angle of the user's eye is at about 0°, the chief ray angle of a center region of display panel 4210 may be about 0° and the collection cone for the center region may be about 7.5°, whereas the chief ray angle of a peripheral region of display panel 4210 may be about 6.5°, and the collection cone for the center region may be about 7.5°.

FIG. 42B illustrates an example of a beam profile 4240 of the light beam emitted at each region of display panel 4210. Beam profile 4240 may have, for example, a Gaussian beam profile, with the peak luminance direction in a surface-normal direction (perpendicular to display panel 4210). For a center region of display panel 4210, when the gazing angle of the user's eye is at 0°, the chief ray angle may match the peak intensity direction, and thus the collected light may be in a region 4242 in FIG. 42 and may have higher energy. When the chief ray angle for a region (e.g., a peripheral region) of display panel is not at zero degree with respect to the surface-normal direction, light in the peak intension direction may not be collected, and thus the total energy of the collected light may be lower even if the collection cone is about the same. The larger the mismatch between the chief ray angle and the peak intensity direction, the lower the total energy of the collected light may be.

FIG. 42C illustrates the example of near-eye display 4200 viewed by a user's eye having a gazing angle about 30°. As shown in FIG. 42A, at each region of display panel 4210, only light within a certain collection cone may be projected to the pupil and the user's eye. The chief ray angle and the collection cone may be different at different regions of display panel 4210. In the illustrated example, the gazing angle of the user's eye is at about 30°, the chief ray angle of a center region of display panel 4210 may be about 11° and the collection cone for the center region may be about 6.5°, the chief ray angle of a left region of display panel 4210 may be about 2.8° and the collection cone for the center region may be about 4°, whereas the chief ray angle of a right region of display panel 4210 may be about 20° and the collection cone for the center region may be about 9°.

FIG. 42D illustrates beam profile 4240 of the light beam emitted at each region of display panel 4210 and a region 4244 of the beam profile showing light emitted from a right region of display panel 4210 and collected by display optics 4220 in near-eye display 4200 when the user's gazing angle is about 30°. As shown by region 4244 in FIG. 42D, even though the collection cone may be larger, the light intensity in region 4244 may be much lower than the peak value, and thus the total energy of the collected light may be low. As such, the light intensity perceived by the user's eye may be different for different regions of display panel 4210, which may also vary as the gazing angle of the user's eye changes.

When the FWHM angular range of the beam profile is large, even if there is some mismatch between the chief ray angle and the peak intensity direction, the total energy of the light collected by display optics 4220 from different regions of display panel 4210 may still be relatively uniform because the light intensity around the chief ray angle may still be sufficiently high. However, the light efficiency of the near-eye display may be low because a large portion of the emitted light having high intensity is outside of the collection cone. As such, it may not be desirable to uniformly increase the emission cone (the FWHM) of the light beam emitted at each region of display panel 4210.

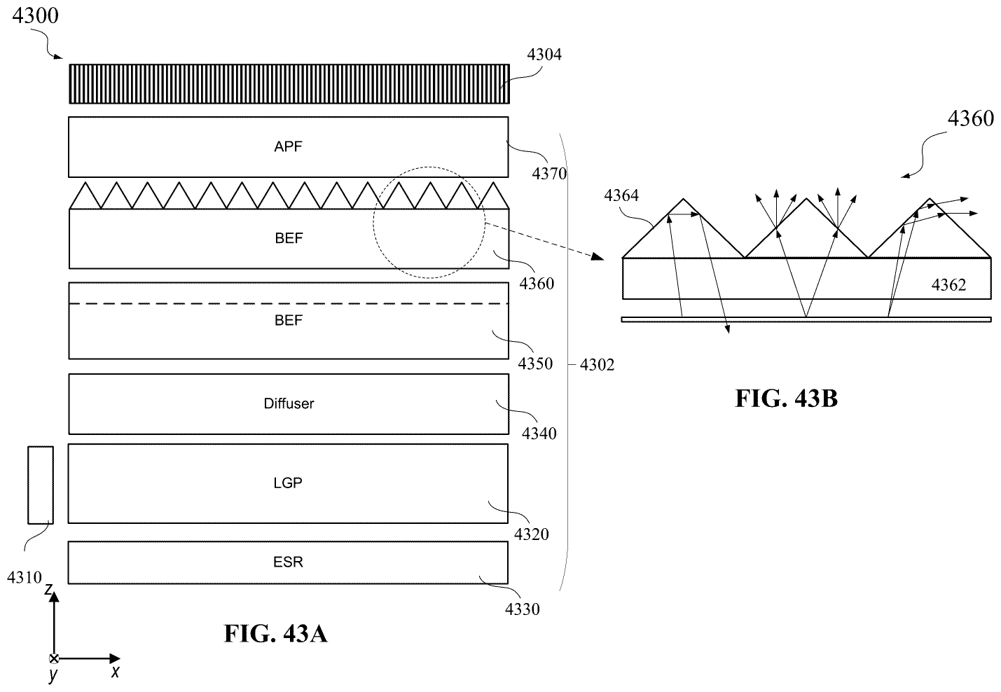

FIG. 43A illustrates an example of a backlight unit (BLU) 4302 in an LCD panel 4300. LCD panel 4300 may include an LC panel 4304 and BLU 4302. In the illustrated example, BLU 4302 may include a light source 4310, a light guide plate (LGP) 4320, an optional enhanced specular reflector (ESR) film 4330, a diffuser 4340, a bottom BEF 4350, a top BEF 4360, and an advance polarizing film (APF) 4370. Light source 4310 may include a light source configured to emit white light, such as an array of LEDs. The array of LEDs may include blue-light emitting LEDs and phosphors (e.g., yttrium, aluminum and garnet (YAG) phosphors) that may convert some blue light to green, yellow, and red light to produce white light.

Light emitted by light source 4310 may be coupled into LGP 4320 and may be guided by LGP 4320 (e.g., through total internal reflection) to propagate in approximately the x direction. Portions of the light guided by LGP 4320 may be coupled out of LGP 4320 towards diffuser 4340 by micro-structures, such as, for example, V-shaped blades, printed dots, particulates, diffusion reflectors, and the like, formed on LGP 4320. LGP 4320 may be flat or may have a wedge shape. ESR film 4330 may include a multi-layer optical film (e.g., including dielectric materials) that forms a highly efficient specular reflector, such as with a reflectivity greater than about 95% or higher. ESR film 4330 may be used to reflect incident light back towards LGP 4320 and LC panel 4304.

Light emitted from LGP 4320 may be diffused by diffuser 4340 to generate a uniform light pattern that has low light intensity variation. Bottom BEF 4350 and top BEF 4360 may include prismatic structures to focus light towards on-axis viewers of the display. Bottom BEF 4350 and top BEF 4360 may be used alone to provides up to about 60% increase in on-axis brightness, or may be used in combination (e.g., oriented at about 90° with respect to each other) to provide up to about 120% increase in on-axis brightness. Bottom BEF 4350 and top BEF 4360 may use refraction and reflection to increase the efficiency of backlighting. For example, bottom BEF 4350 and top BEF 4360 may refract light within a certain emission cone (e.g., within about 35° with respect to the z direction) toward the viewer, whereas light outside the emission cone may be reflected and at least partially recycled until it exits the film at angles within the emission cone.

FIG. 43B illustrates an example of top BEF 4360 in backlight unit 4302 of FIG. 43A. As illustrated, top BEF 4360 may include a substrate 4362 and an array of prisms 4364 formed on substrate 4362. Substrate 4362 may include, for example, polyester or another organic or inorganic material. The array of prisms 4364 may include, for example, an acrylic resin. The array of prisms 4364 may have prism angles, for example, about 90°, and may have a pitch, for example, about 50 μm. As shown in FIG. 43B, light incident on surfaces of the prisms of top BEF 4360 from certain angles may be refracted out of top BEF 4360, which may result in a confined emitted cone (e.g., within ±35° with respect to the normal direction) with increased (e.g., by about 58%) luminous intensity. Some light incident on surfaces of the prisms of top BEF 4360 at angles greater than the critical angle may be reflected at the surfaces due to total internal reflection, and may be further reflected by other surfaces of the prisms back to LGP 4320 and ESR film 4330. The light reflected back by top BEF 4360 may be recycled, for example, by ESR film 4330, which may reflect the incident light back towards top BEF 4360. A small portion of the light incident on top BEF 4360 may be reflected and then refracted out of top BEF 4360 and become stray light.

APF 4370 may include a reflective polarizer, and may transmit light of a first polarization state to LC panel 4304 for modulation and filtering. APF 4370 may reflect (rather than absorbing) light of an orthogonal second polarizations state for recycling. The light of the second polarization state reflected by APF 4370 may be reflected back to APF 4370 by, for example, ESR film 4330, where the reflected light may be at least partially converted to light of the first polarization state and thus may at least partially be transmitted by APF 4370 to LC panel 4304. Therefore, light of the second polarization state may be recycled and eventually transmitted by APF 4370 towards LC panel 4304, thereby improving the efficiency of BLU 4302.

In backlight unit 4302, diffuser 4340 may help to increase the FWHM angles of the emitted light beams. Increasing the FWHM of the beam profile of the light beams emitted by the display panel may reduce the BRO effect, but may also reduce the efficiency of the near-eye display as described above. In some implementations, it may be desirable that the light beam emitted from each region (pixel) of the LCD panel of a near-eye display has a narrow beam profile (more collimated) to increase the light efficiency of the near-eye display. The narrow beam profile may be achieved by, for example, replacing diffuser 4340 using a pyramid BEF. However, as described above, the brightness roll-off issue may be more severe for display panels with narrow beam profiles. In some implementations, a beam steering film maybe used to change the peak intensity directions of the narrow (e.g., substantially collimated) light beams emitted from different regions of a display panel, based on the corresponding chief ray angles. This may improve the optical efficiency of the near-eye display, and may also improve the intensity uniformity for at least one gazing direction.

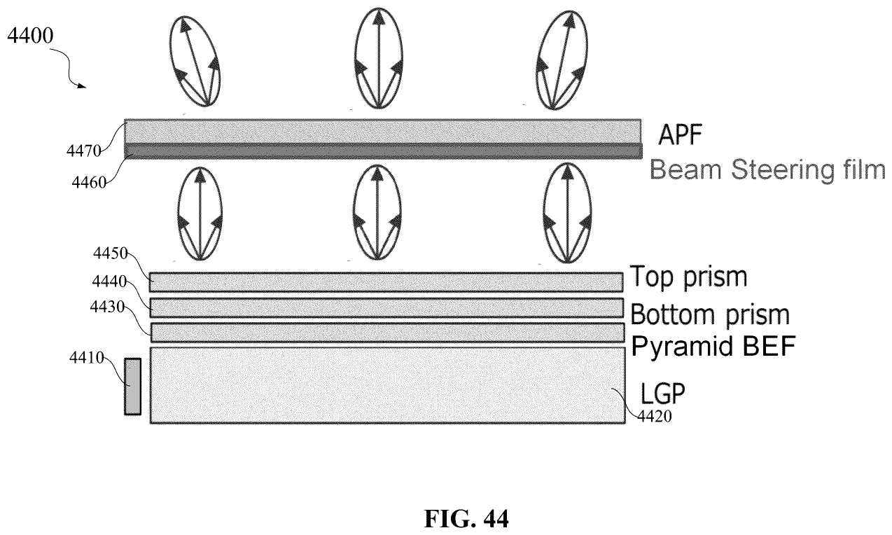

FIG. 44 illustrates an example of a BLU 4400 including a beam steering film 4460. BLU 4400 may be similar to BLU 4302 of FIG. 43A. BLU 4400 may include a light source 4410, a light guide plate (LGP) 4420, an optional enhanced specular reflector (ESR) film (not shown), a pyramid BEF 4430, a bottom BEF 4440, a top BEF 4450, a beam steering film 4460, and an advance polarizing film (APF) 4470. As described above, using a pyramid BEF instead of a diffuser (e.g., diffuser 4340) may generate light beams with narrower beam profiles, thereby improving the optical efficiency of the near-eye display. Beam steering film 4460 may tilt the light beams emitted from different regions of the display panel by different tilt angles such that, when the gazing direction of the user's eye at about 0°, the peak intensity direction may match the chief ray angle at not only the center region of the display panel but also the peripheral regions of the display panel. For example, at shown in FIG. 44, the light beam emitted at the center region may not be tilted, while the light beams emitted at the peripheral regions of the display panel may be tilted towards different directions. This may help to reduce the BRO effect when the gazing direction of the user's eye at about 0°. However, this may increase the BRO effect for other gazing angles. Adding beam steering film 4460 to the layer stack of BLU 4400 may increase the thickness and cost of BLU 4400.

According to certain embodiments, to reduce the BRO effect caused by the mismatch between the peak luminance angle of a display panel and the chief ray angles for some regions of the display panel that includes a pancake lens, a hybrid high efficiency backlight unit may be used to generate customized emission profiles based on, for example, characteristics of the display optics (e.g., a pancake lens). For example, the display panel may have a narrower emission profile at the center portion of the display active area but a wider emission profile at peripheral regions of the display active area. The beam profile variation can be achieved by, for example, using a diffuser layer having different diffusion properties at different regions. The diffuser layer may be an additional layer or may be an existing layer or structure of the BLU, with different amounts, shapes, or sizes of diffusive particles (e.g., micro-beads) added at different regions. In some embodiments, micro-structures (e.g., pyramids or prisms) of some layers of the BLU, such as some brightness enhancement films (BEFs), may be varied across the display panel to achieve different diffusion properties and thus different light emission profiles at different regions. The emission profile may gradually change from the center to the peripheral regions of the display panel, or may be different at different zones but may be the same in a same zone. This technique may improve the BRO performance for more gazing angles, while achieving better optical efficiency than displays with wide emission profiles across the entire active area.

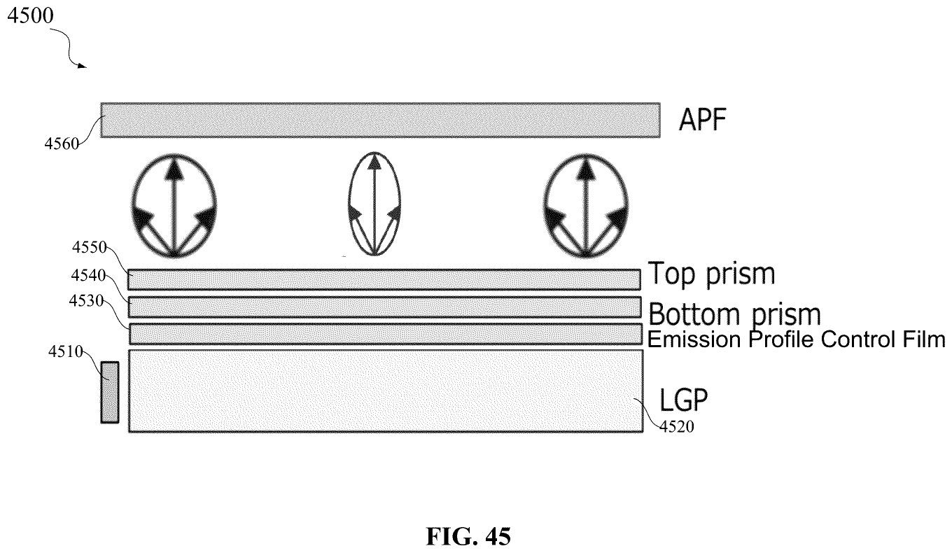

FIG. 45 illustrates an example of a BLU 4500 including an emission profile control film 4530 according to certain embodiments. BLU 4500 may be similar to BLU 4302 of FIG. 43A, but may include emission profile control film 4530, in addition to or instead of diffuser 4340 or pyramid BEF 4430. BLU 4500 may also include a light source 4510, a light guide plate (LGP) 4520, an optional enhanced specular reflector (ESR) film (not shown), a bottom BEF 4540, a top BEF 4550, and an advance polarizing film (APF) 4560 as described above with respect to FIGS. 43A and 44. Emission profile control film 4530 may be used to tune the emission beam profile across the display panel based on characteristics of the display optics (e.g., pancake lenses), such as the chief ray angle of each region or pixel of the display panel with respect to the display optics, the tolerable BRO level, and the like. As illustrated, the center region of the backlight unit and the display panel may have narrow beam profile, while peripheral regions of the backlight unit and the display panel may have wide beam profiles.

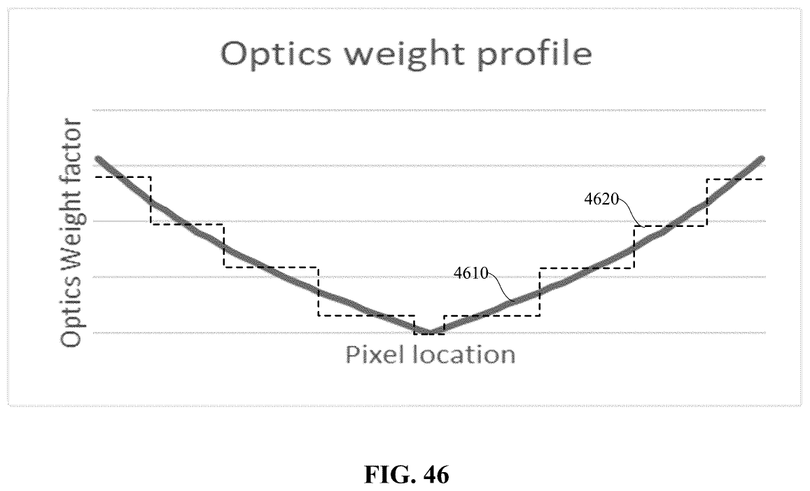

FIG. 46 illustrates an example of a relationship between the pixel location and the corresponding optical weight factor (e.g., FWHM of emission cone) in order to reduce the BRO effect according to certain embodiments. As shown by a curve 4610 in FIG. 46, pixels at the center of the display panel may have narrow beam profiles (emission cones). The FWHM of the emission cone of the pixel may need to gradually increase as the distance from the pixel to the center of the display panel increase. Curve 4610 may depend on, for example, dimensions of the display panel, design of the display optics, tolerable BRO, FOV of the near-eye display, and the like. The emission beam profiles of the pixels of the display panel may then be designed based on curve 4610. For example, the emission profile may be tuned to gradually change from the center to the peripheral regions of the display panel according to curve 4610, or may be different at different zones but may be the same in a same zone as shown by a stepped line chart 4620 that approximates curve 4610.

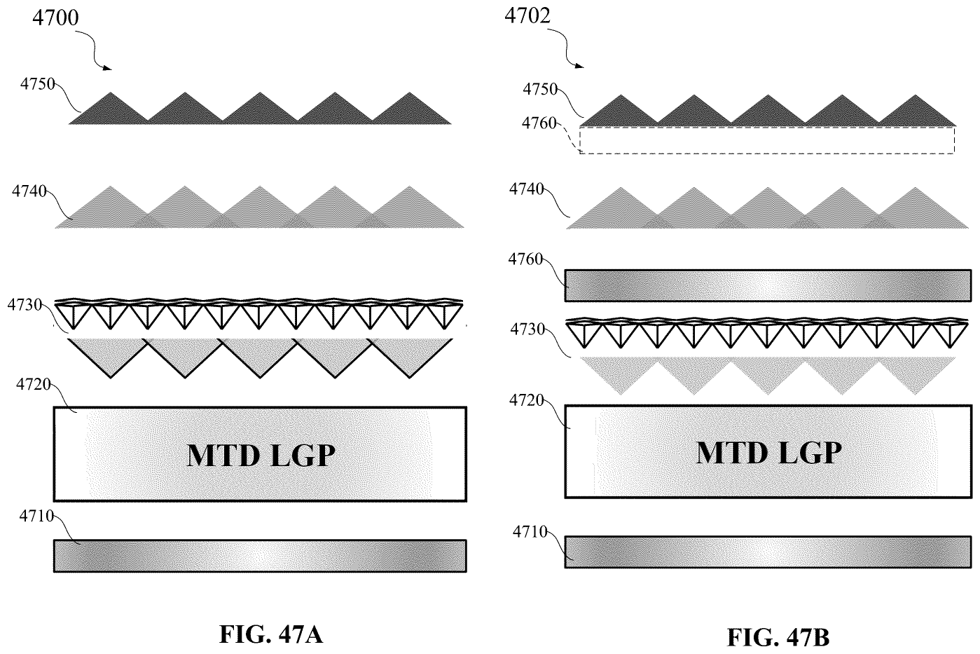

FIG. 47A illustrates an example of a BLU 4700 for reducing BRO effect according to certain embodiments. BLU 4700 may have a structure similar to the structure of BLU 4302 or 4400 described above, but may not need a beam steering film (e.g., beam steering film 4460) and may have some modification to the diffuser (e.g., diffuser 4340), the pyramid BEF (e.g., pyramid BEF 4430), the top BEF, and/or the bottom BEF. In the illustrated example, BLU 4700 may include a light source (not shown), a light guide plate (LGP) 4720, an optional enhanced specular reflector (ESR) film 4710, a bottom BEF 4740, a top BEF 4750, and an advance polarizing film (APF) (not shown) as described above with respect to FIGS. 43A and 44. BLU 4700 may also include a pyramid BEF 4730. Pyramid BEF 4730 may include, for example, concave or convex pyramid structures on one side (or one sublayer) and prism structures on another side (or another sublayer), and may be used as a variable diffuse to diffuse light and tune the beam profiles of the light beams for illuminating an LC panel. In some embodiments, diffusive micro- or nano-particles (e.g., micro-beads) may be added to the pyramid structures (e.g., cavity of the concave pyramid structures), where the amounts, shapes, and/or sizes of the diffusive particles added to different regions of pyramid BEF 4730 may vary in such a way that the diffusion may gradually increase from the center towards edges. In some embodiments, additionally or alternatively, the shape, size, and/or orientation of the pyramid structure and/or the prism structure may vary across pyramid BEF 4730 to change the diffusion performance of pyramid BEF 4730. As described above, the diffusion profile for each pixel or region may be determined in such a way that the resultant emission cone variation across the display active area (at the display module level) matches with a distribution curve determined based on the display optics design and the tolerable BRO level, such as curve 4610.

FIG. 47B illustrates another example of a BLU 4702 for reducing BRO effect according to certain embodiments. BLU 4700 may have a structure similar to the structure of BLU 4700 described above, but may include an additional variable diffuser 4760, or a variable diffuser layer formed on a substrate of pyramid BEF 4730, top BEF 4750, and/or bottom BEF 4740. In some embodiments, variable diffuser 4760 may include diffusive micro- or nano-particles (e.g., micro-beads), where the amounts, shapes, and/or sizes of the diffusive particles at different regions of variable diffuser 4760 may vary in such a way that the diffusion may gradually increase from the center towards edges. In some embodiments, variable diffuser 4760 may be between pyramid BEF 4730 and bottom BEF 4740. In some embodiments, variable diffuser 4760 may be coated or laminated on a surface (e.g., bottom surface) of top BEF 4750 and/or bottom BEF 4740. In some embodiments, variable diffuser 4760 may include two or more sublayers formed on substrates of two or more components of BLU 4702. As described above, the diffusion profile of variable diffuser 4760 for each pixel or region may be determined in such a way that the resultant emission cone variation across the display active area (at the display module level) matches with a distribution curve determined based on the display optics design and the tolerable BRO level, such as curve 4610.

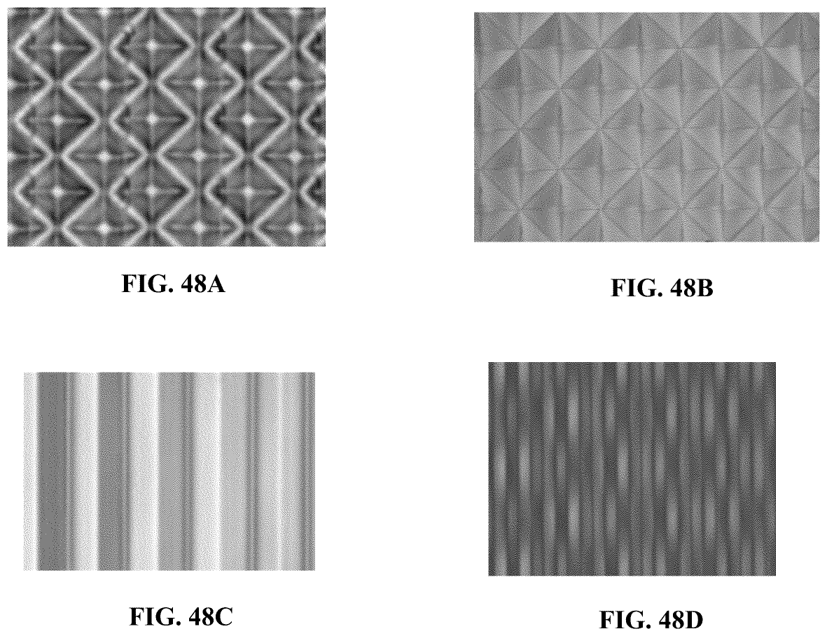

FIGS. 48A-48B illustrate examples of concave pyramid structures on pyramid BEF 4430 or 4730. The concave pyramid structures may be molded on one side of a substrate. The cavities of the concave pyramid structures may be filled with a material including diffusive nano- or micro-particles. FIGS. 48C-48D illustrate examples of prism structures on pyramid BEF 4430 or 4730. The prism structures may be formed on another side of the substrate.

In view of the description, embodiments may include different combinations of features described herein. Certain embodiments are described in the following examples.

In Example 1, a liquid crystal display (LCD) panel includes a liquid crystal (LC) panel and a backlight unit, the backlight unit comprising: a light source; a light guide plate configured to receive light from the light source, guide the light through total internal reflection, and couple portions of the light guided by the light guide plate out of the light guide plate; a brightness enhancement film configured to transmit incident light within an angular range and reflect incident light outside of the angular range; and a variable diffusion layer on a substrate or the brightness enhancement film, wherein the variable diffusion layer is configured to modify a full-width half-magnitude (FWHM) angular range of a light beam emitted from a region of the backlight unit by an amount determined based on a distance of the region from a center of the backlight unit.

Example 2 includes the LCD panel of Example 1, wherein the brightness enhancement film includes a pyramid brightness enhancement film including concave pyramid structures on a first side and prism structures on a second side, and wherein the variable diffusion layer is on the concave pyramid structures.

Example 3 includes the LCD panel of Example 1, wherein the brightness enhancement film includes a prism brightness enhancement film including prism structures on a first side, and wherein the variable diffusion layer is on a second side of the prism brightness enhancement film.

Example 4 includes the LCD panel of any of Examples 1-3, wherein the variable diffusion layer includes diffusive micro-particles.

Example 5 includes the LCD panel of any of Examples 1-4, wherein the variable diffusion layer includes micro-structures having different sizes, shapes, orientations, or a combination thereof at different regions.

### VII. Homogeneous Integration of Tiled Display System for Field-of-View Expansion

As described above, augmented reality (AR) and virtual reality (VR) applications may use near-eye displays (e.g., head-mounted displays) to present images to users. A near-eye display system may include an image source (e.g., a display panel) for generating image frames, and display optics for projecting the image frames to the user's eyes. It is generally desirable that the near-eye display system has a large field of view (FOV) and a higher resolution in order to, for example, improve the immersive experience of using the near-eye display system. The FOV of a display system is the angular range over which an image may be projected in the near or far field. The FOV of a display system is generally measured in degrees, and the resolution over the FOV is generally measured in pixels per degree (PPD). The FOV of a display system may be linearly proportional to the size of the image source (e.g., the display panel), and may be inversely proportional to the focal length of the display optics (e.g., a collimation lens or lens assembly). A balance between the size of the image source and the optical power of the display optics may be needed in order to achieve a good modulation transfer function (MTF) and reduced size/weight/cost. For example, for a smaller display panel, the field of view may be increased by bringing the image source closer, but the image source would need to have higher PPD, and the aberrations of the display optics at the periphery may limit the effective field of view. In addition, to achieve a high PPD, micro displays with ultra-high pixels per inch (PPI) may be needed. There may be many technological challenges and cost issues associated with making high-PPI display panels (e.g., silicon-based μOLED panels or micro-LED panels) with large sizes to cover wider FOVs. For example, when a single drive circuit die is used, the drive circuit die may need to have large chip dimensions to accommodate the OLED panel, gate and data driver, and display driver integrated circuit (DDIC) on the single die, and advanced processing technology with higher cost may need to be used. Production yield of the larger chips may be low. Therefore, micro displays may generally be small due to the limited sizes of the drive circuit dies and/or high cost for large sized drive circuit dies. As such, the FOVs of current AR/VR/MR systems may be limited, which may adversely affect the user experience.

Tiled displays that use two or more discrete display system may be used to improve the FOV, where a central display system for the central FOV and one or more peripheral display systems for the peripheral FOV may be placed, for example, side by side. However, tiled displays with discrete display systems may have many issues. One notable issue is the boundary between the central display system and the peripheral display systems. For example, mechanical structures such as lens housing and eye-tracking assembly housing may create physical boundary between the discrete display systems of the tiled displays. In addition, the boundary between discrete display systems with mismatching resolutions can result in abrupt transitions across a displayed image.

In some designs, an integrated, tiled display system may include at least a peripheral display panel with a lower resolution on a first region of a large base substrate, and may also include a higher resolution central display panel bonded on top of a second region of the large base substrate that is adjacent to the first region. The large base substrate may include a rigid or flexible substrate, such as a glass or another oxide substrate, or an organic substrate, such as a polyimide substrate. The peripheral display panel may include, for example, a lower resolution panel (e.g., with PPI≤1K) that does not need to use a silicon backplane to drive. For example, the peripheral display panel may be controlled using thin-film transistor (TFT) drive circuits formed on the first region of the large base substrate. The lower resolution peripheral display panel may include, for example, an active matrix organic light-emitting diode (AMOLED) display panel or a liquid crystal display (LCD) panel. The central display panel may have a higher resolution (e.g., with PPI≥4K or 5K), and may include, for example, micro-LEDs or μOLEDs with silicon-based backplane drive circuits. Thus, the tiled display system can have a higher resolution at least in the center (or foveated) region, and may also have a wider FOV provided by the combination of the central display panel and the peripheral display panel. For example, the monocular FOV of the tiled display system can be greater than 135°, 150°, 170° or wider, and the binocular FOV of a near-eye display including the tiled display system may be greater than abut 150°, 180°, 200°, 220°, or wider.

The central display panel with the higher resolution may have a small non-active edge region adjacent to the peripheral display panel. The small non-active edge region of the central display panel may be on top of and overlap with a non-active edge region of the peripheral display panel. Drive circuit of the peripheral display panel can be underneath the central display panel. Therefore, the non-active region between the two display panels of the tiled display system can be small (e.g., less than 2 mm, 1 mm, 0.5 mm, or smaller), such that the tiled display system may include a substantially continuous display panel with a higher resolution central region and a lower resolution peripheral region. In some embodiments, at least the peripheral region of the base substrate and the lower resolution display panel formed thereon can be curved to further increase the FOV (e.g., greater than 180°, such as about 200°-240°). Foveated rending may be utilized to create a smooth transition between the higher resolution central region and the lower resolution peripheral region. For example, in the boundary regions of the central display panel with the higher resolution, pixels in the central display panel may be grouped to form macro-pixels to gradually decrease the effective resolution from the higher resolution to the low resolution of the peripheral display panel.

The tiled displays formed by integrating heterogeneous display panels into one near-eye display system to expand the FOV may still have some gaps between the heterogeneous display panels and may have characteristic mismatch issues. For example, the backplane of the AMOLED display panel may include thin-film-transistors, whereas the backplane of the μOLED display panel may include CMOS circuits such as CMOS transistors. The different transistors in the different backplanes may have different electrical characteristics, and thus the different backplanes may need to have different pixel designs. In addition, the different OLED (e.g., AMOLED and μOLED) panels in the heterogeneous display panel may need to be made using different OLED fabrication processes. Therefore, there may be batch to batch mismatches that may cause different OLED opto-electrical characteristics in the heterogeneous display panels. In addition, the heterogeneous display panels may have different thicknesses, and thus the illumination layers of the heterogeneous display panels may have different distances to the display optics (e.g., a lens assembly). The differences in the distance between the illumination layer and the display optics may cause optical mismatch and may make it difficult to design the display optics to reduce optical aberrations and achieve good image quality.

According to certain embodiments, an OLED display panel may include three-dimensionally integrated heterogeneous backplane drivers bonded to an interposer or a printed circuit board (PCB) and a homogeneous OLED panel on the heterogeneous backplane drivers. The heterogeneous backplane drivers may include, for example, a display driver die with high PPI for a central display region and one or more display driver dies with lower PPI for peripheral display regions. The display driver dies may be fabricated separately on different wafers using different processing technologies, to achieve the desired resolution, yield, and cost. The display driver dies may then be singulated from the wafers and bonded to a side of an interposer. An OLED panel may then be formed simultaneously on multiple display driver dies or the interposer using a same OLED fabrication process. The OLED panel may include, for example, a hole injection layer, a hole transport layer, an emissive layer, an electron transport layer, and an electron injection layer that are formed on multiple display driver dies.

As such, the emissive layer for regions with different PPIs may be on a flat contiguous layer and thus may have the same distance from the display optics. Therefore, there may not be gaps between display regions having different PPIs. Since the emissive layer for different regions of the OLED panel may be on a homogeneous layer having the same distance from the display optics, it may be easier to design the display optics to reduce optical aberrations and achieve good image quality. In addition, because the display driver dies may all include CMOS drive circuits and the emissive layer at different regions is fabricated on a same layer using the same processes (thereby avoiding batch to batch mismatch), opto-electrical characteristics at different regions of the OLED display panel may be better matched, and thus it may be easier to achieve the desired uniformity in the optical characteristics of the OLED display panel.

In addition, the cost of OLED display panels disclosed herein may be reduced by, for example, optimizing backplane processing technologies, reducing the die size of each die thereby increasing yield, and reducing the total number of OLED processes. Not all dies need to be made using advanced processing technologies. For example, a more advanced technology (e.g., 22-nm processing technology) may be used for fabricating high-speed low-power DDIC, lower precision processing node (e.g., 32-nm processing technology) may be used for fabricating central display driver dies, while more mature processing node (e.g., 65 nm processing technology) may be used for fabricating peripheral display driver dies. In this way, the cost of the OLED display panel and the near-eye display can be reduced by using the most cost-effective processes while achieving the highest yield possible.

According to certain embodiments, an OLED display panel may include an interposer including a plurality of electrical interconnects, a plurality of display driver dies including pixel drive circuits and bonded to a first side of the interposer, and a single OLED panel formed on the interposer or the plurality of display driver dies, the OLED panel including a contiguous organic light emission layer and electrically coupled to the plurality of electrical interconnects of the interposer or the pixel drive circuits of the plurality of display driver dies. In some embodiments, the plurality of display driver dies may include at least a first display driver die characterized by a first pixel density and a second display driver die characterized by a second pixel density lower than the first pixel density. The first display driver die and the second display driver die may be fabricated using different fabrication technologies and have different feature sizes.

According to certain embodiments, a near-eye display system may include an OLED display panel, where the OLED display panel may include an interposer including a plurality of electrical interconnects, a plurality of display driver dies including pixel drive circuits and bonded to a first side of the interposer, and a single OLED panel formed on the interposer or the plurality of display driver dies, the OLED panel including a contiguous organic light emission layer and electrically coupled to the plurality of electrical interconnects of the interposer or the pixel drive circuits of the plurality of display driver dies. The plurality of display driver dies may include at least a first display driver die characterized by a first pixel density and a second display driver die characterized by a second pixel density lower than the first pixel density. The first display driver die and the second display driver die may be fabricated using different fabrication technologies and have different feature sizes.

Human eyes can have a wide monocular FOV (e.g., about 170°-175° or wider) and wide total binocular FOV (e.g., about 200°-220° or wider). To provide more immersive experience to a user of an artificial reality system, such as an AR, VR, or MR system, the near-eye display system of the artificial reality system may need to provide a large FOV that may be close to the FOV of naked human eyes without using the artificial reality system. In addition, to improve the user experience, a higher resolution display system may be desired. It can be challenging to provide a near-eye display that can provide both a large FOV and a high resolution.

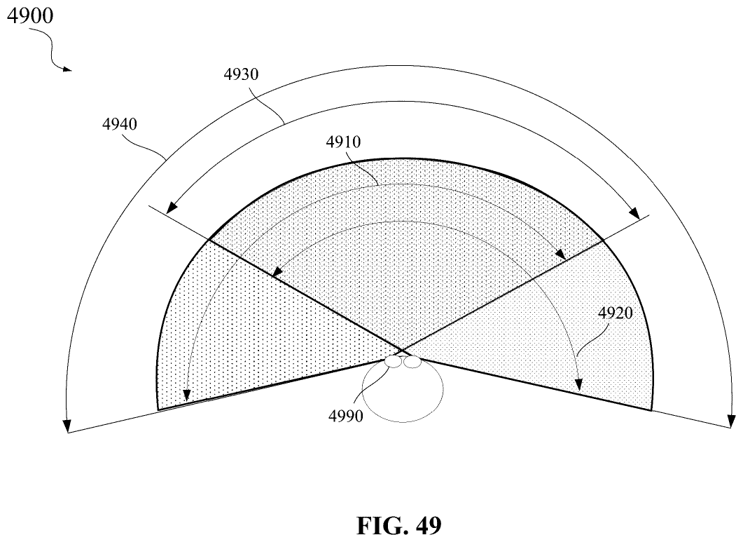

FIG. 49 includes a diagram 4900 illustrating examples of monocular and binocular fields of view of human eyes 4990. In FIG. 49, an angular range 4910 shows the horizontal monocular FOV of a left eye of a person, and an angular range 4920 shows the horizontal monocular FOV of a right eye of the person. Monocular FOV describes the field of view for one eye. For a healthy eye, the horizontal monocular FOV may be between about 170° and about 175°, which may include the nasal FOV (e.g., about 60°-65° from the pupil towards the nose) and the temporal FOV (e.g., about 100°-110° from the pupil towards the side of the head). FIG. 49 also shows a binocular FOV 4940 of human eyes 4990, which may be the combination of the two monocular fields of view in most humans, and may provide a total FOV of about 200°-220° or larger (e.g., up to 240°). The overlapped range of the two monocular fields of view may be refer to as the stereoscopic binocular field of view 4930, which may be about 114° to about 120°, objects within which may be perceived by the human eyes in three dimensions.

As described above, the FOV of a display system may be linearly proportional to the size of the image source (e.g., the display panel), and may be inversely proportional to the focal length of the display optics (e.g., a collimation lens or lens assembly). A balance between the size of the image source and the optical power of the display optics may be needed in order to achieve a good modulation transfer function (MTF) and reduced size/weight/cost. For example, for a smaller display panel, the field of view may be increased by bringing the image source closer, but the image source would need to have higher PPD, and the aberrations of the display optics at the periphery may limit the effective field of view. In addition, to achieve a high PPD, micro displays with ultra-high pixels per inch (PPI) may be needed. There may be many technological challenges and cost issues associated with making high-PPI display panels (e.g., silicon-based μOLED panels or micro-LED panels) with large sizes to cover wider FOVs. For example, when a single drive circuit die is used, the drive circuit die may need to have large chip dimensions to accommodate the OLED panel, gate and data driver, and display driver integrated circuit (DDIC) on the single die, and advanced processing technology with higher cost may need to be used. Production yield of the larger chips may be low. Therefore, micro displays may generally be small due to the limited sizes of the drive circuit dies and/or high cost for large sized drive circuit dies. As such, the FOVs of current AR/VR/MR systems may be limited, which may adversely affect the user experience.

Tiled displays that use two or more discrete display panels may be used to improve the FOV, where a central display panel for the central FOV and one or more peripheral display panels for the peripheral FOV may be placed, for example, side by side. However, tiled displays with discrete display panels may have many issues. One notable issue is the boundary between the central display system and the peripheral display system. For example, mechanical structures such as lens housing and eye-tracking assembly housing may create physical boundary between the discrete display systems of the tiled displays. In addition, the boundary between discrete display systems with mismatching resolutions can result in abrupt transitions across a displayed image.

In some embodiments, an integrated, tiled display system may include a peripheral display panel with a lower resolution on a first region of a large base substrate, and may also include a higher resolution central display panel bonded on top of a second region of the large base substrate that is adjacent to the first region. The large base substrate may include a rigid or flexible substrate, such as a glass or another oxide substrate, or an organic substrate, such as a polyimide substrate. The peripheral display panel may include, for example, a lower resolution panel (e.g., with PPI≤1K) that does not need to use a silicon backplane to drive. For example, the peripheral display panel may be controlled using thin-film transistor (TFT) drive circuits formed on the first region of the large base substrate. The lower resolution peripheral display panel may include, for example, an active matrix organic light-emitting diode (AMOLED) display panel or a liquid crystal display (LCD) panel. The central display panel may have a higher resolution (e.g., with PPI≥4K or 5K), and may include, for example, micro-LEDs or μOLEDs with silicon-based backplane drive circuits. Thus, the tiled display system can have a higher resolution at least in the center (or foveated) region, and may also have a wider FOV provided by the combination of the central display panel and the peripheral display panel. For example, the monocular FOV of the tiled display system can be greater than 135°, 150°, 170° or wider, and the binocular FOV of a near-eye display including the tiled display system may be greater than abut 150°, 180°, 200°, 220°, or wider.

The central display panel with the higher resolution may have a small non-active edge region adjacent to the peripheral display panel. The small non-active edge region of the central display panel may be on top of and overlap with a non-active edge region of the peripheral display panel. Drive circuit of the peripheral display panel can be underneath the central display panel. Therefore, the non-active region between the two display panels of the tiled display system can be small (e.g., less than 2 mm, 1 mm, 0.5 mm, or smaller), such that the tiled display system may include a substantially continuous display panel with a higher resolution central region and a lower resolution peripheral region. In some embodiments, at least the peripheral region of the base substrate and the lower resolution display panel formed thereon can be curved to further increase the FOV (e.g., greater than 180°, such as about 200°-240°). Foveated rending may be utilized to create a smooth transition between the higher resolution central region and the lower resolution peripheral region. For example, in the boundary regions of the central display panel with the higher resolution, pixels in the central display panel may be grouped to form macro-pixels to gradually decrease the effective resolution from the higher resolution to the low resolution of the peripheral display panel.

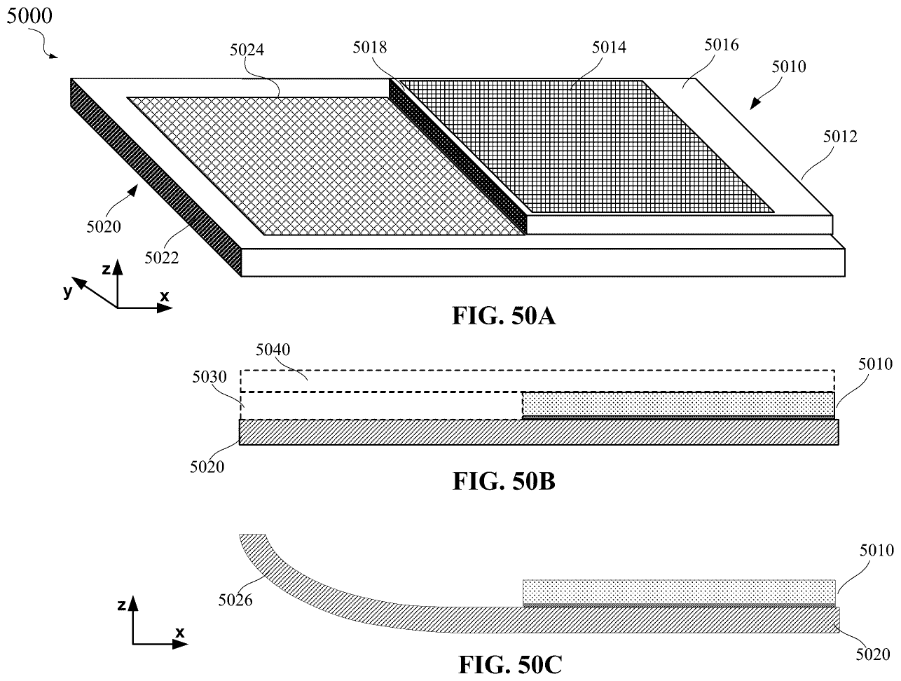

FIG. 50A is a perspective view of an example of a tiled display system 5000 according to certain embodiments. In the illustrated example, tiled display system 5000 may include a first display panel 5010 superimposed on a portion of a second display panel 5020. Second display panel 5020 may include a substrate 5022 that may be wider than, for example, 0.5″, 1″, 2″, or larger. Substrate 5022 may not be based on a semiconductor material, such as silicon, germanium, or a III-V semiconductor, but may instead include an oxide substrate (e.g., metal oxide or semiconductor oxide) or an organic substrate. For example, substrate 5022 may include a glass substrate, a sapphire substrate, a ceramic substrate, a polyimide substrate, a polyethylene naphthalate (PEN) substrate, and the like. Substrate 5022 may be rigid or may be flexible. In some embodiments, substrate 5022 may include thin film transistor (TFT) drive circuits formed thereon. An active region 5024 may be formed on a peripheral region of substrate 5022. Active region 5024 may include a display device that can be made to have a larger size (e.g., a few to tens of inches) but may have a lower resolution, such as with a PPI equal to or less than about 1K, and thus may not need to use silicon-based backplane drive circuits (which may have limited sizes) with small pixel drive circuit sizes. Active region 5024 may include, for example, AMOLED, LCD, and the like, and may be driven by the TFT drive circuits formed on substrate 5022. In one example, active region 5024 may include an AMOLED display that includes an active matrix of OLED pixels configured to generate light upon electrical activation, where the OLED pixels may be deposited or integrated onto a TFT array, which may function as a series of switches to control the current flowing to each individual OLED pixel. In some embodiments, the TFT drive circuits may be fabricated in, for example, an indium-gallium-zinc-oxide (IGZO) layer, a polycrystalline silicon layer, or an amorphous silicon layer.

A region (e.g., the right region shown in FIG. 50A) of substrate 5022 may not include light emitting devices, and first display panel 5010 may be bonded on top of the region. First display panel 5010 may include a substrate 5012 and an active region 5014 bonded to or otherwise formed on substrate 5012. Substrate 5012 may include, for example, a monocrystalline silicon substrate with drive circuits (e.g., complementary metal-oxide-semiconductor (CMOS) circuits) fabricated thereon. The CMOS drive circuits can have small feature sizes and high density, and thus can have small pixels and small pixel pitch, such as less than about 100 μm, 50 μm, 20 μm, 10 μm, 5 μm, 3 μm, 2 μm, or smaller. Active region 5014 may include, for example, a two-dimensional array of micro-LEDs fabricated using III-V semiconductor materials, such as GaN, GaAs, GaP, INP, AlGaInP; or micro-OLED (μOLED) that includes organic light emitting diodes and color filters. The pixel size of active region 5014 may match the pixel size of the CMOS drive circuits, and may be, for example, less than about 100 μm, 50 μm, 20 μm, 10 μm, 5 μm, 3 μm, 2 μm, or smaller. Active region 5014 may have a limited size, but may have a very high resolution, such as with a PPI greater than about 4 K or 5K. Pixels of active region 5014 may be bonded to and driven by the CMOS drive circuits in substrate 5012. Some edge regions 5016 of first display panel 5010 may not include light emitting devices, but may include peripheral drive circuits (e.g., row or column drive circuits). As shown in FIG. 50A, first display panel 5010 may have a very narrow non-active region 5018 at the side adjacent to active region 5024 of second display panel 5020, such that the non-active region between active region 5014 of first display panel 5010 and active region 5024 of second display panel 5020 may be negligible when viewed in the z direction. For example, a width of non-active region 5018 may be less than about 2 mm, less than about 1 mm, less than about 0.5 mm, or smaller.

FIG. 50B is a cross-sectional view of an example of tiled display system 5000 according to certain embodiments. In the example shown in FIG. 50B, substrate 5022 of second display panel 5020 may be a flat substrate including a rigid material, such as a metal oxide or semiconductor oxide. First display panel 5010 may be bonded on top of substrate 5022 (e.g., using an adhesive). An optional first cover glass 5030 with a thickness matching the thickness of first display panel 5010 may be bonded on active region 5024, such that the top surface of first cover glass 5030 and the top surface of first display panel 5010 may be on a same plane. In some embodiments, a second cover glass 5040 may be formed on first cover glass 5030 and first display panel 5010 to protect first display panel 5010.

FIG. 50C is a cross-sectional view of another example of tiled display system 5000 according to certain embodiments. In the example shown in FIG. 50C, substrate 5022 of second display panel 5020 may include a flexible substrate, and may be curved in at least a peripheral region 5026. For example, substrate 5022 may include a flexible material, such as an organic material including polyimide, polyethylene naphthalate, or the like. Active region 5024 (e.g., AMOLED) on the peripheral region 5026 of substrate 5022 may also be curved. Therefore, tiled display system 5000 may be curved and may cover the sides of the user's face/eye, thereby providing an overall binocular FOV greater than 180°, such as about 200° to about 240°.

The tiled displays formed by integrating heterogeneous display panels into one near-eye display system to expand the FOV may still have some display gaps between the heterogeneous display panels. For example, each display panel may have an edge region that may not emit light, and gaps between the heterogeneous display panels may not be light emitting regions. The tiled displays formed by integrating heterogeneous display panels may also have characteristic mismatch issues. For example, the backplane of the AMOLED display panel may include thin-film-transistors, whereas the backplane of the μOLED display panel may include CMOS transistors. The different transistors in the different backplanes may have different electrical characteristics, and thus the different backplanes may need to have different pixel designs. In addition, the different OLED (e.g., AMOLED and μOLED) panels in the heterogeneous display panels may need to be made using different OLED fabrication processes, and thus may have mismatch issues. There may also be batch to batch mismatches that may cause different OLED opto-electrical characteristics in the heterogeneous display panels. In addition, the heterogeneous display panels may have different thicknesses, and thus the light emission layers of the heterogeneous display panels may have different distances to the display optics (e.g., a lens assembly). The differences in the distance between the illumination layer and the display optics may cause optical mismatch and may make it difficult to design the display optics to reduce optical aberrations and achieve good image quality.

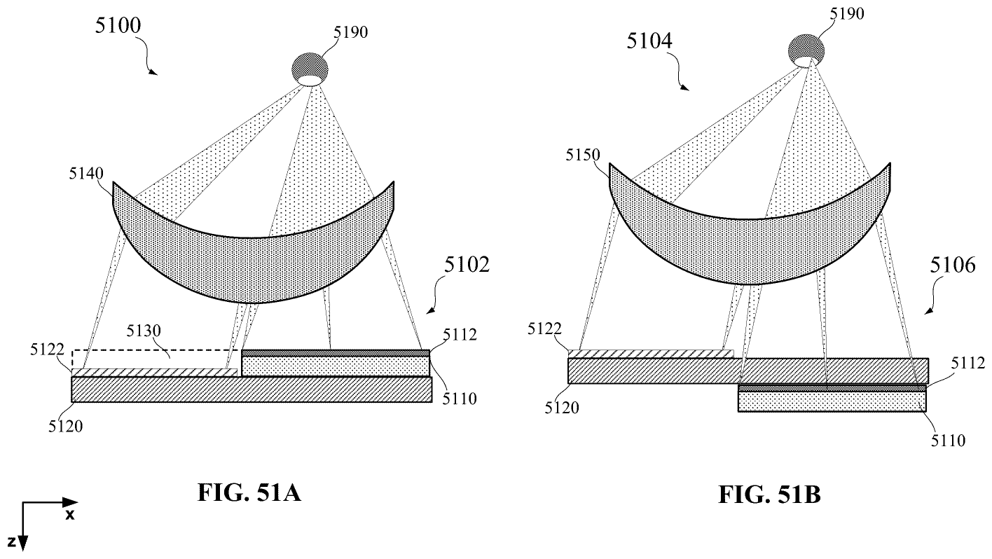

FIG. 51A illustrates an example of a near-eye display system 5100 including a tiled display system 5102 and display optics 5140. FIG. 51A only shows a half of near-eye display system 5100 for one eye of a user. A similar structure may be in the other half of near-eye display system 5100 for another eye of the user. Tiled display system 5102 may be similar to the tiled display systems described above with respect to FIGS. 50A-50C, and may include, for example, a display panel 5110 with a higher resolution and a display panel 5120 with a lower resolution that are integrated on a same substrate. In the illustrated example, an optional cover glass 5130 may be placed on display panel 5120. The thickness of cover glass 5130 may be about the same as the thickness of display panel 5110. Even though not shown in FIG. 51A, tiled display system 5102 may include another cover glass on display panel 5110 and cover glass 5130 to protect display panel 5110.

Display optics 5140 may include a single lens, a lens assembly, or two or more lenses or lens assemblies. In some embodiments, display optics 5140 may include a freeform lens that may include aspherical surfaces. In some embodiments, display optics 5140 may include a lens assembly that forms a folded lens, such as a pancake lens. In one example, display optics 5140 may include a meniscus (C-shaped) pancake lens that can provide a binocular FOV up to, for example, 220°, or a monocular FOV up to, for example, 175°, to user's eyes 5190. In some embodiments, display optics 5140 may include a flat lens, such as a Fresnel lens, a Pancharatnam Berry phase (PBP) lens, or a metasurface lens that can have different optical performance (e.g., focal length or optical power) at different regions. In some embodiments, display optics 5140 may need to include two lenses each optimized for one of display panel 5110 and display panel 5120.

As shown in FIG. 51A, when display panel 5110 is place on the substrate of display panel 5120, a light emitting layer 5112 of display panel 5110 may be closer to display optics 5140 than a light emitting layer 5122 of display panel 5120. Due to the different distances between the different light emitting layers and display optics 5140, it can be difficult to design display optics 5140 that can present all light emitting regions with good image quality to user's eyes 5190.

FIG. 51B illustrates another example of a near-eye display system 5104 including a tiled display system 5106 and display optics 5150. Near-eye display system 5104 may be similar to near-eye display system 5100, but tiled display system 5106 in near-eye display system 5104 may have a configuration different from the configuration of tiled display system 5102 in near-eye display system 5100. In tiled display system 5106, display panel 5110 with the higher resolution may be bonded to the bottom side of a region of the substrate of display panel 5120 with the lower resolution, where the region of the substrate may be transparent to visible light. In near-eye display system 5104, light emitting layer 5122 of display panel 5120 may be closer to display optics 5140 than light emitting layer 5112 of display panel 5110. Due to the different distances between the different light emitting layers and display optics 5150, it can be difficult to design display optics 5150 that can present all light emitting regions with good image quality to user's eyes 5190.

According to certain embodiments, an OLED display panel may include three-dimensionally integrated heterogeneous backplane drivers bonded to an interposer or a printed circuit board (PCB) and a homogeneous OLED panel on the heterogeneous backplane drivers. The heterogeneous backplane drivers may include, for example, a display driver die with high PPI for a central display region and one or more display driver dies with lower PPI for peripheral display regions. The display driver dies may be fabricated separately on different wafers using different processing technologies, to achieve the desired resolution, yield, and cost. The display driver dies may then be singulated from the wafers and bonded to a side of an interposer. An OLED panel may then be formed simultaneously on multiple display driver dies or the interposer using a same OLED fabrication process. The OLED panel may include, for example, a hole injection layer, a hole transport layer, an emissive layer, an electron transport layer, and an electron injection layer that are formed on multiple display driver dies.

As such, the emissive layer for regions with different PPIs may be on a contiguous, homogeneous layer and may have the same distance from the display optics. Therefore, there may not be gaps between display regions having different PPIs. Since the emissive layer for different regions of the OLED panel may be on a homogeneous layer having the same distance from the display optics, it may be easier to design the display optics to reduce optical aberrations and achieve good image quality. In addition, because the display driver dies may all include CMOS drive circuits and the emissive layer at different regions is fabricated on a same layer using the same processes (thereby avoiding batch to batch mismatch), opto-electrical characteristics at different regions of the OLED display panel may be better matched, and thus it may be easier to achieve the desired uniformity in the optical characteristics of the OLED display panel. In addition, the cost of OLED display panels disclosed herein may be reduced by, for example, optimizing backplane processing technologies, reducing the die size of each die thereby increasing yield, and reducing the total number of OLED processes.

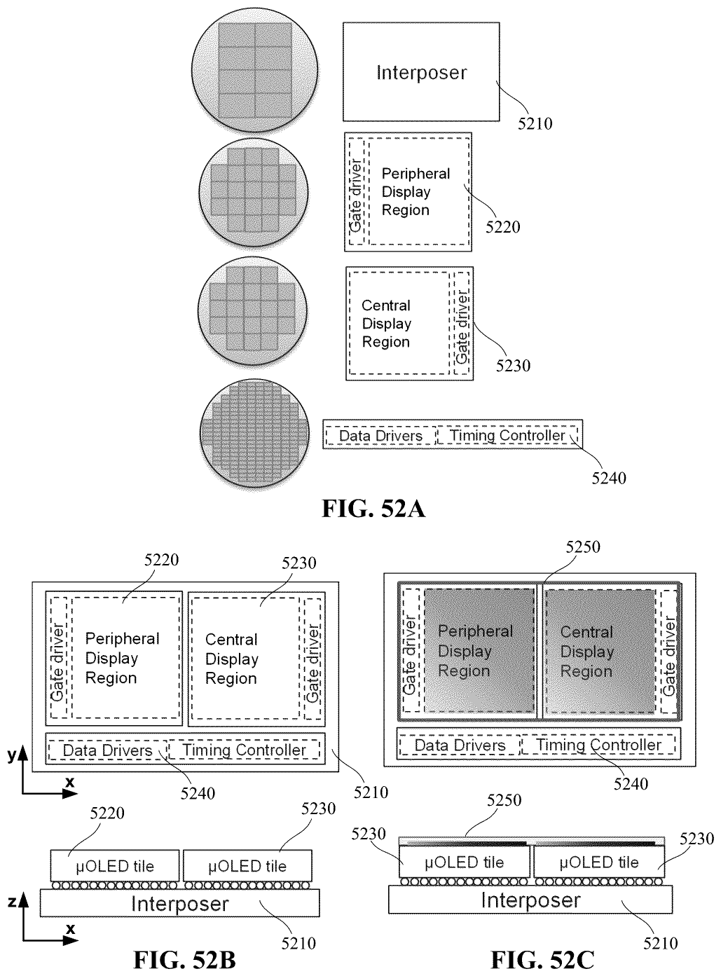

FIGS. 52A-52C illustrate an example of a process of fabricating a tiled display panel according to certain embodiments. FIG. 52A shows that interposers 5210, display driver dies 5220 for peripheral display regions, display driver dies 5230 for a central display region, and display controller dies 5240 (e.g., display driver integrated circuits (DDIC s)) may be fabricated on different wafers using different processing technologies. For example, more advanced technology (e.g., 22-nm processing technology) may be used to fabricate display controller dies 5240, which may include, for example, data driver circuits and timing controller circuits, and may need to have high speed and low power. Lower precision processing node (e.g., 32-nm processing technology) may be used to fabricate display driver dies 5230 for the central display region, which may have a higher pixel density or display resolution. Display driver dies 5230 may include pixel drive circuits and peripheral circuits, such as gate driver circuits. A more mature processing technology with even lower resolution (e.g., 65-nm processing technology) may be used for fabricating display driver dies 5220 for the peripheral display regions, which may have a lower pixel density or display resolution. Display driver dies 5220 may include pixel drive circuits and peripheral circuits, such as gate driver circuits. Each interposer 5210 may have a much larger size and may also be fabricated using a more mature processing technology with lower resolution. Each display driver die 5220, display driver die 5230, and display controller die 5240 may have a size much smaller than the size of interposer 5210, and thus can have a high yield even if more advanced processing technologies (with higher defect densities) are used to fabricate these dies. In this way, the cost of the OLED display panel and the near-eye display can be reduced by using the most cost-effective processes while achieving the highest yield possible.

FIG. 52B shows that one or more display driver dies 5220, at least one display driver die 5230, and at least one display controller die 5240 may be bonded to a same side of a same interposer 5210. For example, display driver dies 5220, display driver die 5230, and display controller die 5240 may include bonding pads, bonding balls, or bonding bumps on one side of the semiconductor substrates (e.g., silicon substrates), where the bonding pads, bonding balls, or bonding bumps may be electrically connected to the drive and control circuits on the other side of the semiconductor substrates by, for example, through-silicon vias (TSVs). Interposer 5210 may also include bonding pads, bonding balls, or bonding bumps formed thereon, which may be used to bond with the bonding pads, bonding balls, or bonding bumps on display driver dies 5220, display driver die 5230, and display controller die 5240. In the example shown in FIG. 52B, the bottom sides of display driver dies 5220, display driver die 5230, and display controller die 5240 may be bonded to interposer 5210, and the drive and control circuits may be on the top sides of display driver dies 5220, display driver die 5230, and display controller die 5240. Display driver dies 5220, display driver die 5230, and display controller die 5240 may have similar heights. Therefore, the top surfaces of display driver dies 5220, display driver die 5230, and display controller die 5240 may be on approximately the same plane.

FIG. 52C shows that a homogeneous OLED panel 5250 may be formed on the top surfaces of display driver dies 5220 and display driver die 5230. Homogeneous OLED panel 5250 may include, for example, an anode layer (which may be included in display driver dies 5220 and 5230 in some embodiments), a hole injection layer, a hole transport layer, an emissive layer, an electron transport layer, an electron injection layer, a cathode layer, and an encapsulation layer formed on the top surfaces of display driver dies 5220 and display driver die 5230 in a same processing flow. Each of the hole injection layer, hole transport layer, emissive layer, electron transport layer, and electron injection layer may be a contiguous layer that covers the central display region and peripheral display regions. Therefore, there may not be gaps between display regions having different PPIs.

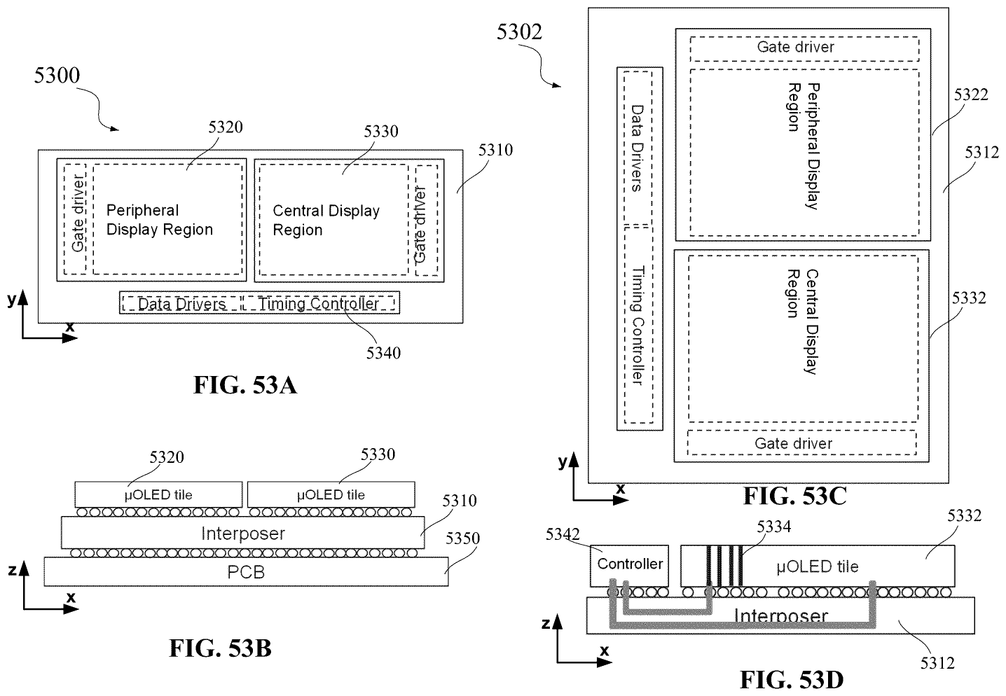

FIGS. 53A and 53B illustrate an example of a tiled display panel 5300 according to certain embodiments. In the illustrated example, display panel 5300 includes a PCB 5350, and an interposer 5310 bonded to PCB 5350 through, for example, bonding balls or bumps. Interposer 5310 may include at least one display driver die 5330 for the central display region, one or more display driver dies 5320 for peripheral display region, and at least one display controller die 5340 bonded to the top surface of interposer 5310 through, for example, bonding balls or bonding bumps. As described above, display driver dies 5320, display driver die 5330, and display controller die 5340 may include TSVs for connecting the bonding balls or bonding bumps on the bottom side to drive or control circuits on the top side. Interposer 5310 may include one or more interconnect layers that include routing traces or other electrical interconnects for electrically connecting display controller die 5340 to display driver dies 5320 and display driver die 5330. A homogeneous OLED panel (not shown in FIGS. 53A and 53B) similar to homogeneous OLED panel 5250 may be formed on the one or more display driver dies 5320 and at least one display driver die 5330 using a same processing flow, and thus there may not be gaps between display regions having different PPIs.

FIGS. 53C and 53D illustrate another example of a tiled display panel 5302 according to certain embodiments. In the illustrated example, display panel 5302 may include an interposer 5312, and at least one display driver die 5332 for the central display region, one or more display driver dies 5322 for peripheral display regions, and at least one display controller die 5342 bonded to the top surface of interposer 5312 through, for example, bonding balls or bonding bumps. Display driver dies 5322, display driver die 5332, and display controller die 5342 may include TSVs 5334 for connecting the bonding balls or bonding bumps on the bottom side to the drive or control circuits on the top side. Interposer 5312 may include one or more interconnect layers that include routing traces or other electrical interconnects for electrically connecting display controller die 5342 to display driver dies 5322 and display driver die 5332. A homogeneous OLED panel (not shown in FIGS. 53C and 53D) similar to homogeneous OLED panel 5250 may be formed on the at least one display driver die 5332 and one or more display driver dies 5322 using a same processing flow, and thus there may not be gaps between display regions having different PPIs.

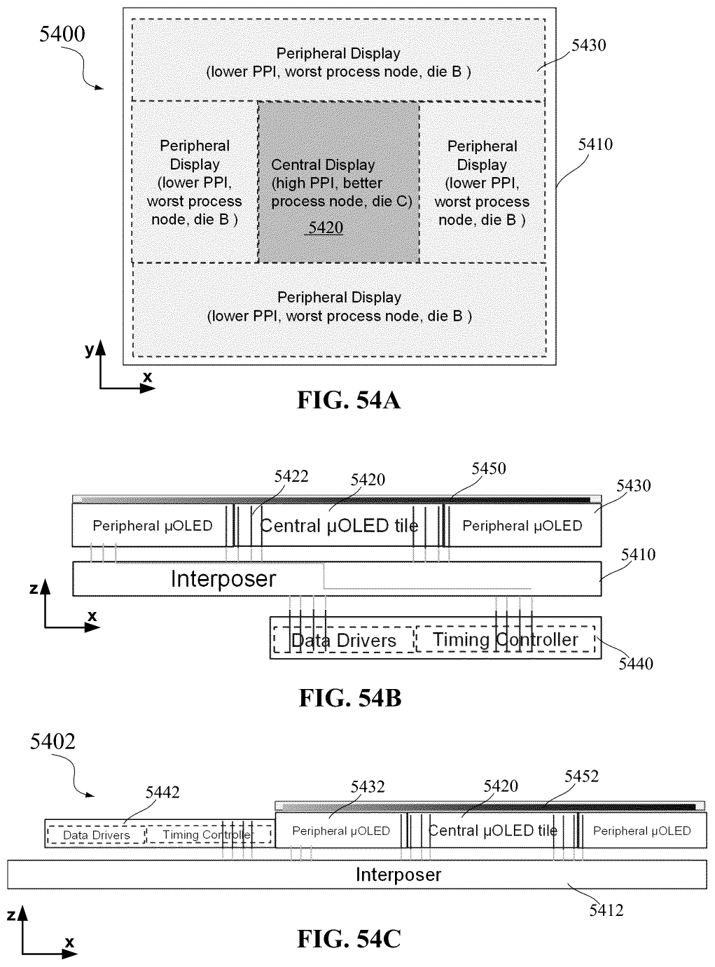

FIGS. 54A-54B illustrate an example of a tiled display panel 5400 according to certain embodiments. In the illustrated example, display panel 5400 may include an interposer 5410, and a display driver die 5420 for a central display region and one or more display driver dies 5430 for peripheral display regions bonded to the top surface of interposer 5410 through, for example, bonding balls or bonding bumps. Display driver die 5420 and display driver dies 5430 may include TSVs 5422 for connecting the bonding balls or bonding bumps on the bottom side to the drive circuits on the top side. A top or bottom surface of a display controller die 5440 may be bonded to the bottom surface of interposer 5410. For example, the top surface of display controller die 5440 including data driver and time control circuits may be bonded to interposer 5410 by flip-chip bonding. In another example, display controller die 5440 may include TSVs, and the bottom surface of display controller die 5440 may include bonding balls or bumps and may be bonded to interposer 5410 using the bonding balls or bumps. Interposer 5410 may include one or more interconnect layers that include routing traces or other electrical interconnects for electrically connecting display controller die 5440 to display driver die 5420 and display driver dies 5430.

As described above, more advanced CMOS processing technology may be used to fabricate display controller die 5440, which may include, for example, data driver circuits and timing controller circuits, and may need to have high speed and low power. A lower precision CMOS processing node may be used to fabricate display driver die 5420 for the central display region, which may have a higher pixel density or display resolution. Display driver die 5420 may include pixel drive circuits and peripheral circuits, such as gate driver circuits. A more mature CMOS processing technology with even lower resolution may be used for fabricating display driver dies 5430 for the peripheral display regions, which may have a lower pixel density or display resolution. Display driver dies 5430 may include pixel drive circuits and peripheral circuits, such as gate driver circuits. Each interposer 5410 may have a much larger size and may also be fabricated using a more mature processing technology with lower resolution. Each display driver die 5420, display driver die 5430, and display controller die 5440 may have a respective size much smaller than the size of interposer 5410.

Display driver die 5420 and display driver dies 5430 on the top surface of interposer 5410 may be fabricated on silicon wafers and may have similar thicknesses. Therefore, the top surfaces of display driver die 5420 and display driver dies 5430 may be on approximately the same plane. As such, a planar, homogeneous OLED panel 5450 may be formed on the top surfaces of display driver die 5420 and display driver dies 5430. Homogeneous OLED panel 5450 may include, for example, an anode layer (which may be included in display driver dies 5420 and 5430 in some embodiments), a hole injection layer, a hole transport layer, an emissive layer, an electron transport layer, an electron injection layer, a cathode layer, and an encapsulation layer, which may be fabricated in a same processing flow. Each of the hole injection layer, hole transport layer, emissive layer, electron transport layer, and electron injection layer may be a contiguous layer that covers the central display region and peripheral display regions. Therefore, there may not be gaps between display regions having different PPIs.

FIG. 54C illustrates another example of a tiled display panel 5402 according to certain embodiments. Display panel 5402 may be similar to display panel 5400. Display panel 5402 may include an interposer 5412, and may also include a display driver die 5420 for a central display region, one or more display driver dies 5432 for peripheral display regions, and a display controller die 5442 bonded to the top surface of interposer 5410. Display driver die 5420, display driver dies 5432, and display controller die 5442 may include TSVs for connecting bonding balls or bonding bumps on the bottom side to the drive or control circuits on the top side of semiconductor substrates (e.g., silicon substrates). Display driver die 5420 and display driver dies 5432 on the top surface of interposer 5412 may be fabricated on silicon wafers and may have similar thicknesses. Therefore, the top surfaces of display driver die 5420 and display driver dies 5432 may be on approximately the same plane. A homogeneous OLED panel 5452 similar to homogeneous OLED panel 5450 may be formed on display driver die 5420 and display driver dies 5432 using a same processing flow, and thus there may not be gaps between display regions having different PPIs.

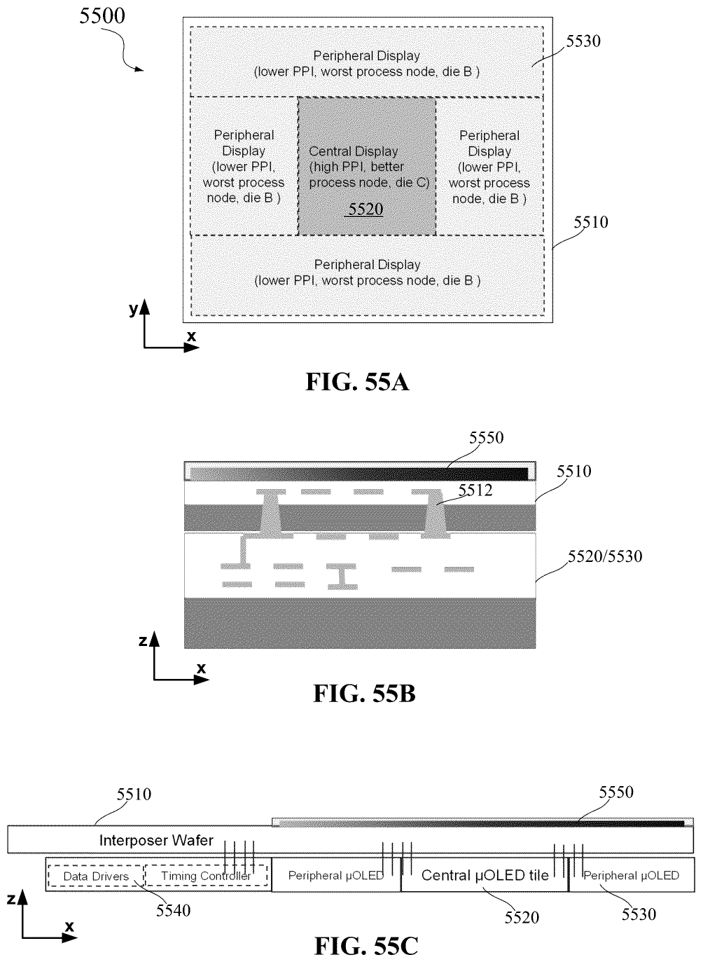

FIGS. 55A-55C illustrate an example of a tiled display panel 5500 according to certain embodiments. Display panel 5500 may include an interposer 5510, and may also include a display driver die 5520 for a central display region, one or more display driver dies 5530 for peripheral display regions, and a display controller die 5540 bonded to the bottom surface of interposer 5510 through, for example, bonding balls or bonding bumps. Interposer 5510 may include electrical interconnects (e.g., pads and/or traces) on both the bottom surface and the top surface, and may also include TSVs 5512 connecting the electrical interconnects on the bottom surface to the electrical interconnects on the top surface. In some embodiments, display driver die 5520, display driver dies 5530, and display controller die 5540 may also include TSVs and bonding balls or bumps on the semiconductor substrate, and may be bonded to the bottom surface of interposer 5510 using the bonding balls or bumps. In some embodiments, display driver die 5520, display driver dies 5530, and display controller die 5540 may not include TSVs and may be bonded to the bottom surface of interposer 5510 by, for example, flip-chip bonding. As described above, interposer 5510, display driver die 5520, display driver dies 5530, and display controller die 5540 may be fabricated using different processing technologies.

In display panel 5500, a planar, homogeneous OLED panel 5550 may be formed on the top surface of interposer 5510. Homogeneous OLED panel 5550 may include, for example, an anode layer (which may be included in the electrical interconnects on the top surface of interposer 5510 in some embodiments), a hole injection layer, a hole transport layer, an emissive layer, an electron transport layer, an electron injection layer, a cathode layer, and an encapsulation layer, which may be fabricated in a same processing flow. Each of the hole injection layer, hole transport layer, emissive layer, electron transport layer, and electron injection layer may be a contiguous layer that covers both the central display region and peripheral display regions. Therefore, there may not be gaps between display regions having different PPIs.

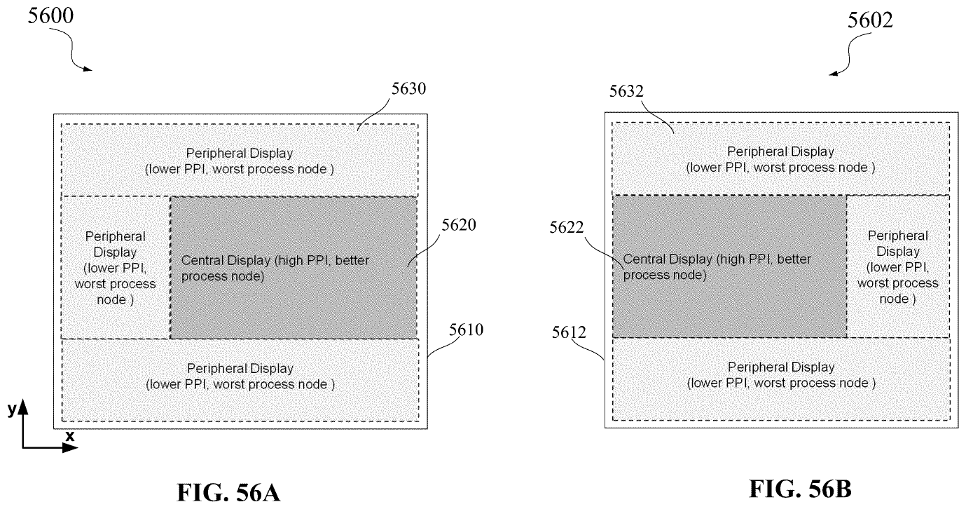

FIG. 56A illustrates an example of a tiled display panel 5600 according to certain embodiments. Display panel 5600 may include an interposer 5610 (e.g., similar to interposer 5210, 5310, 5410, or 5510 described above), and may include a display driver die 5620 for a central display region, one or more display driver dies 5630 for peripheral display regions, and a display controller die (not shown in FIG. 56A) bonded to interposer 5610. In the illustrated example, display panel 5600 may be used for displaying images to the left eye of a user, where display driver dies 5630 may be above, below, and to the left of display driver die 5620.

FIG. 56B illustrates an example of a tiled display panel 5602 according to certain embodiments. Display panel 5602 may include an interposer 5612 (e.g., similar to interposer 5210, 5310, 5410, or 5510 described above), and may include a display driver die 5622 for a central display region, one or more display driver dies 5632 for peripheral display regions, and a display controller die (not shown in FIG. 56B) bonded to interposer 5612. In the illustrated example, display panel 5602 may be used for display images to the right eye of a user, where display driver dies 5632 may be above, below, and to the right of display driver die 5622.

It is noted that FIGS. 52A-56B illustrate some examples of three-dimensional arrangements of the display driver dies with different resolutions, the display controller die, and the interposer in tiled OLED display panels. Other arrangements of these components can also be made, and a homogeneous OLED panel may be formed on top of the display driver dies or the interposer such that there may not be gaps between display regions having different PPIs.

Since the emissive layer for regions with different PPIs may be a contiguous, planar layer and thus may have the same distance from the display optics, it may be easier to design the display optics to reduce optical aberrations and achieve good image quality. In addition, because the display driver dies may all include CMOS drive circuits and the emissive layer at different regions is fabricated on a homogeneous layer using the same processes (thereby avoiding batch to batch mismatch), opto-electrical characteristics at different regions of the OLED display panel may be better matched, and thus it may be easier to achieve the desired uniformity in the optical characteristics of the OLED display panel.

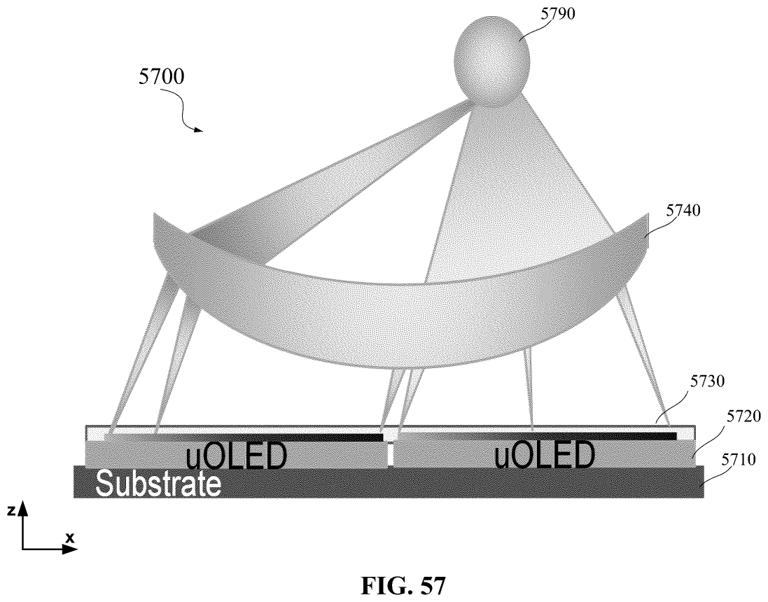

FIG. 57 illustrates an example of a near-eye display system 5700 including a tiled display panel and display optics 5740 according to certain embodiments. Any of the OLED display panels described above with respect to FIGS. 52A-56B may be used as the OLED display panel in near-eye display system 5700. As described above, the OLED display panel may include a substrate 5710 (e.g., an interposer), display driver dies 5720 bonded to substrate 5710, and a homogeneous OLED panel 5730 formed on display driver dies 5720. Homogeneous OLED panel 5730 may be driven by display driver dies 5720 to generate images in an emissive layer (e.g., an emissive polymer layer) of homogeneous OLED panel 5730, where the images may not have gaps between regions with different resolutions. Display optics 5740 may be used to project the images to the user's eye 5790 as described above with respect to, for example, FIGS. 4 and 5. Display optics 5740 may include, for example, a pancake lens, and may be designed to project images with low optical aberrations and better image quality. Since the images are generated in a homogeneous emissive layer, it may be much easier to design display optics 5740 to achieve the desired performance than display optics 5140 and 5150 of near-eye display systems 5100 and 5104.

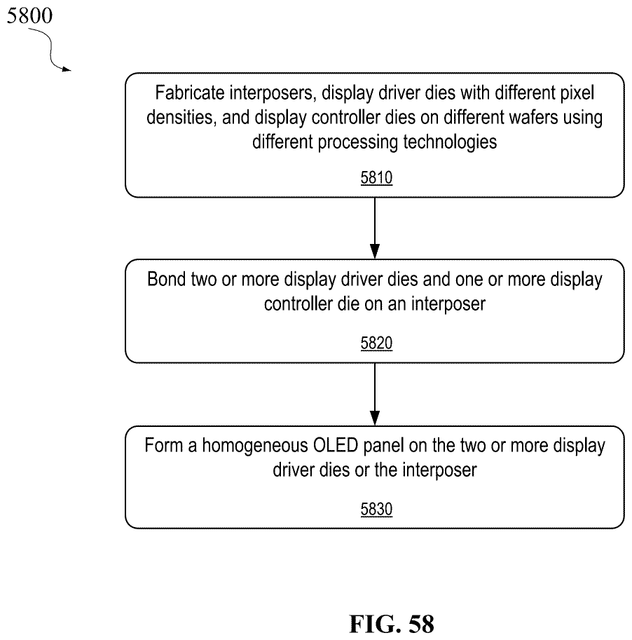

FIG. 58 includes a flowchart 5800 illustrating an example of a process of fabricating a tiled display panel according to certain embodiments. It is noted that the operations illustrated in FIG. 58 provide particular processes for fabricating tiled OLED display panels. Other sequences of operations can also be performed according to alternative embodiments. For example, alternative embodiments may perform the operations in a different order. Moreover, the individual operations illustrated in FIG. 58 can include multiple sub-operations that can be performed in various sequences as appropriate for the individual operation. Furthermore, some operations can be added or removed depending on the particular applications. In some implementations, two or more operations may be performed in parallel. One of ordinary skill in the art would recognize many variations, modifications, and alternatives.

Operations in block 5810 of flowchart 5800 may include fabricating interposers, display driver dies for peripheral display regions, display driver dies for a central display region, and display controller dies (e.g., DDICs) on different wafers using different processing technologies. For example, more advanced CMOS processing technology (e.g., 22-nm processing technology) may be used to fabricate the display controller dies, which may include, for example, data driver circuits and timing controller circuits, and may need to have high speed and low power. A lower precision CMOS processing node (e.g., 32-nm processing technology) may be used to fabricate the display driver dies for the central display region, which may have a higher pixel density or display resolution. The display driver dies for the central display regions may include pixel drive circuits and peripheral circuits, such as gate driver circuits. A more mature CMOS processing technology with even lower resolution (e.g., 65-nm processing technology) may be used for fabricating the display driver dies for the peripheral display regions, which may have a lower pixel density or display resolution. The display driver dies for the peripheral display regions may include pixel drive circuits and peripheral circuits, such as gate driver circuits. Each interposer may have a much larger size and may also be fabricated using a more mature processing technology with lower resolution. The interposers may be fabricated using silicon wafer or other wafers (e.g., IGZO, polycrystalline silicon, or amorphous silicon). Each display driver die or display controller die may have a size much smaller than the size of the interposer, and thus can have a high yield even if more advanced processing technologies (with higher defect densities) are used to fabricate these dies. In this way, the cost of the OLED display panel and the near-eye display system can be reduced by using the most cost-effective processes while achieving the highest yield possible.

In some embodiments, the display driver dies, the display controller dies, and/or the interposers may include bonding pads, bonding balls, or bonding bumps on the side of the drive (or control) circuits or on the bottom side of the substrate. When the bonding pads, bonding balls, or bonding bumps are on the bottom side of a silicon substrate, TSVs may be used to electrically connect the bonding pads, bonding balls, or bonding bumps on the bottom side to the drive (or control) circuits on the opposite side of the silicon substrate. The wafers with the interposers, display driver dies, and display controller dies fabricated thereon may be diced to singulate the interposers, display driver dies, and display controller dies.

Operations in block 5820 of flowchart 5800 may include bonding two or more display driver dies with different pixel densities, and one or more display controller dies to an interposer using the bonding pads, bonding balls, or bonding bumps. As described above, the display driver dies with different resolutions, the display controller die, and the interposer may be bonded to form various three-dimensional structures. The display driver dies with different resolutions may be on a same side of the interposer. For example, the display driver dies with different resolutions may be bonded to a top surface (closer to display optics) of the interposer as in the embodiments shown in FIGS. 52A-12C. The display driver dies may have similar heights, and thus the top surfaces of the display driver dies may be on approximately the same plane. In some embodiments, the display driver dies with different resolutions may be bonded to a bottom surface of the interposer as in the embodiments shown in FIGS. 55A-13C. The display controller die may be on the same side of the interposer as the display driver dies, or may be on the side of the interposer opposing the display driver dies.

Operations in block 5830 of flowchart 5800 may include forming a homogeneous OLED panel on either the top surface of the interposer (e.g., as shown in FIG. 55C) or the top surfaces of the display driver dies (e.g., as shown inn FIGS. 52C and 54C). The homogeneous OLED panel may include, for example, an anode layer (which may be part of the interposer or the display driver dies), a hole injection layer, a hole transport layer, an emissive layer, an electron transport layer, an electron injection layer, a cathode layer, and an encapsulation layer, which may be fabricated in a same processing flow. Each of the hole injection layer, hole transport layer, emissive layer, electron transport layer, and electron injection layer may be a flat, contiguous layer that covers both the central display region and peripheral display regions. Therefore, the OLED panel may be planar and there may not be gaps between display regions having different PPIs.

Embodiments may include different combinations of features in view of the description. Certain embodiments are described in the following examples.

In Example 1, a near-eye display system may include an organic light-emitting diode (OLED) display panel comprising: an interposer including a plurality of electrical interconnects; a plurality of display driver dies bonded to a first side of the interposer, the plurality of display driver dies including pixel drive circuits; and a single OLED panel formed on the interposer or the plurality of display driver dies, the OLED panel including a contiguous organic light emission layer and electrically coupled to the plurality of electrical interconnects of the interposer or the pixel drive circuits of the plurality of display driver dies.

Example 2 includes the near-eye display system of Example 1, wherein the plurality of display driver dies includes at least a first display driver die characterized by a first pixel density and a second display driver die characterized by a second pixel density lower than the first pixel density.

Example 3 includes the near-eye display system of Example 2, wherein the first display driver die and the second display driver die are fabricated using different fabrication technologies and have different feature sizes.

Example 4 includes the near-eye display system of Example 2 or 3, wherein the first display driver die and the second display driver die include complementary metal-oxide semiconductor (CMOS) circuits.

Example 5 includes the near-eye display system of any of Examples 2-4, wherein the first display driver die is in a central region of the OLED display panel and the second display driver die is in a peripheral region of the OLED display panel.

Example 6 includes the near-eye display system of any of Examples 2-5, wherein the plurality of display driver dies includes one or more third display driver dies characterized by a third pixel density equal to or lower than the second pixel density.

Example 7 includes the near-eye display system of any of Examples 1-6, wherein the OLED display panel further comprises a display controller die bonded to the interposer, the display controller die positioned on the first side of the interposer or a second side of the interposer opposing the first side.

Example 8 includes the near-eye display system of Example 7, wherein the display controller die and the plurality of display driver dies are fabricated using different fabrication technologies and have different feature sizes.

Example 9 includes the near-eye display system of Example 7 or 8, wherein the display controller die includes data driver circuits and time control circuits.

Example 10 includes the near-eye display system of any of Examples 1-9, wherein: the OLED panel is in physical contact with and driven by the pixel drive circuits of the plurality of display driver dies; and the plurality of display driver dies includes through-silicon vias (TSVs) configured to electrically connect the pixel drive circuits to the plurality of electrical interconnects of the interposer.

Example 11 includes the near-eye display system of any of Examples 1-10, wherein: the OLED panel is formed on a second side of the interposer opposing the first side; and the interposer includes through-silicon vias (TSVs) configured to electrically connect the pixel drive circuits of the plurality of display driver dies to the OLED panel.

Example 12 includes the near-eye display system of any of Examples 1-11, wherein: the OLED display panel includes a printed circuit board (PCB); and the interposer includes a semiconductor substrate bonded to the PCB.

Example 13 includes the near-eye display system of any of Examples 1-12, wherein the plurality of display driver dies includes gate drivers.

In Example 14, the near-eye display system of any of Examples 1-13 further comprises display optics configured to project images generated by the OLED display panel to a user's eye.

Example 15 includes the near-eye display system of Example 14, wherein the display optics include a C-shaped pancake lens.

Example 16 includes the near-eye display system of any of Examples 1-15, wherein the contiguous organic light emission layer is a flat layer.

Example 17 includes the near-eye display system of any of Examples 1-16, wherein the OLED panel further comprises: a contiguous hole injection layer; a contiguous hole transport layer; a contiguous electron transport layer; and a contiguous electron injection layer, wherein the contiguous organic light emission layer is between the contiguous hole transport layer and the contiguous electron transport layer.

Example 18 includes the near-eye display system of any of Examples 1-17, wherein a total monocular field of view of the near-eye display system is greater than 90°.

In Example 19, an organic light-emitting diode (OLED) display panel may include an interposer including a plurality of electrical interconnects; a plurality of display driver dies bonded to a first side of the interposer, the plurality of display driver dies including pixel drive circuits; and a single OLED panel formed on the interposer or the plurality of display driver dies, the OLED panel including a contiguous organic light emission layer and electrically coupled to the plurality of electrical interconnects of the interposer or the pixel drive circuits of the plurality of display driver dies.

Example 20 includes the OLED display panel of Example 19, wherein the plurality of display driver dies includes at least a first display driver die characterized by a first pixel density and a second display driver die characterized by a second pixel density lower than the first pixel density.

Example 21 includes the OLED display panel of Example 20, wherein the first display driver die and the second display driver die are fabricated using different fabrication technologies and have different feature sizes.

Example 22 includes the OLED display panel of Example 20 or 21, wherein the first display driver die and the second display driver die include complementary metal-oxide semiconductor (CMOS) circuits.

Example 23 includes the OLED display panel of any of Examples 20-22, wherein the first display driver die is in a central region of the OLED display panel and the second display driver die is in a peripheral region of the OLED display panel.

Example 24 includes the OLED display panel of any of Examples 20-23, wherein the plurality of display driver dies includes one or more third display driver dies characterized by a third pixel density equal to or lower than the second pixel density.

In Example 25, the OLED display panel of any of Examples 20-24 further comprises a display controller die bonded to the interposer, the display controller die positioned on the first side of the interposer or a second side of the interposer opposing the first side.

Example 26 includes the OLED display panel of Example 25, wherein the display controller die and the plurality of display driver dies are fabricated using different fabrication technologies and have different feature sizes.

Example 27 includes the OLED display panel of Example 25, wherein the display controller die includes a data driver and a time controller.

Example 28 includes the OLED display panel of any of Examples 19-27, wherein: the OLED panel is in physical contact with and driven by the pixel drive circuits of the plurality of display driver dies; and the plurality of display driver dies includes through-silicon vias (TSVs) configured to electrically connect the pixel drive circuits to the plurality of electrical interconnects of the interposer.

Example 29 includes the OLED display panel of any of Examples 19-28, wherein: the OLED panel is formed on a second side of the interposer opposing the first side; and the interposer includes through-silicon vias (TSVs) configured to electrically connect the pixel drive circuits of the plurality of display driver dies to the OLED panel.

Example 30 includes the OLED display panel of any of Examples 19-29, wherein: the OLED display panel includes a printed circuit board (PCB); and the interposer includes a semiconductor substrate bonded to the PCB.

Example 31 includes the OLED display panel of any of Examples 19-30, wherein the plurality of display driver dies includes gate drivers.

Example 32 includes the OLED display panel of any of Examples 19-31, wherein the contiguous organic light emission layer is a flat layer.

Example 33 includes the OLED display panel of any of Examples 19-32, wherein the OLED panel further comprises: a contiguous hole injection layer; a contiguous hole transport layer; a contiguous electron transport layer; and a contiguous electron injection layer, wherein the contiguous organic light emission layer is between the contiguous hole transport layer and the contiguous electron transport layer.

In Example 34, a method comprising: fabricating interposers and display driver dies with different pixel densities, the display driver dies including pixel drive circuits, and the interposer including a plurality of electrical interconnects; bonding a plurality of display driver dies to a first side of an interposer; and forming a single OLED panel on the interposer or the plurality of display driver dies, the OLED panel including a contiguous organic light emission layer and electrically coupled to the plurality of electrical interconnects of the interposer or the pixel drive circuits of the plurality of display driver dies.

Example 35 includes the method of Example 34, wherein the contiguous organic light emission layer is a flat layer.

Example 36 includes the method of Example 34 or 35, wherein the display driver dies with different pixel densities are fabricated on different wafers using different processing technologies.

Example 37 includes the method of any of Examples 34-36, wherein: the plurality of display driver dies includes at least a first display driver die characterized by a first pixel density and a second display driver die characterized by a second pixel density lower than the first pixel density; and the first display driver die is bonded to a central region of the interposer and the second display driver die is bonded to a peripheral region of the interposer.

In Example 38, the method of any of Examples 34-37 further comprises: fabricating display controller dies; and bonding a display controller die to the first side of the interposer or a second side of the interposer opposing the first side.

Example 39 includes the method of any of Examples 34-38, wherein: the OLED panel is in physical contact with and driven by the pixel drive circuits of the plurality of display driver dies; and the plurality of display driver dies includes through-silicon vias (TSVs) configured to electrically connect the pixel drive circuits to the plurality of electrical interconnects.

Example 40 includes the method of any of Examples 34-39, wherein: the OLED panel is formed on a second side of the interposer opposing the first side; and the interposer includes through-silicon vias (TSVs) configured to electrically connect the pixel drive circuits of the plurality of display driver dies to the OLED panel.

Example 41 includes the method of any of Examples 34-40, wherein the OLED panel further comprises: a contiguous hole injection layer; a contiguous hole transport layer; a contiguous electron transport layer; and a contiguous electron injection layer, wherein the contiguous organic light emission layer is between the contiguous hole transport layer and the contiguous electron transport layer.

In Example 42, the method of any of Examples 34-41 further comprises bonding the interposer to a printed circuit board (PCB).

VIII. Over-Molded Frame with Integrated Heat Sink for VR Display Application

In near-eye display, thermal management and sealing between cover glass and display panel (e.g., an LCD, LED, OLED display panel) may be challenging. The luminance from some light sources, such as various types of LEDs, may be sensitive to the operating temperature. This may be problematic for an LED display panel in a display system (e.g., an AR/VR system) because changes in the temperature of the display panel may cause the luminance to vary, which may result in a decrease in the quality of the displayed image and the user experience. For example, the temperature of the display panel may increase while the light sources are being driven, and the increase may be more significant when a complicated application or content is being produced. Conversely, the temperature of the display panel may decrease if there is a break in the display or if a simpler application or content is being produced. A passive or active heat sink may generally be used for the thermal management.

As described above, a display panel such as an LCD panel, an OLED display panel, or an LED display panel may include many layers that are integrated into a layer stack. For example, an OLED panel may include a substrate, an anode layer (which may be included in display driver), a hole injection layer, a hole transport layer, an emissive layer, an electron transport layer, an electron injection layer, a cathode layer, and an encapsulation layer. An LCD panel may include a BLU, polarizers, an LC cell, TFT layer, color filter, and the like, where some components such as the BLU and LC cell may each include multiple layers. A cover glass may often be used to provide transparent protection of components of the display panel. The layers of the display panel may need to be encapsulated or sealed to protect the display panel from the environment, such as moisture, oxygen, and other contamination that may degrade the performance of the display panel. The display panel may generally need a frame to provide the protection and mechanical support for the display panel. The frame may sometimes include a front portion and a back portion that sandwich other layers of the display panel.

Existing technology generally addresses the challenges of thermal management and sealing separately, which may lead to more component requirement and more complicated manufacturing equipment and process. In many cases, even with the separated handling of the thermal management and sealing issues, the thermal and/or sealing performance of the display panel may not be optimized. For example, existing sealing techniques generally utilize resin between the cover glass and the panel. These techniques may need increased panel border and cover glass outline to ensure sufficient resin width, may be difficulty to control the uniformity of the resin height around the perimeter, and may require complicated manufacturing equipment and process. Existing heat sinks typically includes a large piece of metal attached to the backside of the display, which may limit the heat dissipation surface, increase weight, and require additional layer of adhesive to bond the heat sink to the display.

According to certain embodiments, an integrated frame and heat sink design may be used to achieve display panel sealing and thermal dissipation. The integrated frame and heat sink can be manufactured through one single manufacturing process such as injection molding. The over-molded frame can improve the sealing performance for the display panel, and provide better reliability performance for extreme environmental conditions. Heat sink fins can be integrated into the molded frame, such that the heat dissipation surface may be increased to improve the efficiency of thermal dissipation, and the overall weight of the integrated frame and heat sink may be reduced significantly. The over-molded frame with integrated heat sink can also provide additional structural support for the display module, such that the display module may be much less vulnerable to external forces (e.g., bending, twisting, impact type loading, etc.). The molded frame may also provide additional freedom for assembling the display module to the optical module (e.g., a projection lens such as a pancake lens). For example, the molded frame may include mounting tabs with screw holes, or may facilitate bonding to the optical module using adhesive.

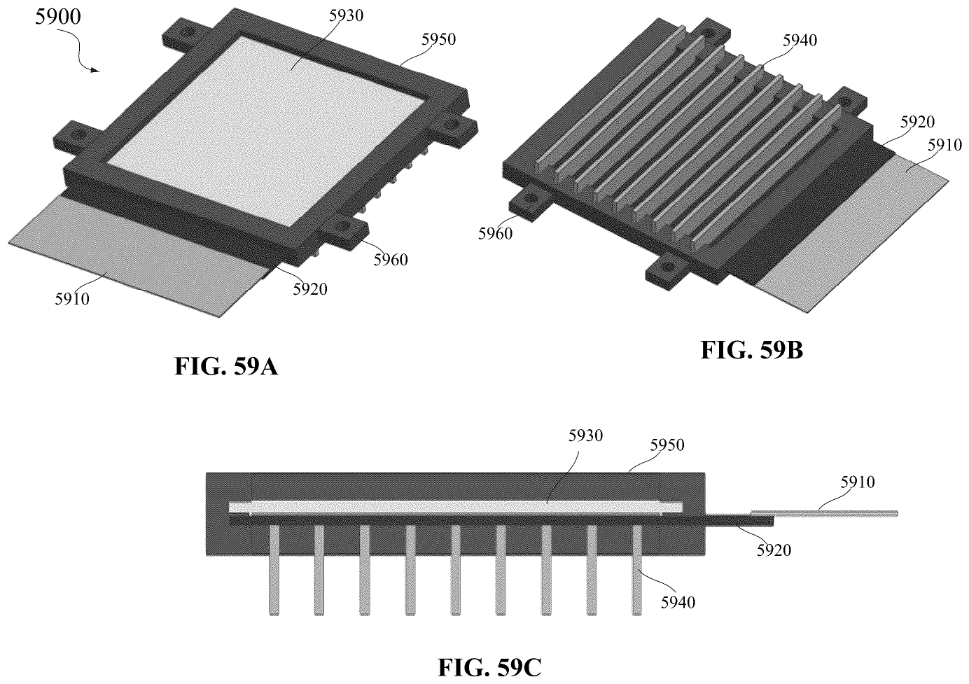

FIGS. 59A-59C include different views of an example of a display module 5900 including an over-molded frame with integrated heat sink according to certain embodiments. For example, FIG. 59A includes a front perspective view of display module 5900, FIG. 59B includes a back perspective view of display module 5900, whereas FIG. 59C includes a cross-sectional view of display module 5900. Display module 5900 may be used in a near-eye display that may also include an optical module (e.g., display optics that includes a projection lens) for projecting images generated by display module 5900 to user's eyes. In the illustrated example, display module 5900 may include a display flex 5910, a display panel 5920, a cover glass 5930, heat sink fins 5940, and an over-molded frame 5950. Display flex 5910 may include, for example, a flexible substrate, such as a chip on film/flex (COF) tape or a flexible printed circuit (FPC), and may include, for example, a metal layer (e.g., Cu) and a polyimide layer. Display flex 5910 may be used to electrically connect display panel to control circuits. Display panel 5920 may include an LCD panel, an OLED display panel, a micro-OLED display panel, an AMOLED display panel, a micro-LED display panel, and the like, described above. In some embodiments, display panel 5920 may include drive circuits formed on a semiconductor substrate. Cover glass 5930 may include a transparent glass and may include optical coatings (e.g., antireflective coating) in some embodiments. Heat sink fins 5940 may include metal plates that have high thermal conductivity and heat dissipation (e.g., by thermal conduction and/or radiation). Heat sink fins 5940 may physically or thermally connected to the back side (e.g., a semiconductor substrate) of display panel 5920.

Over-molded frame 5950 may include an over-mold material, such as a plastic material (e.g., a resin or polymer) or a rubber material that is thermally and/or optical curable. Over-molded frame 5950 may surround edges of display panel 5920 and cover glass 5930, and may at least partially surround edges of heat sink fins 5940. In some embodiments, over-molded frame 5950 may include mounting tabs for assembling with other modules of a near-eye display, such as an optical module that includes projection optics. Over-molded frame 5950 may be a single contiguous piece formed by, for example, injection molding.

In one example, a mold may be made to hold heat sink fins 5940, a large portion of display panel 5920, and cover glass 5930. The mold may include a top portion and a bottom portion that may together form cavities for holding components to be over-molded and for receiving over-mold materials. For example, the cavities of the mold may include a plurality of slots that can fit a plurality of heat sink fins 5940. Display panel 5920 and cover glass 5930 may be positioned on heat sink fins 5940 and supported by heat sink fins. The mold may include voids surrounding display panel 5920 and cover glass 5930, where a melted material may be injected into the voids and then cooled down to solidify the melted material. In this way, the frame fabrication, assembling, sealing, encapsulating, heat sink attaching, and the like can be performed in one molding process to achieve excellent sealing of the display module. In addition, heat sink fins can directly contact the back side of the display panel without requiring additional components or material to attach the heat sink fins to the display panel, and the overall contact area between heat sink fins and the display panel can be large and more uniformly distributed across the display panel. As such, thermal dissipation from the display panel by the heat sink fins may be improved, and the display module may be more robust and compact.

In some embodiments, the mold may include some features such that the over-molded frame may include other features, such as features for holding, supporting, or connecting to display optics (e.g., lens). For example, in display module 5900, over-molded frame 5950 may include a plurality of mounting tabs 5960 for mounting an optical module.

Embodiments may include different combinations of features in view of the description. Certain embodiments are described in the following examples.

In Example 1, a display module includes a display panel, a cover glass on a front side of the display panel, a plurality of heat sink fins contacting a back side of the display panel, and a contiguous over-molded frame around a perimeter of the cover glass and edges of the display panel, wherein the contiguous over-molded frame is in contact with the plurality of heat sink fins.

Example 2 includes the display module of Example 1, wherein the display panel includes, for example, an LCD panel, an OLED display panel, or an LED display panel.

Example 3 includes the display module of Example 1 or 2, wherein the contiguous over-molded frame includes structures for mounting an optical module to the display module.

Example 4 includes the display module of any of Examples 1-3, wherein two ends of each heat sink fin of the plurality of heat sink fins are at least partially in the contiguous over-molded frame.

Example 5 includes the display module of any of Examples 1-4, wherein the contiguous over-molded frame covers edges of the cover glass.

Example 6 includes the display module of any of Examples 1-5, wherein the contiguous over-molded frame covers edges of the back side of the display panel.

Example 7 includes the display module of any of Examples 1-6, wherein at least a portion of the display panel is outside a perimeter of the contiguous over-molded frame.

Example 8 includes the display module of any of Examples 1-7, wherein the contiguous over-molded frame includes a plastic or rubber material.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

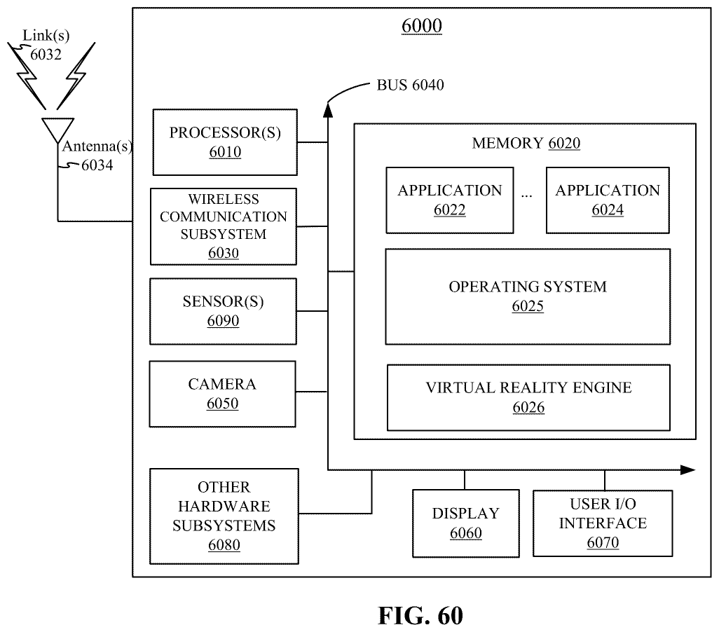

FIG. 60 is a simplified block diagram of an example electronic system 6000 of an example near-eye display (e.g., HMD device) for implementing some of the examples disclosed herein. Electronic system 6000 may be used as the electronic system of an HMD device or other near-eye displays described above. In this example, electronic system 6000 may include one or more processor(s) 6010 and a memory 6020. Processor(s) 6010 may be configured to execute instructions for performing operations at a number of components, and can be, for example, a general-purpose processor or microprocessor suitable for implementation within a portable electronic device. Processor(s) 6010 may be communicatively coupled with a plurality of components within electronic system 6000. To realize this communicative coupling, processor(s) 6010 may communicate with the other illustrated components across a bus 6040. Bus 6040 may be any subsystem adapted to transfer data within electronic system 6000. Bus 6040 may include a plurality of computer buses and additional circuitry to transfer data.

Memory 6020 may be coupled to processor(s) 6010. In some embodiments, memory 6020 may offer both short-term and long-term storage and may be divided into several units. Memory 6020 may be volatile, such as static random access memory (SRAM) and/or dynamic random access memory (DRAM) and/or non-volatile, such as read-only memory (ROM), flash memory, and the like. Furthermore, memory 6020 may include removable storage devices, such as secure digital (SD) cards. Memory 6020 may provide storage of computer-readable instructions, data structures, program code, and other data for electronic system 6000. In some embodiments, memory 6020 may be distributed into different hardware subsystems. A set of instructions and/or code might be stored on memory 6020. The instructions might take the form of executable code that may be executable by electronic system 6000, and/or might take the form of source and/or installable code, which, upon compilation and/or installation on electronic system 6000 (e.g., using any of a variety of generally available compilers, installation programs, compression/decompression utilities, etc.), may take the form of executable code.

In some embodiments, memory 6020 may store a plurality of applications 6022 through 6024, which may include any number of applications. Examples of applications may include gaming applications, conferencing applications, video playback applications, or other suitable applications. The applications may include a depth sensing function or eye tracking function. Applications 6022-6024 may include particular instructions to be executed by processor(s) 6010. In some embodiments, certain applications or parts of applications 6022-6024 may be executable by other hardware subsystems 6080. In certain embodiments, memory 6020 may additionally include secure memory, which may include additional security controls to prevent copying or other unauthorized access to secure information.

In some embodiments, memory 6020 may include an operating system 6025 loaded therein. Operating system 6025 may be operable to initiate the execution of the instructions provided by applications 6022-6024 and/or manage other hardware subsystems 6080 as well as interfaces with a wireless communication subsystem 6030 which may include one or more wireless transceivers. Operating system 6025 may be adapted to perform other operations across the components of electronic system 6000 including threading, resource management, data storage control and other similar functionality.

Wireless communication subsystem 6030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 6000 may include one or more antennas 6034 for wireless communication as part of wireless communication subsystem 6030 or as a separate component coupled to any portion of the system. Depending on desired functionality, wireless communication subsystem 6030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15×, or some other types of network. The techniques described herein may also be used for any combination of WWAN, WLAN, and/or WPAN. Wireless communications subsystem 6030 may permit data to be exchanged with a network, other computer systems, and/or any other devices described herein. Wireless communication subsystem 6030 may include a means for transmitting or receiving data, such as identifiers of HMD devices, position data, a geographic map, a heat map, photos, or videos, using antenna(s) 6034 and wireless link(s) 6032.

Embodiments of electronic system 6000 may also include one or more sensors 6090. Sensor(s) 6090 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 6090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 6000 may include a display 6060. Display 6060 may be a near-eye display, and may graphically present information, such as images, videos, and various instructions, from electronic system 6000 to a user. Such information may be derived from one or more applications 6022-6024, virtual reality engine 6026, one or more other hardware subsystems 6080, a combination thereof, or any other suitable means for resolving graphical content for the user (e.g., by operating system 6025). Display 6060 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 6000 may include a user input/output interface 6070. User input/output interface 6070 may allow a user to send action requests to electronic system 6000. An action request may be a request to perform a particular action. For example, an action request may be to start or end an application or to perform a particular action within the application. User input/output interface 6070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 6000. In some embodiments, user input/output interface 6070 may provide haptic feedback to the user in accordance with instructions received from electronic system 6000. For example, the haptic feedback may be provided when an action request is received or has been performed.

Electronic system 6000 may include a camera 6050 that may be used to take photos or videos of a user, for example, for tracking the user's eye position. Camera 6050 may also be used to take photos or videos of the environment, for example, for VR, AR, or MR applications. Camera 6050 may include, for example, a complementary metal-oxide-semiconductor (CMOS) image sensor with a few millions or tens of millions of pixels. In some implementations, camera 6050 may include two or more cameras that may be used to capture 3-D images.

In some embodiments, electronic system 6000 may include a plurality of other hardware subsystems 6080. Each of other hardware subsystems 6080 may be a physical subsystem within electronic system 6000. While each of other hardware subsystems 6080 may be permanently configured as a structure, some of other hardware subsystems 6080 may be temporarily configured to perform specific functions or temporarily activated. Examples of other hardware subsystems 6080 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 6080 may be implemented in software.

In some embodiments, memory 6020 of electronic system 6000 may also store a virtual reality engine 6026. Virtual reality engine 6026 may execute applications within electronic system 6000 and receive position information, acceleration information, velocity information, predicted future positions, or some combination thereof of the HMD device from the various sensors. In some embodiments, the information received by virtual reality engine 6026 may be used for producing a signal (e.g., display instructions) to display 6060. For example, if the received information indicates that the user has looked to the left, virtual reality engine 6026 may generate content for the HMD device that mirrors the user's movement in a virtual environment. Additionally, virtual reality engine 6026 may perform an action within an application in response to an action request received from user input/output interface 6070 and provide feedback to the user. The provided feedback may be visual, audible, or haptic feedback. In some implementations, processor(s) 6010 may include one or more GPUs that may execute virtual reality engine 6026.

In various implementations, the above-described hardware and subsystems may be implemented on a single device or on multiple devices that can communicate with one another using wired or wireless connections. For example, in some implementations, some components or subsystems, such as GPUs, virtual reality engine 6026, and applications (e.g., tracking application), may be implemented on a console separate from the head-mounted display device. In some implementations, one console may be connected to or support more than one HMD.

In alternative configurations, different and/or additional components may be included in electronic system 6000. Similarly, functionality of one or more of the components can be distributed among the components in a manner different from the manner described above. For example, in some embodiments, electronic system 6000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A liquid crystal display (LCD) of a near-eye display, the LCD comprising:
a backlight unit configured to emit light;
a thin-film-transistor (TFT) array including pixel control circuits and an array of apertures configured to transmit light;
a diffractive optical element between the TFT array and the backlight unit, wherein the diffractive optical element is configured to, at two or more different locations of the diffractive optical element, deflect the light emitted from the backlight unit by different respective deflection angles towards the TFT array;
a color filter on a side of the TFT array opposing the diffractive optical element, wherein the color filter comprises an array of color filter elements, and wherein each color filter element of the array of color filter elements is positioned along a chief ray direction of the near-eye display with respect to a corresponding aperture of the array of apertures of the TFT array; and
a liquid crystal layer between the TFT array and the color filter and controlled by the pixel control circuits.

2. The LCD of claim 1, wherein the diffractive optical element is configured to deflect the light emitted from the backlight unit by deflection angles that match chief ray angles of the near-eye display.

3. The LCD of claim 1, wherein a pitch of the array of color filter elements is smaller than 30 micrometers.

4. The LCD of claim 1, wherein a lateral size of each color filter element of the array of color filter elements is smaller than 10 micrometers.

5. The LCD of claim 1, wherein deflection angles at different locations of the diffractive optical element increase as distances of the different locations from a center of the diffractive optical element increase.

6. The LCD of claim 1, wherein the diffractive optical element is configured to deflect, at peripheral regions of the diffractive optical element, the light emitted from the backlight unit inwardly in a surface-normal direction of the diffractive optical element.

7. The LCD of claim 1, wherein the diffractive optical element is configured to deflect, at peripheral regions of the diffractive optical element, the light emitted from the backlight unit outwardly in a surface-normal direction of the diffractive optical element.

8. The LCD of claim 1, wherein the diffractive optical element comprises a Pancharatnam-Berry phase (PBP) element that is sensitive to circularly polarized light.

9. The LCD of claim 8, wherein the PBP element includes one or more patterned birefringent layers that include a liquid crystal material, a form-birefringent structure, a meta-surface, a surface plasmonic layer, or any combination thereof.

10. The LCD of claim 8, wherein the diffractive optical element further comprises a first quarter-wave plate configured to convert circularly polarized light into linearly polarized light.

11. The LCD of claim 10, wherein the diffractive optical element further comprises a linear polarizer configured to selectively transmit the linearly polarized light converted by the first quarter-wave plate.

12. The LCD of claim 11, further comprising a brightness enhancement film and a second quarter-wave plate between the backlight unit and the TFT array, wherein the brightness enhancement film is configured to transmit linearly polarization light of a first linear polarization state and reflect linearly polarization light of a second linear polarization state that is orthogonal to the first linear polarization state.

13. The LCD of claim 1, further comprising a second linear polarizer on a side of the color filter opposing the liquid crystal layer.

14. The LCD of claim 1, wherein:
the TFT array includes a black-mask layer; and
the array of apertures is formed in the black-mask layer.

15. The LCD of claim 1, further comprising a black-mask layer, wherein the array of color filter elements is formed in the black-mask layer.

16. A near-eye display comprising:
a liquid crystal display (LCD) configured to display an image; and
display optics configured to project the image to a user's eye,
wherein the LCD comprises:
a backlight unit configured to emit light;
a thin-film-transistor (TFT) array including control circuits and an array of apertures configured to transmit light;
a diffractive optical element between the TFT array and the backlight unit, wherein the diffractive optical element is configured to, at two or more different locations of the diffractive optical element, deflect the light emitted from the backlight unit by different respective deflection angles towards the TFT array;
a color filter on a side of the TFT array opposing the diffractive optical element, wherein the color filter comprises an array of color filter elements, and wherein each color filter element of the array of color filter elements is positioned along a chief ray direction of the near-eye display with respect to a corresponding aperture of the array of apertures of the TFT array; and
a liquid crystal layer between the TFT array and the color filter and controlled by the control circuits to modulate incident light.

17. The near-eye display of claim 16, wherein a pitch of the array of color filter elements is smaller than 30 micrometers.

18. The near-eye display of claim 16, wherein the diffractive optical element is configured to deflect the light emitted from the backlight unit by deflection angles that match chief ray angles of the near-eye display.

19. The near-eye display of claim 16, wherein deflection angles at different locations of the diffractive optical element increase or decrease as distances of the different locations from a center of the diffractive optical element increase.

20. The near-eye display of claim 16, wherein the diffractive optical element comprises a Pancharatnam-Berry phase (PBP) element that is sensitive to circularly polarized light.
